(19) United States
(12) Patent Application Publication
(10) Pub. No.: US 2017/0257286 A1
(43) Pub. Date: Sep. 7, 2017

(54) ADVANCE VERIFICATION METHOD AND RECORDING MEDIUM

(71) Applicant: FUJITSU LIMITED, Kawasaki-shi (JP)

(72) Inventors: Shinya Kitajima, Shinagawa (JP); Shinji Kikuchi, Yokohama (JP)

(73) Assignee: FUJITSU LIMITED, Kawasaki-shi (JP)

(21) Appl. No.: 15/408,473

(22) Filed: Jan. 18, 2017

(30) Foreign Application Priority Data
Mar. 4, 2016 (JP) 2016-042755

(51) Int. Cl. H04L 12/24; H04L 12/26

(52) U.S. Cl. CPC H04L 41/5035; H04L 43/0817

(57) ABSTRACT

A non-transitory computer-readable recording medium stores an advance verification program that causes a computer to execute a process. The process includes creating one or more state transition information items indicating a transition of a state of a device, based on a condition described in a policy rule and configuration information indicating the device included in a system, the policy rule describing a content of a process to be executed by the system and the condition for executing the process; and referring to quality information describing a quality to be satisfied in the system, determining whether there is a state transition information item in which the state of the device does not transition from a state of not satisfying the quality when complying with the policy rule, among the created one or more state transition information items, and outputting information indicating a result of the determination.

### CROSS-REFERENCE TO RELATED APPLICATION

This patent application is based upon and claims the benefit of priority of the prior Japanese Patent Application No. 2016-042755 filed on Mar. 4, 2016, the entire contents of which are incorporated herein by reference.

### FIELD

The embodiments discussed herein are related to an advance verification method and a recording medium.

### BACKGROUND

Conventionally, in a system including a plurality of devices such as a data center, operation management tasks, which are to be performed when various events occur (for example, a failure, a change in the configuration, etc.), are defined as policy rules, and operation management is performed based on the policy rules.

In the policy rules, the contents of tasks to be performed when various events occur, and conditions for performing the tasks are defined. By applying the policy rules, the operation management of the system is automated.

Patent Document 1: Japanese Laid-Open Patent Publication No. 2013-205941

Patent Document 2: Japanese Laid-Open Patent Publication No. 2015-7886

However, because a policy rule is defined for each event, the administrator of operation management has difficulty in determining whether the SLA (Service Level Agreement: service quality assurance), etc., defined for each system is satisfied. Furthermore, in recent years, the configuration of a system has a tendency of becoming enormous and complex, and the number of policy rules has increased. Therefore, it has become increasingly difficult to make the above determination.

As a result, after the operation management of the system starts, for example, there have been cases where the state of the device does not transition from a state of not satisfying the SLA to a state of satisfying the SLA, even though the policy rule has been applied.

### SUMMARY

According to an aspect of the embodiments, a non-transitory computer-readable recording medium stores an advance verification program that causes a computer to execute a process, the process including creating one or more state transition information items indicating a transition of a state of a device, based on a condition described in a policy rule and configuration information indicating the device included in a system, the policy rule describing a content of a process to be executed by the system and the condition for executing the process; and referring to quality information describing a quality to be satisfied in the system, determining whether there is a state transition information item in which the state of the device does not transition from a state of not satisfying the quality when complying with the policy rule, among the created one or more state transition information items, and outputting information indicating a result of the determination.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an example of the overall configuration of a cloud system including an operation management server;

FIG. 2 illustrates an example of a system configuration inside a data center;

FIG. 3 illustrates an example of a hardware configuration of the operation management server;

FIG. 4 illustrates the types of management targets;

FIG. 5 is a first diagram illustrating an example of configuration information;

FIG. 6 is a second diagram illustrating an example of configuration information;

FIG. 7 is a third diagram illustrating an example of configuration information;

FIG. 8 illustrates an example of policy information;

FIG. 9 illustrates an example of SLA information;

FIG. 10 illustrates an example of dependency information;

FIG. 11 illustrates an example of priority information;

FIG. 12 illustrates an example of a functional configuration of an advance verification unit;

FIG. 13 is a first diagram for describing the function of a state creating unit;

FIGS. 14A and 14B are a second diagram for describing the function of the state creating unit;

FIG. 15 illustrates an example of state management information stored by the state creating unit;

FIG. 16 is a first diagram for describing the functions of an unnecessary state searching unit;

FIG. 17 is a second diagram for describing the functions of the unnecessary state searching unit;

FIG. 18 is a third diagram for describing the functions of the unnecessary state searching unit;

FIG. 19 is a fourth diagram for describing the functions of the unnecessary state searching unit;

FIG. 20 is a fifth diagram for describing the functions of the unnecessary state searching unit;

FIG. 21 illustrates an example of state management information stored by the unnecessary state searching unit;

FIGS. 22A and 22B are a first diagram for describing the functions of a state transition creating unit;

FIG. 23 is a second diagram for describing the functions of the state transition creating unit;

FIG. 24 is a third diagram for describing the functions of the state transition creating unit;

FIGS. 25A through 25C are a fourth diagram for describing the functions of the state transition creating unit;

FIGS. 26A and 26B are a fifth diagram for describing the functions of the state transition creating unit;

FIGS. 27A and 27B are a sixth diagram for describing the functions of the state transition creating unit;

FIG. 28 is a seventh diagram for describing the functions of the state transition creating unit;

FIG. 29 illustrates an example of state management information stored by the state transition creating unit;

FIG. 30 is a diagram for describing a function of a policy transition identifying unit;

FIG. 31 illustrates an execution example of the policy transition identifying unit;

FIG. 32 illustrates an example of state management information stored by the policy transition identifying unit;

FIGS. 33A and 33B are diagrams for describing the functions of an SLA check unit and an SLA determining unit;

FIG. 34 is a diagram for describing execution examples by the SLA check unit and the SLA determining unit;

FIG. 35 illustrates an example of state management information stored by the SLA determining unit;

FIG. 36 illustrates an output example of an output unit;

FIG. 37 is a flowchart of an advance verification process;

FIG. 38 is a flowchart of a state creation process;

FIG. 39 is a first flowchart of a process of integrating or deleting the state information;

FIG. 40 is a second flowchart of a process of integrating or deleting the state information;

FIG. 41 is a flowchart of a state transition creation process;

FIG. 42 is a flowchart of a state transition identification process;

FIG. 43 is a flowchart of an SLA determination process; and

FIG. 44 is a flowchart of an output process.

### DESCRIPTION OF EMBODIMENTS

Preferred embodiments of the present invention will be explained with reference to accompanying drawings. Note that in the present specification and drawings, elements having substantially the same functions are denoted by the same reference numerals, and overlapping descriptions are omitted.

### EMBODIMENT

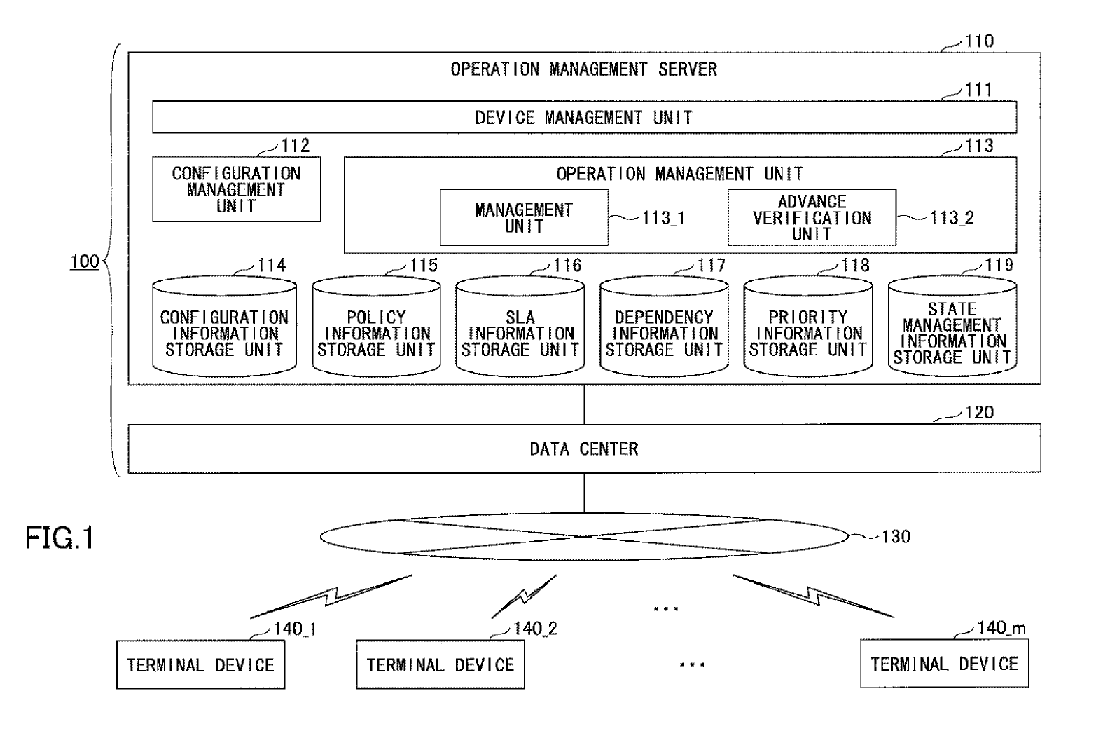

First, a description is given of the overall configuration of a cloud system including an operation management server in which an advance verification program according to an embodiment is installed. FIG. 1 illustrates an example of the overall configuration of a cloud system including an operation management server.

As illustrated in FIG. 1, a cloud system 100 includes an operation management server 110 forming a management system, and a data center 120 forming a service providing system that includes a plurality of devices and that provides services. The operation management server 110 and the data center 120 are communicatively connected to each other. Furthermore, as illustrated in FIG. 1, terminal devices 140_1 through 140_m (m is any integer number) are connected to the cloud system 100 via a network 130.

The operation management server 110 includes a device management unit 111, a configuration management unit 112, and an operation management unit 113.

The device management unit 111 measures the state of the respective devices (servers, storages, switches, etc.) included in the data center 120, and the state of the network between the devices, and manages the measured states as actual measurement values. Furthermore, the device management unit 111 measures the state of the availability zone in the data center 120, the state of a virtual machine (VM) operating in a server included in the data center 120, and the state of the user using the data center 120, and manages the measured states as actual measurement values. The device management unit 111 stores the actual measurement values, which are obtained by measuring the management targets, in a configuration information storage unit 114 as configuration information. Note that an availability zone means each zone in a case where the physical devices, etc., are distributed and separated into zones for the purpose of failure measures and disaster recovery.

The configuration management unit 112 manages the specifications of the devices (servers, storages, switches, etc.) and the network included in the data center 120, and information relevant to the sections of the availability zones included in the data center 120, etc. Furthermore, the configuration management unit 112 manages the specifications of the VM operating in the server, and attribute information, etc., indicating the attribute of the user using the data center 120. Furthermore, the configuration management unit 112 manages information of server configuration items and relationship information indicating the relationship of operations between devices, included in the data center 120. The configuration management unit 112 stores the fixed values with respect to these management targets as configuration information, in the configuration information storage unit 114.

The operation management unit 113 includes a management unit 113_1 and an advance verification unit 113_2. The management unit 113_1 monitors the data center 120 and automatically executes an operation management task according to policy information stored in a policy information storage unit 115, when various events such as a failure, a configuration change, etc., occurs. Accordingly, the service quality assurance (SLA: Service Level Agreement) is satisfied. The SLA is an example of quality information in which the quality defined by the administrator managing the data center 120 (the quality to be satisfied by a service provided by the data center 120) is described. Note that the SLA defined by the administrator managing the data center 120 is stored in advance in an SLA information storage unit 116 as SLA information.

The policy information, which the management unit 113_1 complies with when performing an operation management task, includes a plurality of policy rules defining process contents corresponding to task contents of operation management tasks that are performed when various events occur.

The advance verification unit 113_2 determines whether the data center 120 will operate normally and outputs the determination result, based on policy information stored in the policy information storage unit 115, at the timing when the data center 120 is about to start operating. The determination of whether the data center 120 will normally operate is performed by determining whether the state of the device, which has fallen into a state of not satisfying the SLA because an event has occurred, will transition to a state of satisfying the SLA, by applying a policy rule (by complying with the SLA).

When the policy rule included in the policy information is not appropriately defined, the state of the device will not transition to a state of satisfying the SLA by applying the policy rule, when the state of the device has fallen into a state of not satisfying the SLA because an event has occurred in the data center 120. As a result, the user using the data center 120 is adversely affected. In view of such circumstances, the advance verification unit 113_2 determines whether the data center 120 will normally operate, at a timing when the data center 120 is about to start operating.

Note that the timing when the data center 120 is about to start operating includes, for example, a timing when a new data center 120 is constructed and the new data center 120 is about to actually start operating, a timing when the configuration inside the data center 120 has been changed and the data center 120 is subsequently about to start operating, etc. Furthermore, a timing when various kinds of information such as policy information stored in the policy information storage unit 115 are changed and the data center 120 is subsequently about to start operating, etc., may be included.

Note that the operation of determining whether the data center 120 will normally operate and outputting the determination result at a timing when the data center 120 is about to start operating, is hereinafter referred to as “advance verification”.

In advance verification, the advance verification unit 113_2 creates “state transition information” indicating how the state of each device included in the data center 120 will transition (transition of state). The “state information” indicates the state of a device. The state transition information is information connecting the state information of the transition source and the state information of the transition destination in a case where the state of the device transitions. The state transition information includes the state information of the transition source, the state information of the transition destination, and information indicating the direction of transition. The advance verification unit 113_2 determines whether the state of the device will transition from a state of not satisfying the SLA to a state of satisfying the SLA, based on the state transition information and the SLA information. Accordingly, the advance verification unit 113_2 is able to determine whether the policy rule, which is necessary for the state of the device to transition from a state of not satisfying the SLA to a state of satisfying the SLA, is defined in the policy information stored in the policy information storage unit 115.

Note that when the advance verification unit 113_2 creates the state transition information, the advance verification unit 113_2 refers to dependency information defining the dependency relationships between states of devices, and priority information defining the order of priority of policy rules to be applied when operation management tasks are performed according to the policy information. The dependency information is stored in advance in a dependency information storage unit 117, and the priority information is stored in advance in a priority information storage unit 118.

In advance verification, the state information and the state transition information created by the advance verification unit 113_2 are stored in a state management information storage unit 119 as state management information.

The device management unit 111, the configuration management unit 112, the management unit 113_1, and the advance verification unit 113_2 are respectively realized as an exclusive-use program is executed by a computer in the operation management server 110. For example, the advance verification unit 113_2 is realized as an advance verification program is executed by a computer in the operation management server 110.

The data center 120 includes devices (computing resources) such as servers and storages, and provides these computing resources to the terminal devices 140_1 through 140_m of users via the network 130. Accordingly, the data center 120 functions as a service providing system that provides cloud computing services to the terminal devices 140_1 through 140_m of the users.

The terminal devices 140_1 through 140_m are devices used by the users using services provided by the data center 120. The users make a connection request to the data center 120 by using the terminal devices 140_1 through 140_m, to use computing resources included in the data center 120. Accordingly, the users are able to use the cloud computing services provided by the data center 120.

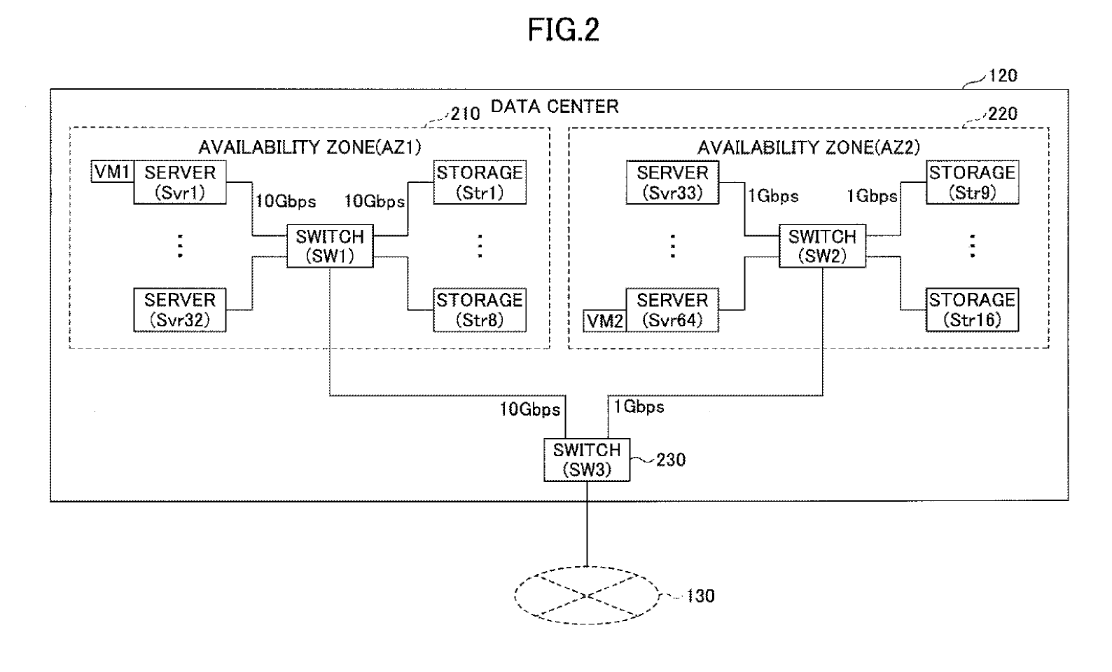

Next, a description is given of the system configuration inside the data center 120. FIG. 2 illustrates an example of a system configuration inside the data center 120. As illustrated in FIG. 2, the data center 120 is separated into a plurality of availability zones. In the example of FIG. 2, the data center 120 is separated into two availability zones, i.e., an availability zone 210 (zone name=“AZ1”) and an availability zone 220 (zone name=“AZ2”).

Each of the availability zones 210 and 220 includes a plurality of servers, a plurality of storages, and a switch, and the plurality of servers and the plurality of storages are connected to each other via the switch.

According to the example of FIG. 2, the availability zone 210 includes 32 servers (server names=“Svr1” through “Svr32”), 8 storages (storage names=“Str1” through “Str8”), and one switch (switch name=“SW1”). Furthermore, the communication speed in the availability zone 210 is 10 Gbps. Furthermore, in the server having the server name=“Svr1”, a VM (VM name=“VM1”) is operating.

Similarly, the availability zone 220 includes 32 servers (server names=“Svr33” through “Svr64”), 8 storages (storage names=“Str9” through “Str16”), and one switch (switch name=“SW2”). Furthermore, the communication speed in the availability zone 220 is 1 Gbps. Furthermore, in the server having the server name=“Svr64”, a VM (VM name=“VM2”) is operating.

Furthermore, according to the example of FIG. 2, the switch in the availability zone 210 and the switch in the availability zone 220 are connected to the network 130 via a switch (switch name=“SW3”).

Furthermore, according to the example of FIG. 2, the communication speed between the switch having the switch name=“SW1” and the switch having the switch name=“SW3” is 10 Gbps. Furthermore, the communication speed between the switch having the switch name=“SW2” and the switch having the switch name=“SW3” is 1 Gbps.

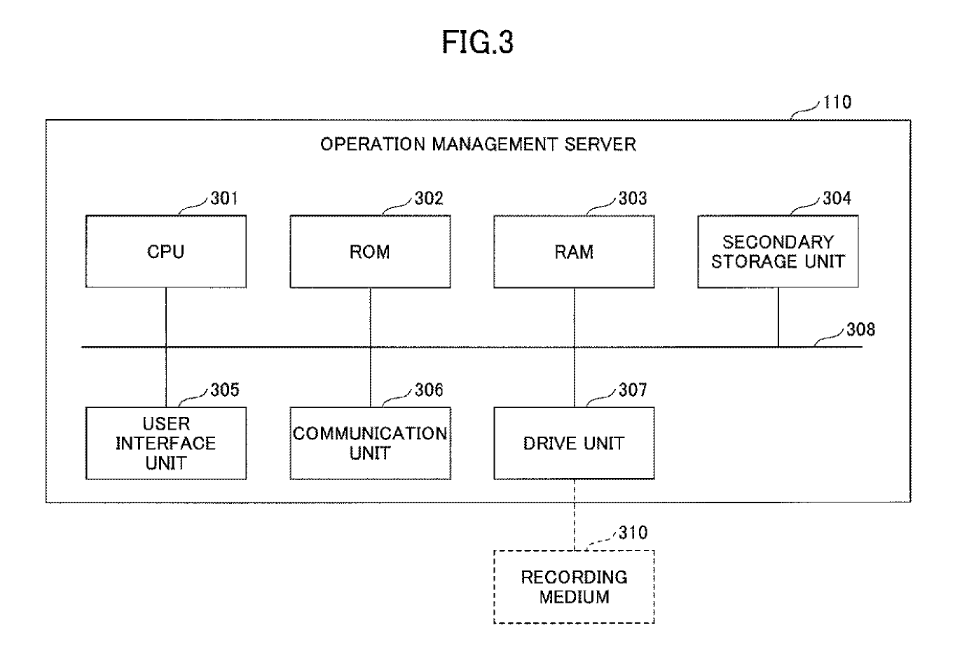

Next, a description is given of a hardware configuration of the operation management server 110. FIG. 3 illustrates an example of a hardware configuration of the operation management server 110. As illustrated in FIG. 3, the operation management server 110 includes a CPU (Central Processing Unit) 301, a ROM (Read-Only Memory) 302, and a RAM (Random Access Memory) 303. Furthermore, the operation management server 110 includes a secondary storage unit 304, a user interface unit 305, a communication unit 306, and a drive unit 307. Note that the units of the operation management server 110 are connected to each other via a bus 308.

The programs installed in the secondary storage unit 304 (for example, the advance verification program, etc.) are executed by the CPU 301. The ROM 302 is a non-volatile memory. The ROM 302 functions as a main storage unit storing various programs and data, etc., necessary when the CPU 301 executes various programs stored in the secondary storage unit 304. Specifically, the ROM 302 stores boot programs, etc., such as BIOS (Basic Input/Output System) and EFI (Extensible Firmware Interface), etc.

The RAM 303 is a volatile memory such as DRAM (Dynamic Random Access Memory) and SRAM (Static Random Access Memory), etc., and functions as a main storage unit. The RAM 303 provides a work area for parts of various programs stored in the secondary storage unit 304 for execution by the CPU 301.

The secondary storage unit 304 is a device storing various programs installed in the operation management server 110, and information (configuration information, policy information, SLA information, dependency information, priority information, and state management information, etc.) used when various programs are executed by the CPU 301.

The user interface unit 305 is a device used when the administrator inputs various instructions in the operation management server 110. Furthermore, the user interface unit 305 is a device for displaying various processing results (for example, determination results) obtained by the operation management server 110.

The communication unit 306 is a device for communicating with the data center 120 to which the operation management server 110 is connected.

The drive unit 307 is a device for setting a recording medium 310. The recording medium 310 described here includes media for optically, electrically, or magnetically recording information, such as a CD-ROM, a flexible disk, and a magnetic optical disk, etc. Furthermore, the recording medium 310 also includes a semiconductor memory, etc., for electrically recording information, such as a ROM and a flash memory, etc.

Note that, for example, the advance verification program stored in the secondary storage unit 304 is stored as the distributed recording medium 310 is set in the drive unit 307 and the advance verification program recorded in the recording medium 310 is read by the drive unit 307. Alternatively, the advance verification program stored in the secondary storage unit 304 may be stored by being received via the communication unit 306.

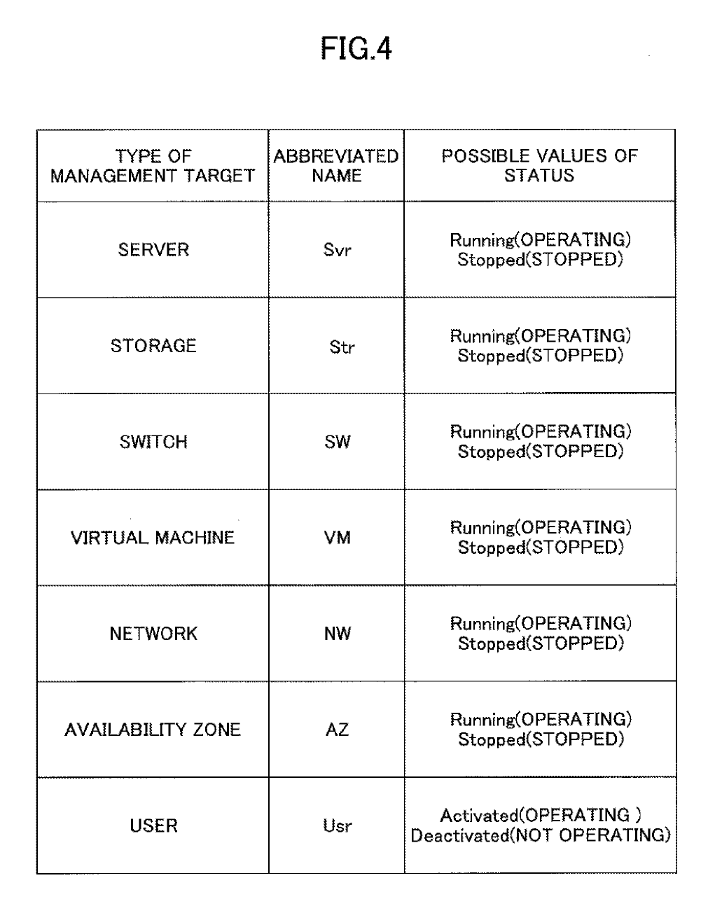

Next, a description is given of the types of management targets managed by the operation management server 110. FIG. 4 illustrates the types of management targets. As illustrated in FIG. 4, the management targets managed by the operation management server 110 include a server, a storage, a switch, and a virtual machine. Furthermore, the management targets managed by the operation management server 110 include a network, an availability zone, and a user.

Note that in the following descriptions, the management targets may be indicated by abbreviated names. The abbreviated names of the management targets are server=Svr, storage=Str, switch=SW, virtual machine=VM, network=NW, availability zone=AZ, and user=Usr.

Furthermore, as illustrated in FIG. 4, the values expressing the status (status indicating the operation state) of the management target may be “running” or “stopped”, in the case where the management target is a server, a storage, a switch, a virtual machine, a network, and an availability zone. “Running” expresses that the status of the management target is operating, and “stopped” expresses that the status of the management target is stopped.

Furthermore, as illustrated in FIG. 4, the values expressing the status of the management target when the type of the management target is user may be “activated” or “deactivated”. “Activated” expresses that the status of the user is operating (in a state where the user has made a connection request and is using the data center 120), and “deactivated” expresses that the status of the user is not operating (not using the data center 120).

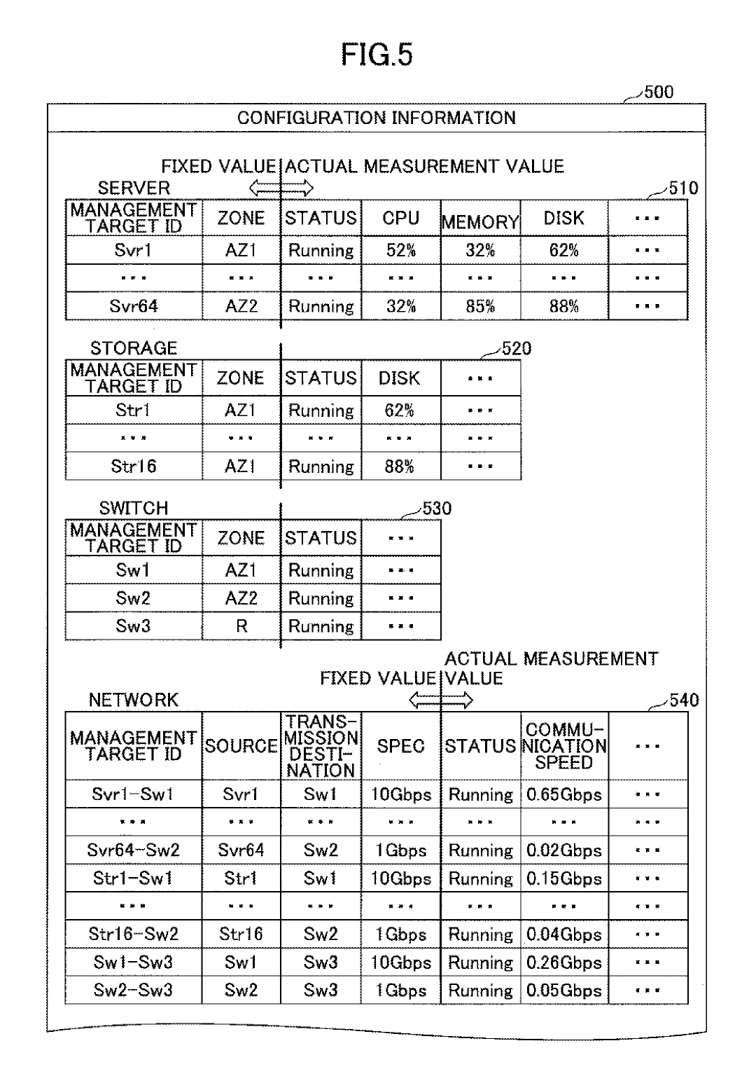

Next, a description is given of the configuration information stored in the configuration information storage unit 114 of the operation management server 110, with reference to FIGS. 5 through 7. FIG. 5 is a first diagram illustrating an example of configuration information.

As illustrated in FIG. 5, in configuration information 500, information indicating the configuration of the data center 120 is stored. Specifically, in the configuration information 500, the specifications of the devices (servers, storages, switches, etc.) and the network included in the data center 120, are stored as fixed values. Furthermore, in the configuration information 500, the states of the management targets included in the data center 120, are stored as actual measurement values.

For example, configuration information 510 with respect to the server includes, “management target ID”, “zone”, “status”, “CPU”, “memory”, and “disk”, etc., as information items. The server included in the data center 120 is managed by the configuration management unit 112, with respect to the information items included in the configuration information 510. Furthermore, the present state of the server included in the data center 120 is managed by the device management unit 111, with respect to the information items included in the configuration information 510.

Furthermore, configuration information 520 with respect to the storage, configuration information 530 with respect to the switch, and configuration information 540 with respect to the network also include similar information items. The storage, the switch, and the network included in the data center 120 are managed by the configuration management unit 112, with respect to the information items. Furthermore, the present state of the storage, the switch, and the network is managed by the device management unit 111, with respect to the information items.

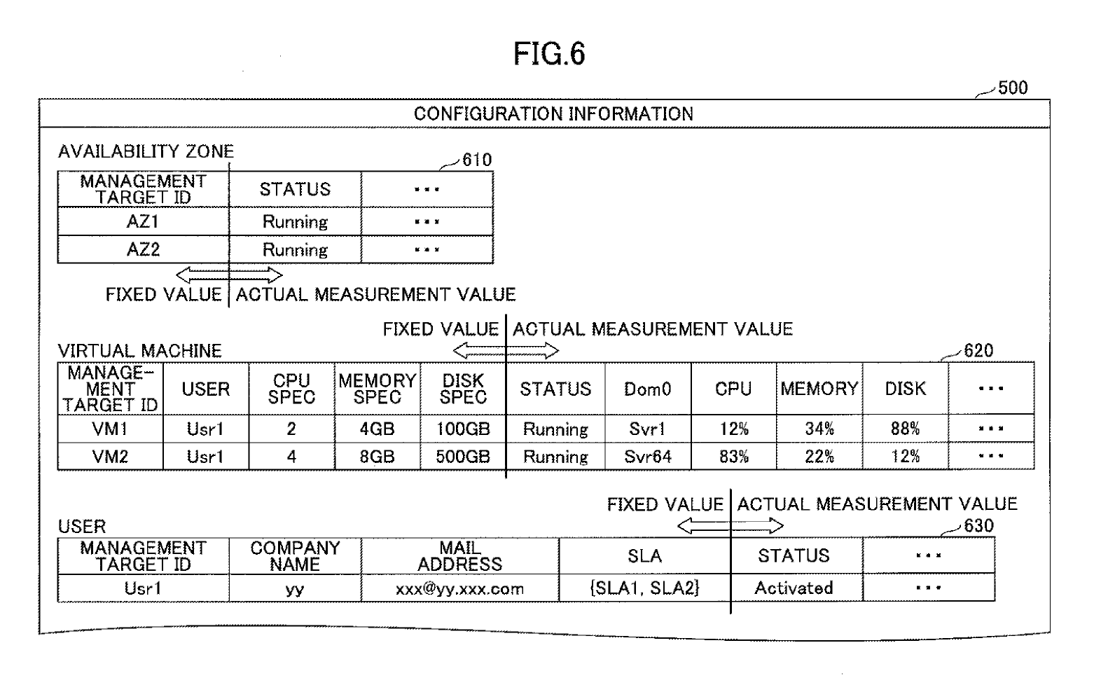

FIG. 6 is a second diagram illustrating an example of configuration information. As illustrated in FIG. 6, in the configuration information 500, sections of availability zones, specifications of the virtual machine, and attribute information indicating the attribute of the user using the data center 120, etc., are further stored as fixed values. Furthermore, in the configuration information 500, the states of the management targets included in the data center 120 are stored as actual measurement values.

For example, configuration information 610 of the availability zone includes “management target ID” and “status” as information items. The availability zones included in the data center 120 are managed by the configuration management unit 112, and the present state of the availability zones are managed by the device management unit 111, with respect to the information items included in the configuration information 610.

Furthermore, configuration information 620 with respect to the virtual machine and attribute information 630 with respect to a user include similar information items. Therefore, the VM operating in the server of the data center 120 and attribute information, etc., of a user using the data center 120 are managed by the configuration management unit 112, with respect to the information items. Furthermore, the present states of the respective VMs and the respective users are managed by the device management unit 111, with respect to the information items.

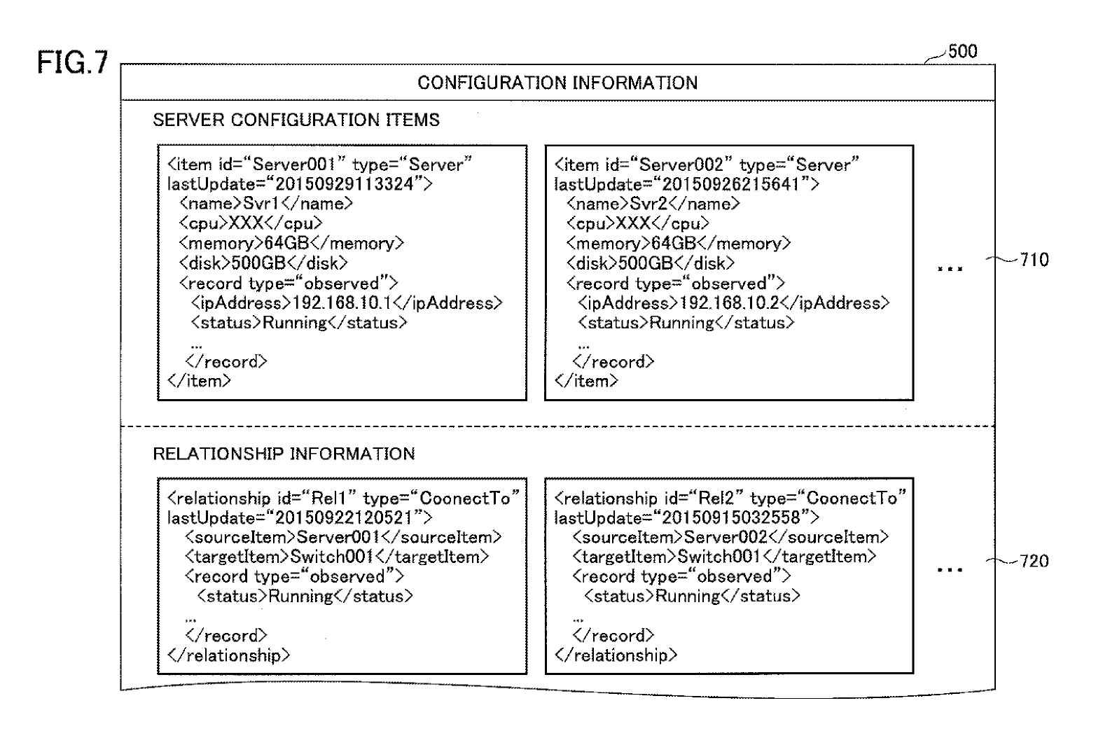

FIG. 7 is a third diagram illustrating an example of configuration information. As illustrated in FIG. 7, in the configuration information 500, information 710 indicating server configuration items and relationship information 720 indicating the relationships of operations between devices are stored. In the information 710 indicating server configuration items, for example, information indicating the detailed specifications of the servers included in the data center 120 is described.

Furthermore, in the relationship information 720 indicating the relationships of operations between devices, for example, information indicating the relationship between an operation of a server and an operation of a switch is described. For example, a server having a server name=“Svr1” operates when a switch having a switch name=“SW1” is “running (operating)”, but does not operate when the switch is “stopped”. Therefore, in the relationship information 720, information indicating the relationship between the operation of the server having the server name=“Svr1” and the operation of the switch having the switch name=“SW1” is described.

As described above, in the relationship information 720 indicating the relationships of operations between devices, information indicating a relationship that when the operation of one device stops, the operation of another device also stops, etc., is described.

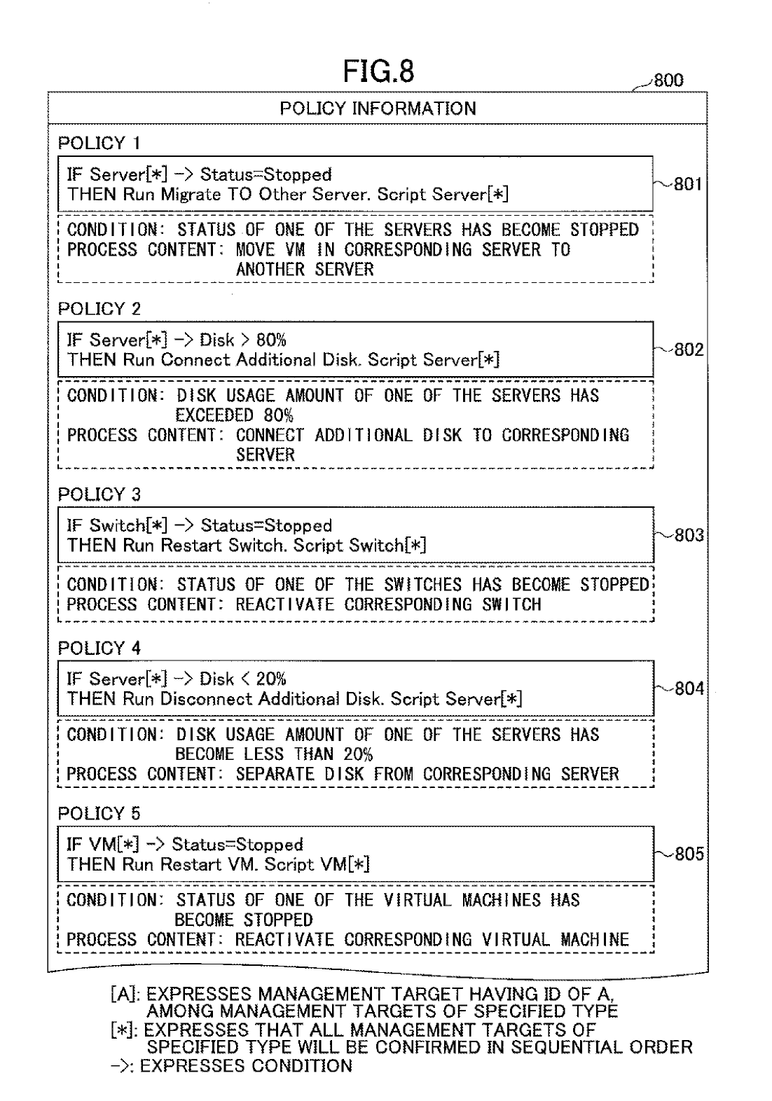

Next, a description is given of policy information stored in the policy information storage unit 115 of the operation management server 110. FIG. 8 illustrates an example of policy information.

As illustrated in FIG. 8, policy information 800 includes a plurality of policy rules 801 through 805. In each of the policy rules 801 through 805, a condition for determining whether an event has occurred, and a process content corresponding to the task content of the operation management task performed when the condition is satisfied, are defined.

Furthermore, as illustrated in FIG. 8, in the policy rules 801 through 805, the conditions and the task contents of the operation management tasks are described in a form that can be interpreted by the advance verification program. In FIG. 8, “[A]” expresses a management target having a management target ID of A, among the management targets of the specified type. “[*]” expresses that all of the management targets of the specified type will be confirmed in a sequential order. “->” expresses that a condition is described.

Note that the contents described in dotted-line frames below each of the policy rules 801 through 805 express the policy rules 801 through 805 rewritten into a form that can be interpreted by a human being. As can be clearly seen in the descriptions in the dotted-line frames, in each of the policy rules 801 through 805, a condition for determining whether an event has occurred, is described in the “IF part”. Furthermore, the process content corresponding to the task content of the operation management task performed when the condition is satisfied, is defined in the “THEN part” in each of the policy rules 801 through 805.

The policy rule 801 (policy name=“policy 1”) defines that when the status of any one of the servers included in the data center 120 becomes stopped, a VM operating in the corresponding server is to be moved to another server.

The policy rule 802 (policy name=“policy 2”) defines that when the disk usage amount of any one of the servers included in the data center 120 exceeds 80%, an additional disk is connected to the corresponding server.

The policy rule 803 (policy name=“policy 3”) defines that when the status of any one of the switches included in the data center 120 becomes stopped, the corresponding switch is to be reactivated.

The policy rule 804 (policy name=“policy 4”) defines that when the disk usage amount of any one of the servers included in the data center 120 becomes less than 20%, the disk of the corresponding server is to be separated from the corresponding server.

The policy rule 805 (policy name=“policy 5”) defines that when the status of any one of the VMs operating in the servers included in the data center 120 becomes stopped, the corresponding VM is to be reactivated.

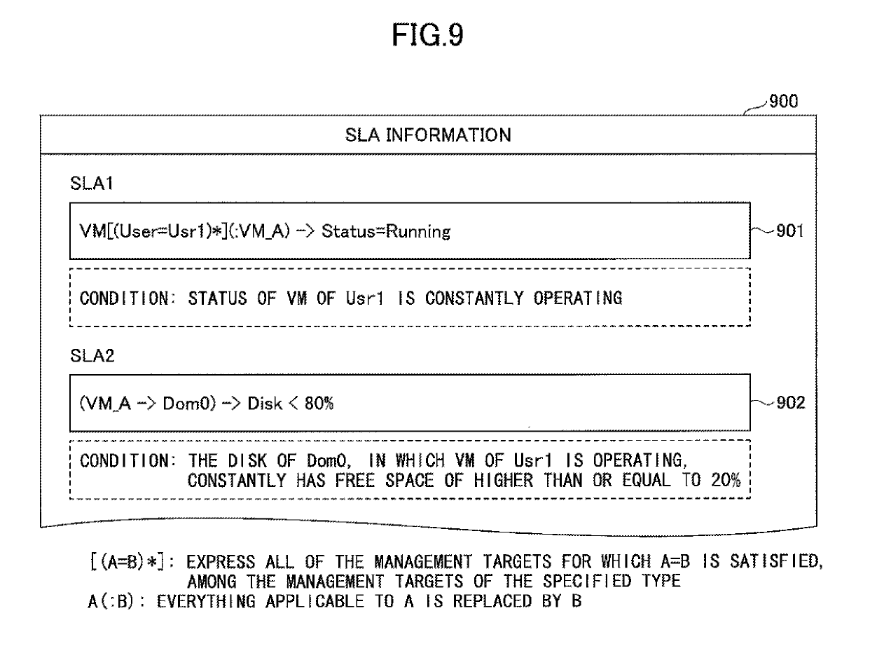

Next, a description is given of the SLA information stored in the SLA information storage unit 116 of the operation management server 110. FIG. 9 illustrates an example of SLA information.

As illustrated in FIG. 9, in SLA information 900, a plurality of SLAs 901, 902 are stored. The SLAs 901, 902 define information relevant to the quality to be satisfied by performing an operation management task by the management unit 113_1 (the quality to be satisfied in a service provided by the data center 120). Note that the SLAs 901, 902 are also described in a form that can be interpreted by the advance verification program, similar to the policy rules.

In FIG. 9, [(A=B)*] expresses all of the management targets for which A=B is satisfied, among the management targets of the specified type. Furthermore, A(:B) expresses that everything applicable to A is replaced by B. Note that the contents described in dotted-line frames below each of the SLAs 901, 902 express the SLAs 901, 902 rewritten into a form that can be interpreted by a human being.

The SLA 901 (SLA name=“SLA1”) defines that the status of the VM of a user identified by “Usr1” is constantly operating, as information relevant to the quality to be satisfied in the service provided by the data center 120.

The SLA 902 (SLA name=“SLA2”) defines that the disk of Dom0, in which the VM of a user identified by “Usr1” is operating, constantly has free space of higher than or equal to 20%, as information relevant to the quality to be satisfied in the service provided by the data center 120. Note that Dom0 is the abbreviation of domain 0, and is an OS (Operating System) that fulfills a particular role in the OS operating in the VM.

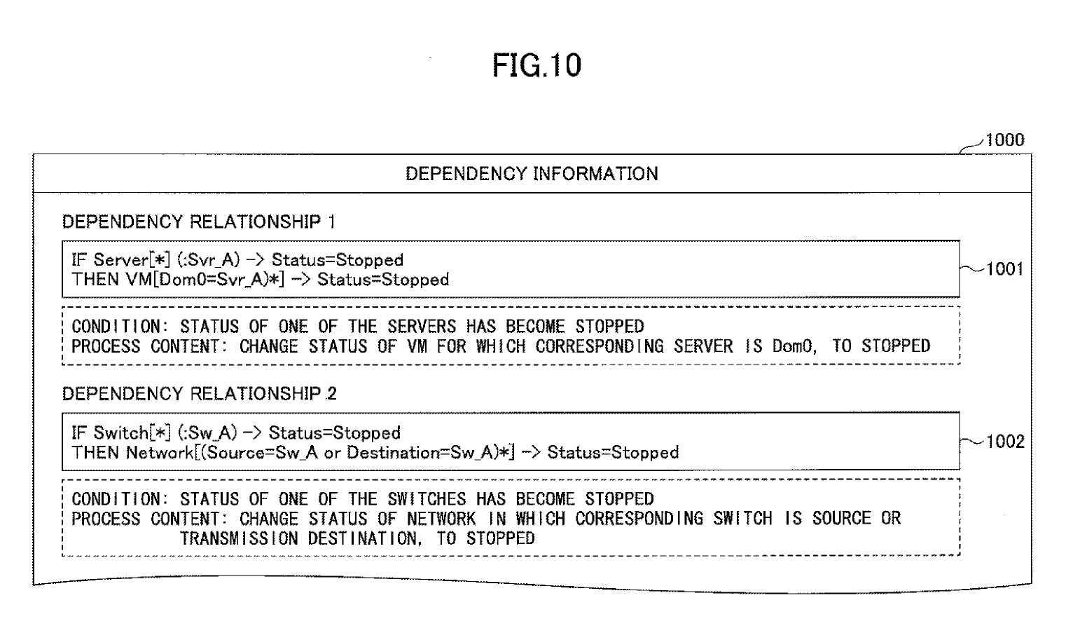

Next, a description is given of the dependency information stored in the dependency information storage unit 117 of the operation management server 110. FIG. 10 illustrates an example of dependency information.

As illustrated in FIG. 10, dependency information 1000 includes a plurality of dependency relationships 1001, 1002. The dependency relationships 1001, 1002 define the dependency relationships of states of devices included in the data center 120.

The dependency relationship 1001 (relationship name=“dependency relationship 1”) defines that when the status of any one of the servers included in the data center 120 becomes stopped, the status of the VM operating in the corresponding server as the server of Dom0 also becomes stopped.

According to the dependency relationship 1001, for example, when the VM is operating in a server having a server name=“Svr1” as the server of Dom0, and the server having the server name=“Svr1” stops and Dom0 stops, the VM that has been operating also stops.

The dependency relationship 1002 (relationship name=“dependency relationship 2”) defines that when the status of any one of the switches included in the data center 120 becomes stopped, the status of a network using the corresponding switch as the source or the transmission destination also stops.

According to the dependency relationship 1002, for example, when a switch having a switch name=“SW1” stops, a network using the switch having the switch name=“SW1” as the source or the transmission destination also stops.

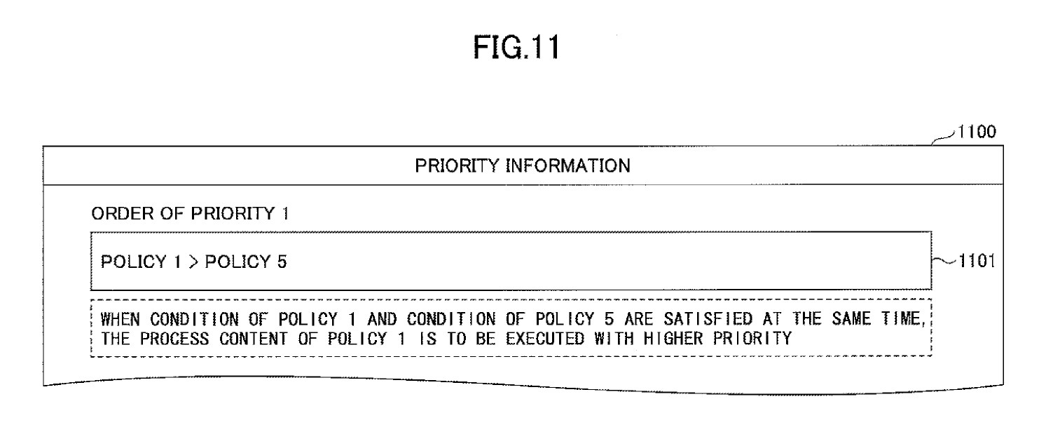

Next, a description is given of the priority information stored in the priority information storage unit 118 of the operation management server 110. FIG. 11 illustrates an example of priority information.

As illustrated in FIG. 11, priority information 1100 includes an order of priority 1101. The order of priority 1101 defines the order of priority of policy rules to be applied when performing an operation management task according to the policy information.

The order of priority 1101 (order name=“order of priority 1”) defines that when a policy rule having a policy name=“policy 1” and a policy rule having a policy name=“policy 5” are satisfied at the same time, the policy rule having the policy name=“policy 1” is to be applied with higher priority.

According to the order of priority 1101, when a VM stops because the server in which the VM is operating has stopped, among the servers included in the data center 120, the management unit 113_1 moves the VM to another server before reactivating the VM. That is, before applying the policy rule having the policy name=“policy 5”, the policy rule having the policy name=“policy 1” is applied. Accordingly, if another server is operating, the VM can be operated.

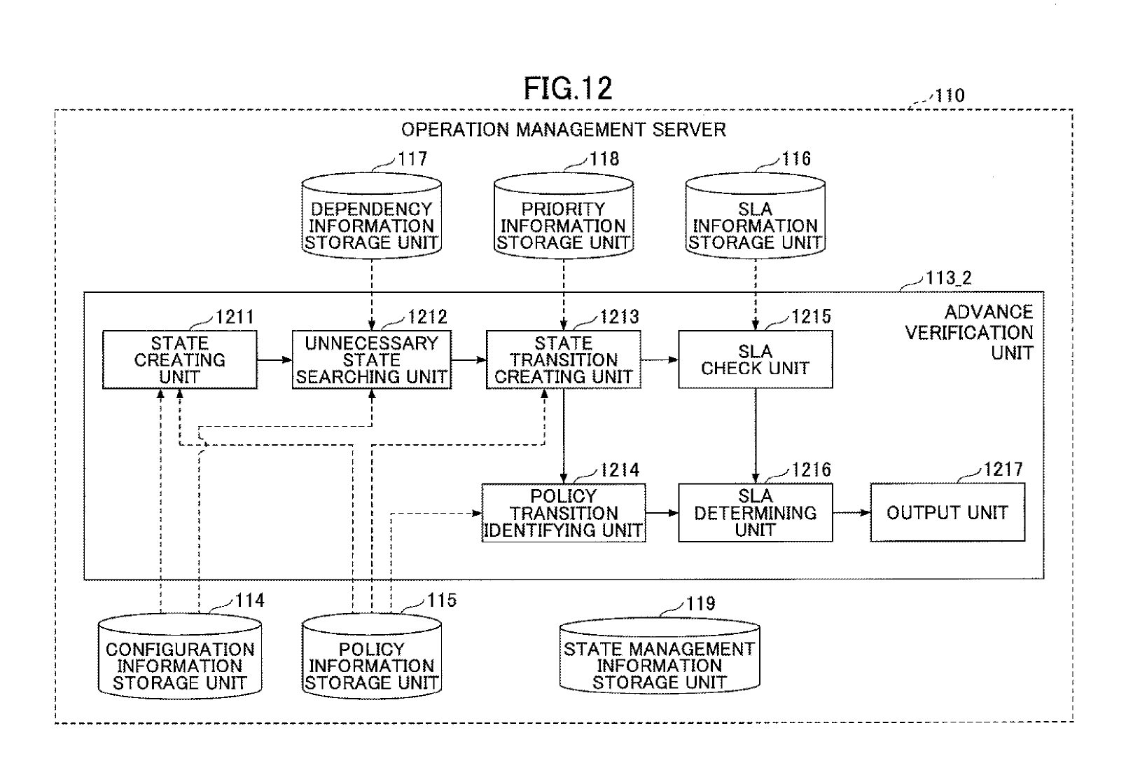

Next, a description is given of a functional configuration of the advance verification unit 113_2. FIG. 12 illustrates an example of a functional configuration of the advance verification unit 113_2.

As illustrated in FIG. 12, the advance verification unit 113_2 includes a state creating unit 1211, an unnecessary state searching unit 1212, a state transition creating unit 1213, a policy transition identifying unit 1214, an SLA check unit 1215, an SLA determining unit 1216, and an output unit 1217. Note that in FIG. 12, the dotted-line arrows express reading information from the respective storage units. Furthermore, in FIG. 12, the solid line arrows express that the information created at the functional unit at the start of the solid-line arrow is stored in the state management information storage unit 119, and that the functional unit at the end of the solid-line arrow reads the information from the state management information storage unit 119.

The state creating unit 1211 creates the state information of each device that is a management target, based on the configuration information 500 stored in the configuration information storage unit 114 and the policy information 800 stored in the policy information storage unit 115. The policy rules 801 through 805 included in the policy information 800 include an “IF part” defining the condition for determining whether an event has occurred. Therefore, the state creating unit 1211 creates state information of the devices that are management targets included in the configuration information 500, based on the “IF part” in the policy rules 801 through 805. Note that the state creating unit 1211 creates state information for all of the devices having a management target ID.

Furthermore, for example, the state creating unit 1211 creates new state information by combining the state information items created for the respective management target IDs, or combining state information items created based on different policy rules.

The unnecessary state searching unit 1212 decreases the number of state information items created by the state creating unit 1211 and stored in the state management information storage unit 119. When the number of state information items is large, the number of state transition information items to be created will increase, and the processing load of the operation management server 110 will increase when executing the advance verification process. For this reason, the number of state information items is decreased.

The unnecessary state searching unit 1212 performs a process of integrating the state information items, when there are overlapping parts in a part of the state contents describing the states of the devices in the state information items created by the state creating unit 1211.

Accordingly, the unnecessary state searching unit 1212 is able to decrease the number of state information items stored in the state management information storage unit 119.

Furthermore, for example, the unnecessary state searching unit 1212 performs a process of deleting the state information including a description relevant to the internal state of a device whose status is stopped, among the state information items created by the state creating unit 1211. Accordingly, the unnecessary state searching unit 1212 is able to decrease the number of state information items stored in the state management information storage unit 119.

Furthermore, for example, the unnecessary state searching unit 1212 performs a process of integrating the state information items created separately, when a combination of various states of devices of the same type, among the plurality of devices that are the management targets, is created as different state information items. Accordingly, the unnecessary state searching unit 1212 is able to decrease the number of state information items stored in the state management information storage unit 119. However, even when the state information items created separately are integrated, when a dependency relationship between the states of the corresponding device is defined in the dependency information 1000, the unnecessary state searching unit 1212 corrects the integrated state information items. That is, the unnecessary state searching unit 1212 recreates the integrated state information items as separate state information items, according to the dependency relationship between the states of the device.

Furthermore, for example, the unnecessary state searching unit 1212 performs a process of deleting state information indicating a state that is determined not to exist, based on the dependency relationship defined in the dependency information 1000, from the state information items created by the state creating unit 1211. Accordingly, the unnecessary state searching unit 1212 is able to decrease the number of state information items stored in the state management information storage unit 119.

Note that the order of executing the above processes by the unnecessary state searching unit 1212 for decreasing the number of state information items, may be in any order. Furthermore, the unnecessary state searching unit 1212 does not need to execute all of the above processes for decreasing the number of state information items; the unnecessary state searching unit 1212 may only execute some of the above processes.

The state transition creating unit 1213 lists the state transition information indicating the transition of the states of the devices that are the management targets. Specifically, the state transition creating unit 1213 creates state transition information connecting the state information items of each device, based on the state information stored in the state management information storage unit 119.

In creating the state transition information, for example, the state transition creating unit 1213 creates state transition information connecting the state information items based on the policy rule used when the state information items have been created. Note that the state transition information as viewed from one of the state information items, is hereinafter expressed as “the state transition information corresponding to the state information”.

Furthermore, when creating state transition information connecting the state information items, which have been created by combining a plurality of state information items, for example, the state transition creating unit 1213 creates the state transition information connecting the state information items after being combined, based on the state transition information connecting the state information items before being combined. Accordingly, the state transition information, which is created based on the policy rule used when creating the state information items before being combined, is carried on.

Furthermore, when creating state transition information connecting the state information items, which have been created by integrating a plurality of state information items, for example, the state transition creating unit 1213 creates the state transition information connecting the state information items after being integrated, based on the state transition information connecting the state information items before being integrated. Accordingly, the state transition information, which is created based on the policy rule used when creating the state information items before being integrated, is carried on.

Furthermore, when state information, which includes a description relevant to the internal state of a device whose status is in a stopped state, has been deleted by the unnecessary state searching unit 1212, the state transition creating unit 1213 creates state transition information connecting other relevant state information items.

Specifically, the state transition creating unit 1213 creates state transition information connecting other relevant state information items, based on the policy rule used when creating the state information before being deleted.

Furthermore, when state information indicating a state that cannot exist is deleted by the unnecessary state searching unit 1212, the state transition creating unit 1213 creates state transition information connecting other relevant state information items. Specifically, the state transition creating unit 1213 creates state transition information connecting other relevant state information items, based on the policy rule used when creating the state information before being deleted.

Note that the state transition creating unit 1213 stores the created state transition information in the state management information storage unit 119.

The policy transition identifying unit 1214 identifies the transition of the state of each device when the policy rules 801 through 805 included in the policy information 800 stored in the policy information storage unit 115 are applied. Accordingly, the policy transition identifying unit 1214 can recognize how the state of each device transitions by applying the policy rules 801 through 805.

Furthermore, the policy transition identifying unit 1214 compares the transition of the state of each device that has been identified with the transition of the state of each device indicated by the state transition information stored in the state management information storage unit 119. Accordingly, the policy transition identifying unit 1214 can recognize which state transition information indicates the transition of a state corresponding to the transition of a state that will occur by applying the policy rules 801 through 805.

The SLA check unit 1215 compares the state transition information stored in the state management information storage unit 119 with the SLAs 901, 902 included in the SLA information 900 stored in the SLA information storage unit 116. Accordingly, the SLA check unit 1215 is able to determine the state transition information, in which the state information indicating a state that does not satisfy the SLA, is the transition source.

The SLA determining unit 1216 determines the state transition information to which the transition of the state identified by the policy transition identifying unit 1214 does not correspond, among the state transition information items determined by the SLA check unit 1215.

Furthermore, the SLA determining unit 1216 performs the following determinations, according to whether the SLA determining unit 1216 has determined the state transition information to which the transition of the state identified by the policy transition identifying unit 1214 does not correspond.

That is, when such state transition information has been determined, the SLA determining unit 1216 determines that there is state transition information in which the state of the device does not transition from a state of not satisfying the SLA to a state of satisfying the SLA, even by applying the present policy rule.

On the other hand, when such state transition information has not been determined, the SLA determining unit 1216 determines that there is no state transition information in which the state of the device does not transition from a state of not satisfying the SLA to a state of satisfying the SLA, by applying the present policy rule.

The SLA determining unit 1216 reports the determination result obtained by making a determination according to whether such state transition information has been determined, to the output unit 1217. Note that the determination result reported to the output unit 1217 includes the determined state transition information per se, in addition to an indication of whether there is determined state transition information.

The output unit 1217 outputs the determination result reported from the SLA determining unit 1216. When the SLA determining unit 1216 reports a determination result indicating that there is determined state transition information, the output unit 1217 outputs a message saying that there is a case where the state of the device does not transition to a state of satisfying the SLA, even by applying the present policy rule. Furthermore, the output unit 1217 outputs at least one of the state information of the transition source and the state information of the transition destination, included in the state transition information by which the state of the device does not transition from a state of not satisfying the SLA to a state of satisfying the SLA, even by applying the present policy rule.

On the other hand, when the SLA determining unit 1216 reports a determination result indicating that there is no determined state transition information, the output unit 1217 outputs a message saying that the present policy rule is appropriate.

Accordingly, the administrator is able to recognize that there is a case where the state of the device does not transition to a state of satisfying the SLA, even by applying the present policy rule. Furthermore, the administrator is able to recognize the state information indicating the state of the device that is the transition source, in a case where the state of the device does not transition to a state of satisfying the SLA even by applying the present policy rule. Furthermore, the administrator is able to recognize the state information indicating the state of the device that is the transition destination to which the state is to transition, in order to satisfy the SLA.

Next, a detailed description is given of the functions of the respective units of the advance verification unit 113_2 (the state creating unit 1211, the unnecessary state searching unit 1212, the state transition creating unit 1213, the policy transition identifying unit 1214, the SLA check unit 1215, the SLA determining unit 1216, and the output unit 1217).

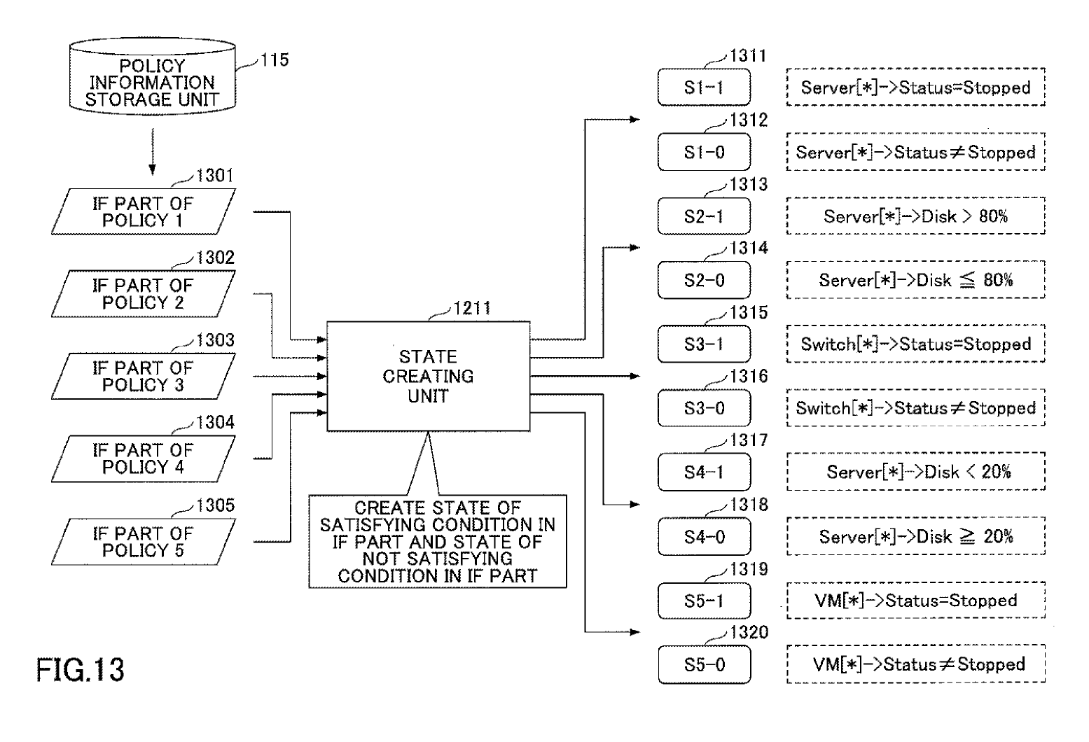

First, a detailed description is given of the function of the state creating unit 1211, with reference to FIGS. 13 through 15. FIG. 13 is a first diagram for describing the function of the state creating unit 1211, and the function of creating the state information of each device that is a management target.

As illustrated in FIG. 13, the state creating unit 1211 reads the policy rules 801 through 805 included in the policy information 800 stored in the policy information storage unit 115, and acquires the “IF parts”.

In the case of the policy rule 801 having the policy name=“policy 1”, an IF part 1301 defines that the status of one of the servers included in the data center 120 is stopped. The state creating unit 1211 creates state information indicating a state satisfying the acquired IF part 1301, and state information indicating a state that does not satisfy the acquired IF part 1301.

Specifically, the state creating unit 1211 creates state information 1311 indicating a state where the status of one of the servers is stopped, as a state satisfying the IF part 1301. Furthermore, the state creating unit 1211 creates state information 1312 indicating a state where the status of one of the servers is not stopped, as a state of not satisfying the IF part 1301.

Note that as a matter of simplifying the drawing, a “state ID (identifier)” for identifying the state information is described in each of the state information 1311 and the state information 1312, and the content of each state information (“state content”) is separately indicated in an area surrounded by a dotted line. However, it is assumed that in the actual state information, both the state ID and the state content are included.

In the case of the policy rule 802 having a policy name=“policy 2”, an IF part 1302 defines that the disk usage amount of one of the servers included in the data center 120 exceeds 80%. The state creating unit 1211 creates state information indicating a state satisfying the acquired IF part 1302, and state information indicating a state that does not satisfy the acquired IF part 1302.

Specifically, the state creating unit 1211 creates state information 1313 indicating a state where the disk usage amount of one of the servers exceeds 80%, as a state satisfying the IF part 1302. Furthermore, the state creating unit 1211 creates state information 1314 indicating a state where the disk usage amount of one of the servers is less than or equal to 80%, as a state of not satisfying the IF part 1302.

In the case of the policy rule 803 having a policy name=“policy 3”, an IF part 1303 defines that the status of one of the switches included in the data center 120 is stopped. The state creating unit 1211 creates state information indicating a state satisfying the acquired IF part 1303, and state information indicating a state that does not satisfy the acquired IF part 1303.

Specifically, the state creating unit 1211 creates state information 1315 indicating a state where the status of one of the switches is stopped, as a state satisfying the IF part 1302. Furthermore, the state creating unit 1211 creates state information 1316 indicating a state where the status of one of the switches is not stopped, as a state of not satisfying the IF part 1303.

In the case of the policy rule 804 having a policy name=“policy 4”, an IF part 1304 defines that the disk usage amount of one of the servers included in the data center 120 is less than 20%. The state creating unit 1211 creates state information indicating a state satisfying the acquired IF part 1304, and state information indicating a state that does not satisfy the acquired IF part 1304.

Specifically, the state creating unit 1211 creates state information 1317 indicating a state where the disk usage amount of one of the servers is less than 20%, as a state satisfying the IF part 1304. Furthermore, the state creating unit 1211 creates state information 1318 indicating a state where the disk usage amount of one of the servers is higher than or equal to 20%, as a state of not satisfying the IF part 1304.

In the case of the policy rule 805 having a policy name=“policy 5”, an IF part 1305 defines that the status of one of the VMs included in the data center 120 is stopped. The state creating unit 1211 creates state information indicating a state satisfying the acquired IF part 1305, and state information indicating a state that does not satisfy the acquired IF part 1305.

Specifically, the state creating unit 1211 creates state information 1319 indicating a state where the status of one of the VMs is stopped, as a state satisfying the IF part 1301. Furthermore, the state creating unit 1211 creates state information 1320 indicating a state where the status of one of the VMs is not stopped, as a state of not satisfying the IF part 1301.

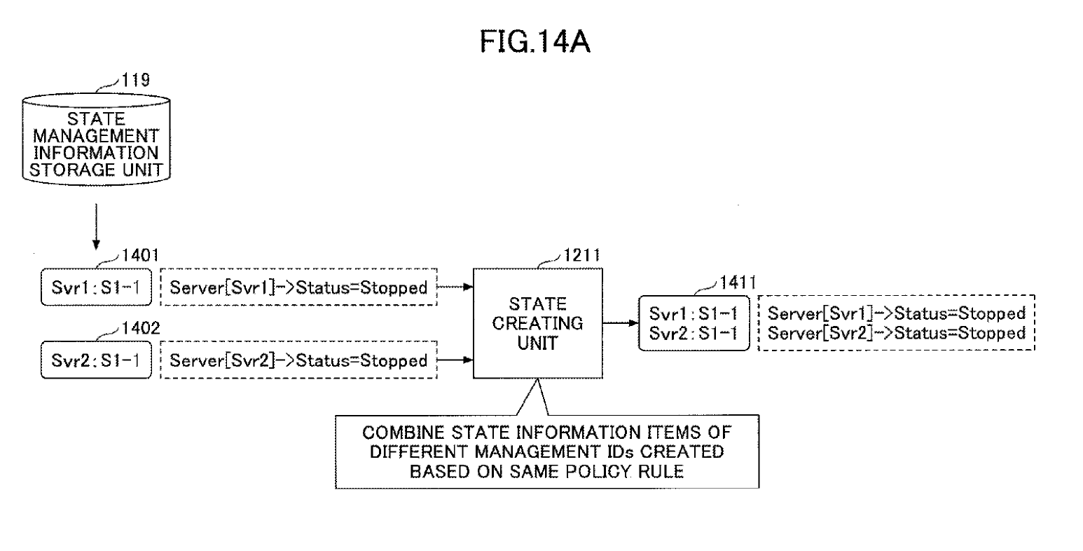

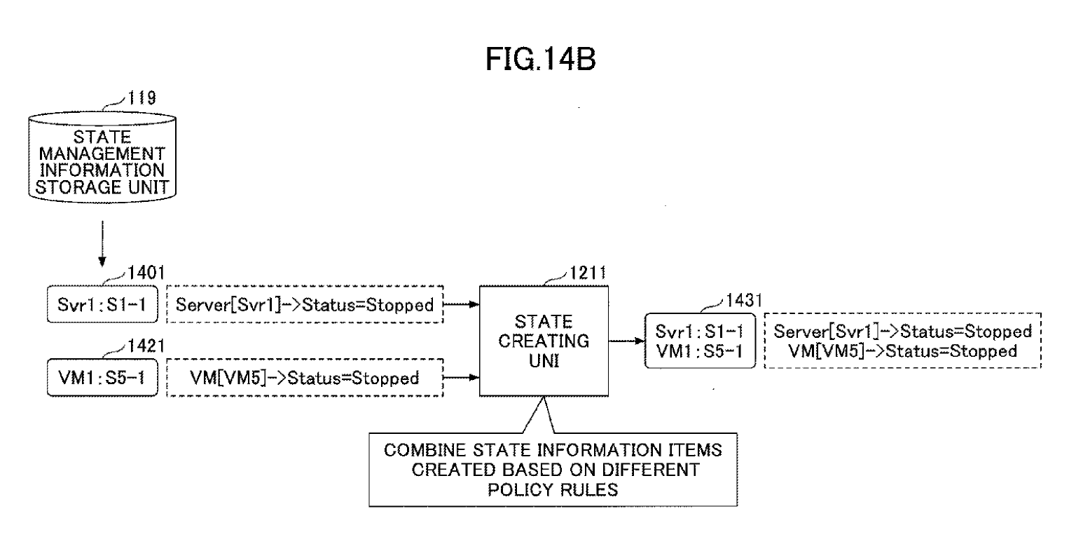

FIGS. 14A and 14B are a second diagram for describing the function of the state creating unit 1211, the function of combining the state information items created for the respective management target IDs, and the function of combining state information items created based on different policy rules.

As illustrated in FIG. 14A, the state creating unit 1211 reads and acquires state information items of devices having different state information IDs, among the state information items stored in the state management information storage unit 119. The example of FIG. 14A illustrates that the state creating unit 1211 has read and acquired state information 1401 that has a state ID=“S1-1” and that is state information of a management target ID=“Svr1”, and state information 1402 that has a state ID=“S1-1” and that is state information of a management target ID=“Svr2”.

Note that in the following, the state information illustrated in the figures is appended with a management target ID before the state ID, when the state information is of a particular device.

The state creating unit 1211 creates a single state information item 1411, by combining the acquired state information items 1401 and 1402. In this way, the state creating unit 1211 is able to create new state information by combining the state information items of the devices created based on the same policy rule (in the example of FIG. 14A, the policy rule 801).

Furthermore, as illustrated in FIG. 14B, the state creating unit 1211 reads and acquires state information items created based on different policy rules, among the state information items stored in the state management information storage unit 119. The example of FIG. 14B illustrates that the state creating unit 1211 has read and acquired the state information 1401 that has a state ID=“S1-1” created based on the policy rule 801 and that is state information of the management target ID=“Svr1”. Furthermore, the example of FIG. 14B illustrates that the state creating unit 1211 has read and acquired state information 1421 that has a state ID=“S5-1” created based on the policy rule 805 and that is state information of the management target ID=“VM1”.

The state creating unit 1211 creates a single state information item 1431, by combining the acquired state information items 1401 and 1421. In this way, the state creating unit 1211 is able to create new state information by combining state information items of devices created based on different policy rules.

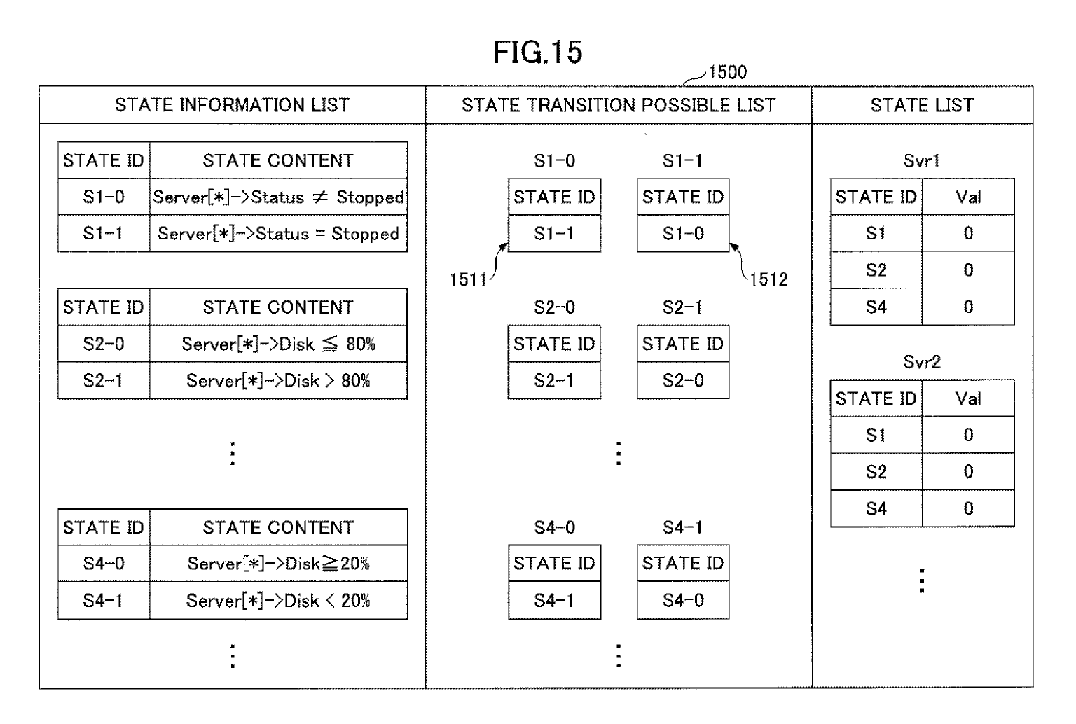

FIG. 15 illustrates an example of state management information stored by the state creating unit 1211. As illustrated in FIG. 15, state management information 1500 includes the information items of a “state information list”, a “state transition possible list”, and a “state list”.

In the “state information list”, the state information items created by the state creating unit 1211 are stored. Each state information item includes a state ID and a state content.

In the “state transition possible list”, state transition information connecting one state information item with another state information item is stored. Note that at the stage when the state creating unit 1211 has created the state information items, the state transition information connecting one state information item with another state information item is not yet created; however, in this example, a description is given assuming that the state transition information has already been created.

As illustrated in FIG. 15, in the “state transition possible list”, state transition information, which connects the state information (state ID) of the transition source indicating a state before the transition with the state information (state ID) of the transition destination indicating the state after the transition, is stored.

State transition information 1511 indicates that the state ID of the state information that is the transition source is “S1-0”, and that the state ID of the state information that is the transition destination is “S1-1”. Similarly, state transition information 1512 indicates that the state ID of the state information that is the transition source is “S1-1”, and that the state ID of the state information that is the transition destination is “S1-0”.

In the “state list”, a value indicating the present state (Va1: Value) is stored in association with a state ID, for each device that is a management target. In “Va1”, “0” is stored when the present state of a device that is a management target is a state that does not satisfy the IF part defined in the policy rule. Furthermore, in “Va1”, “1” is stored when the present state of a device that is a management target is a state that satisfies the IF part defined in the policy rule.

In the example of FIG. 15, “0” is set as Va1, which is associated with the state ID=“S1” of a server having a management target ID=“Svr1”. That is, the example of FIG. 15 illustrates that the present state of the server having the management target ID=“Svr1” is a state that does not satisfy the IF part defined in the policy rule 801.

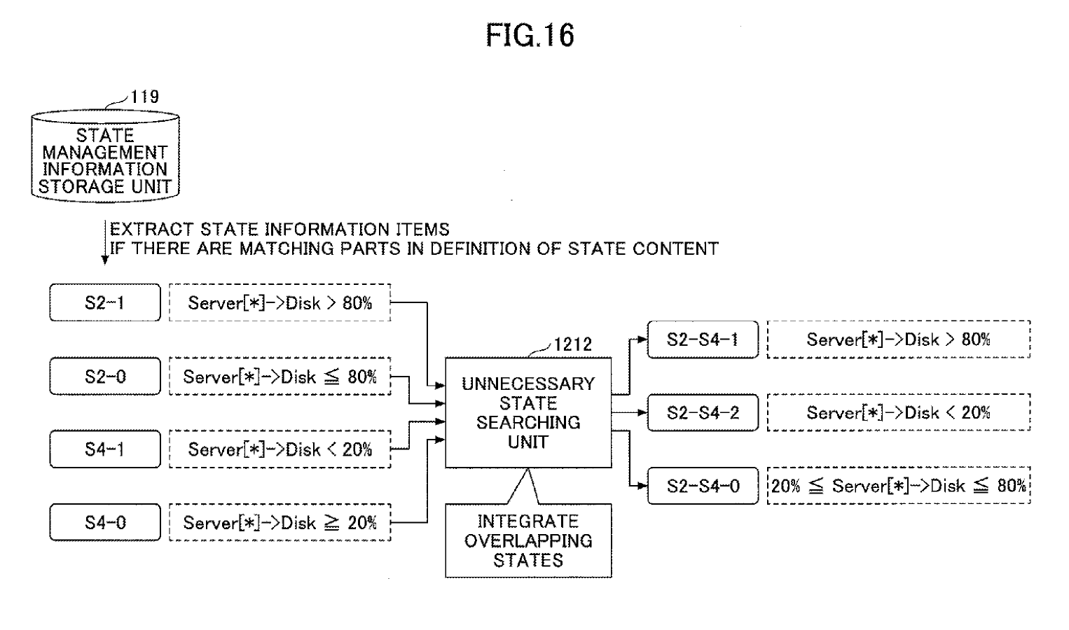

Next, detailed descriptions are given of the functions of the unnecessary state searching unit 1212, with reference to FIGS. 16 through 21.

FIG. 16 is a first diagram for describing the functions of the unnecessary state searching unit 1212, describing a function of integrating state information items, which have overlapping parts in a part of the state content describing the state of each device, among the state information items.

As illustrated in FIG. 16, the unnecessary state searching unit 1212 acquires state information items, which have overlapping parts in a part of the state content describing the state of each device, among the state information items stored in the state management information storage unit 119.

In the example of FIG. 16, the state information of the state ID=“S2-1”, the state information of the state ID=“S2-0”, the state information of the state ID=“S4-1”, and the state information of the state ID=“S4-0”, include a character string “Server[*]->Disk” in a part of the state content. Therefore, these state information items are determined to be state information items having overlapping parts in a part of the state content, and these state information items are acquired by the unnecessary state searching unit 1212.

The unnecessary state searching unit 1212 decreases the number of state information items by integrating the acquired state information items. The state information items illustrated in FIG. 16 include four state information items, namely, a state information item of a state where the disk usage amount of the server exceeds 80%, a state information item of a state where the disk usage amount of the server is less than or equal to 80%, a state information item of a state where the disk usage amount of the server is less than 20%, and a state information item of a state where the disk usage amount of the server is higher than or equal to 80%. These four state information items may be integrated as state information items indicating the three states of exceeding 80%, less than 20%, and higher than or equal to 20% and less than or equal to 80%.

The unnecessary state searching unit 1212 applies new state IDs to the state information items obtained by integrating the four acquired state information items into three state information items. The example of FIG. 16 illustrates that a state ID=“S2-S4-1” is applied to the state content in which “Server[*]->Disk>80%” is described. Furthermore, the example of FIG. 16 illustrates that a state ID=“S2-S4-2” is applied to the state content in which “Server[*]->Disk<20%” is described. Furthermore, the example of FIG. 16 illustrates that a state ID=“S2-S4-0” is applied to the state content in which “20%<Server[*]->Disk80%” is described.

As described above, the unnecessary state searching unit 1212 is able to integrate state information items having overlapping parts in a part of the state content, and therefore the unnecessary state searching unit 1212 is able to decrease the number of state information items stored in the state management information storage unit 119.

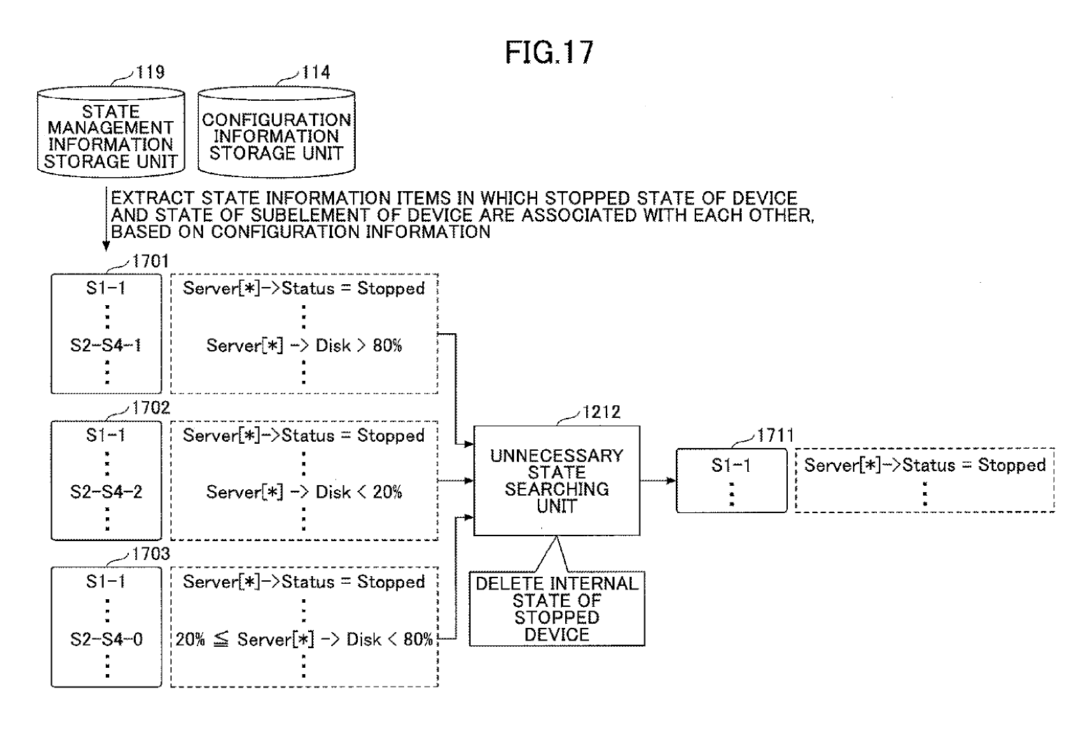

FIG. 17 is a second diagram for describing the functions of the unnecessary state searching unit 1212, describing a function of deleting state information including a description relevant to the internal state of a device whose status is in a stopped state.

As illustrated in FIG. 17, the unnecessary state searching unit 1212 reads and acquires state information created by combining a plurality of state information items, among the state information items stored in the state management information storage unit 119. Here, the unnecessary state searching unit 1212 reads and acquires state information created by combining state information indicating that the status of the device is in a stopped state and state information indicating the internal state of the corresponding device (state of subelement).

The reason why the unnecessary state searching unit 1212 acquires such a state information item is because when the status of the server is stopped, the state is the same regardless of the disk usage amount of the corresponding server, and therefore the state information does not have to be divided.

Note that the relationship between a device and a subelement of the device is determined, for example, based on the information 710 indicating server configuration items included in the configuration information 500 stored in the configuration information storage unit 114. This is because the server configuration items defined in the information 710 define the server and the items constituting the server (subelements).

The example of FIG. 17 illustrates that the unnecessary state searching unit 1212 has acquired state information 1701, which has been formed by combining the state information indicating a state that the status of the server is stopped and state information indicating a state that the usage amount of the disk that is a subelement of the server is higher than 80%. Note that the state information indicating a state that the status of the server is stopped has a state ID=“S-1” and the state information indicating a state that the usage amount of the disk of the server is higher than 80% has a state ID=“S2-S4-1”.

Furthermore, the example of FIG. 17 illustrates that the unnecessary state searching unit 1212 has acquired state information 1702, which is formed by combining the state information indicating a state that the status of the server is stopped and state information indicating a state that the usage amount of the disk that is a subelement of the server is less than 20%. Note that the state information indicating a state that the status of the server is stopped has a state ID=“S-1” and the state information indicating a state that the usage amount of the disk of the server is less than 20% has a state ID=“S2-S4-2”.

Furthermore, the example of FIG. 17 illustrates that the unnecessary state searching unit 1212 has acquired state information 1703, which is formed by combining the state information indicating a state that the status of the server is stopped and state information indicating a state that the usage amount of the disk that is a subelement of the server is higher than or equal to 20% and less than 80%. Note that the state information indicating a state that the status of the server is stopped has a state ID=“S-1” and the state information indicating a state that the usage amount of the disk of the server is higher than or equal to 20% and less than 80% has a state ID=“S2-S4-0”.

The unnecessary state searching unit 1212 deletes a description relevant to the internal state of a device whose status is in a stopped state, from the acquired state information items 1701 through 1703. The example of FIG. 17 illustrates that the unnecessary state searching unit 1212 has deleted, from the state information items 1701 through 1703, descriptions of the state information items having the state IDs=“S2-S4-0”, “S2-S4-1”, and “S2-S4-2”, and has output state information 1711. When the unnecessary state searching unit 1212 deletes the descriptions of the state information items having the state IDs=“S2-S4-0”, “S2-S4-1”, and “S2-S4-2” from the state information items 1701 through 1703, the state information items 1701 through 1703 after the descriptions are deleted will be the same state information. For this reason, the unnecessary state searching unit 1212 outputs only one state information item 1711.

As described above, by deleting a description relevant to the internal state of a device whose status is in a stopped state, the unnecessary state searching unit 1212 is able to decrease the number of state information items stored in the state management information storage unit 119.

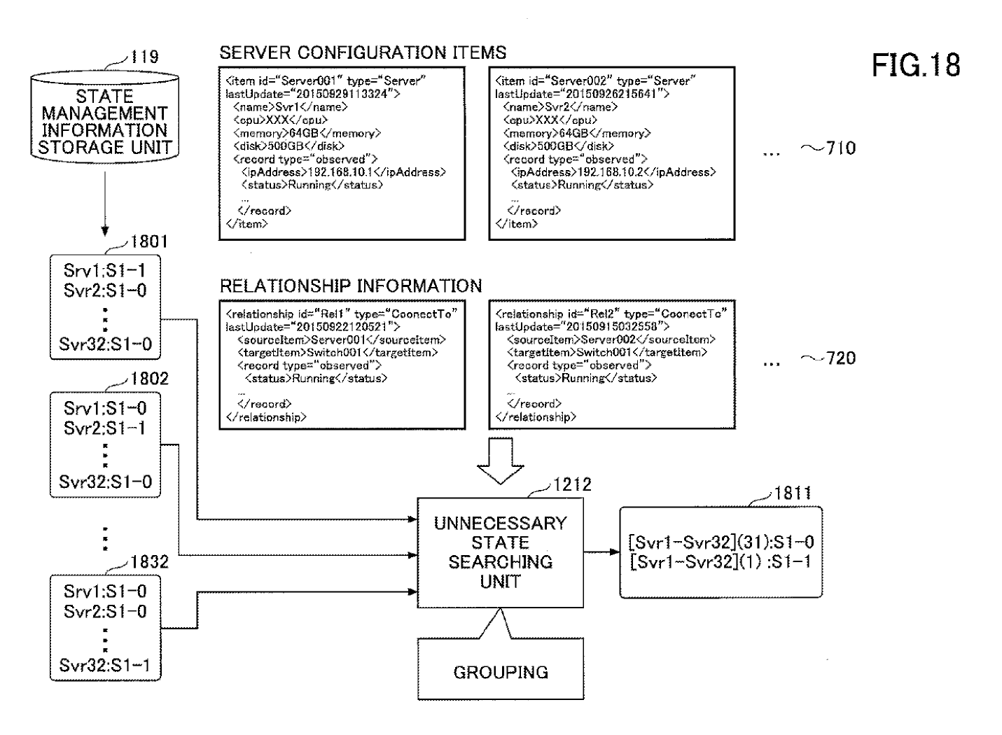

FIG. 18 is a third diagram for describing the functions of the unnecessary state searching unit 1212, describing a function of integrating state information items in a case where a combination of various states with respect to devices of the same type, among the plurality of devices that are management targets, is created as separate state information items.

As illustrated in FIG. 18, the unnecessary state searching unit 1212 reads and acquires separately created state information items, corresponding to a combination of various states with respect to devices of the same type, among the state information items stored in the state management information storage unit 119.

Devices of the same type mean, for example, 32 servers belonging to the same zone. The example of FIG. 18 illustrates that the unnecessary state searching unit 1212 has acquired state information items (state information 1801 through state information 1832) that correspond to a combination of various state information items with respect to the 32 servers.

The state information 1801 through state information 1832 are all state information items indicating a state where the status of one server is stopped and the statuses of 31 servers are operating. The only difference between the state information items is that the stopped server is different. That is, the state information 1801 through state information 1832 merely express that the status of one server in the same zone is in a stopped state, and there is no need to identify the one server whose status is stopped. That is to say, the one server whose status is stopped may be replaced with another server (hereinafter, the devices in a case where various states of devices of the same type are combined, are also referred to as “replaceable devices”).

The unnecessary state searching unit 1212 considers that a group of servers whose states are indicated by the state information 1801 through state information 1832, is one group that is a group of servers in the same zone, and integrates these servers. Note that the unnecessary state searching unit 1212 determines the devices that can be considered as belonging to one group, based on the information 710 indicating server configuration items and the relationship information 720.

Specifically, the unnecessary state searching unit 1212 refers to the server configuration items included in the information 710, and extracts the servers having matching parts, which are parts except for the actual measurement values, that is, parts except for the values that are different for each of the servers such as the management target ID, the server name, etc. Furthermore, the unnecessary state searching unit 1212 extracts, from the extracted servers, the servers that are connected to the same switch, based on the relationship information 720 included in the configuration information 500.

The example of FIG. 18 illustrates that the unnecessary state searching unit 1212 has integrated the state information 1801 through state information 1832, to create state information 1811 in which “[Svr1-Svr32](31):S1-0, [Svr1-Svr32(1):S1-1” is described.

As described above, in a case where a combination of various states with respect to devices of the same type, among the plurality of devices that are management targets, is created as separate state information items, the unnecessary state searching unit 1212 integrates the state information items that have been created separately. Accordingly, the unnecessary state searching unit 1212 is able to decrease the number of state information items stored in the state management information storage unit 119.

Furthermore, in the example of FIG. 18, by considering that the state information items indicate “a state where the statuses of some of the servers among the group of 32 servers in the same zone are stopped”, a combination of 2³² state information items can be integrated into 32 state information items.

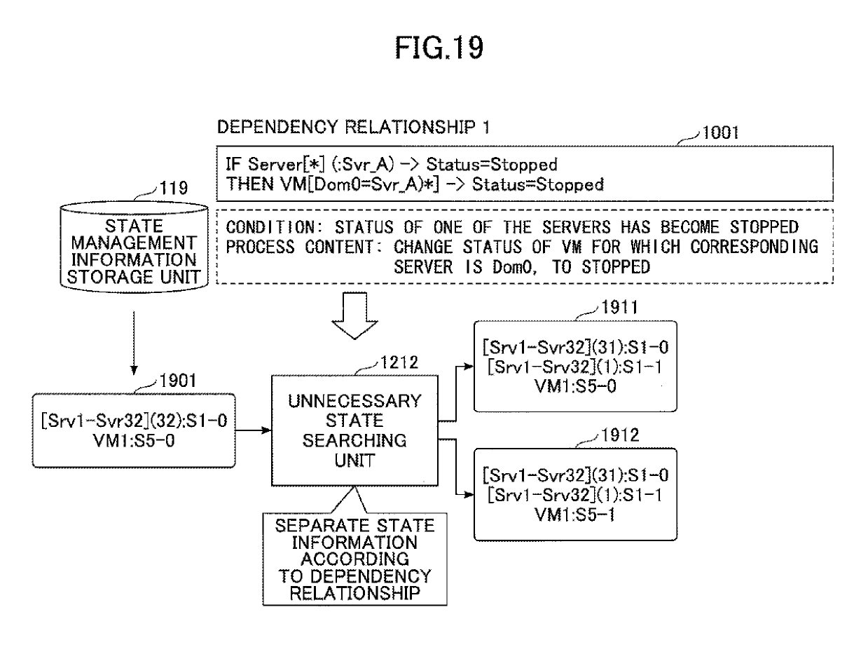

FIG. 19 is a fourth diagram for describing the functions of the unnecessary state searching unit 1212, describing a function of correcting the integrated state information, when separately created state information items have been integrated, but there is a dependency relationship between the states of devices.

When separately created state information items have been integrated, but there is a dependency relationship between the states of devices, there may be a plurality of state transitions depending whether the dependency relationship is applicable to the states. Therefore, the unnecessary state searching unit 1212 reads and acquires the state information that has been created by integrating state information items that have been separately created, from among the state information items stored in the state management information storage unit 119, to correct the integrated state information.

In FIG. 19, state information 1901 is state information that has been created by integrating state information items that have been separately created, by the unnecessary state searching unit 1212. Specifically, the state information 1901 is state information indicating a state where the status of any one of the 32 servers having management target IDs=“Svr1” through “Svr32” is operating, and the status of the VM having the management target ID=“VM1” is operating.

As illustrated in FIG. 19, when the state information 1901 is acquired, the unnecessary state searching unit 1212 refers to the dependency relationship defined in the dependency information 1000. A dependency relationship 1001 having a relationship name=“dependency relationship 1” defines that when the status of the server in which the VM is operating becomes stopped, the status of the VM also becomes stopped in association with the change of the status of the corresponding server. That is, whether the VM stops in association with the stopping of the server, depends on whether the stopped server is the server of Dom0.

Therefore, the unnecessary state searching unit 1212 divides the state information 1901 into a state where the status of the server in which the VM is operating is stopped, and a state where the status of a server other than the server in which the VM is operating is stopped. Accordingly, the unnecessary state searching unit 1212 creates state information 1911 and state information 1912.

The state information 1911 is state information indicating a state where the statuses of 31 servers among the 32 servers belonging to the same zone are operating, and the status of one of the 32 servers is stopped. Note that the state information 1911 indicates a case where the one server whose status is stopped is a server other than the server in which the VM is operating.

Furthermore, the state information 1912 is state information indicating a state where the statuses of 31 servers among the 32 servers belonging to the same zone are operating, and the status of one of the 32 servers is stopped. Note that the state information 1912 indicates a case where the one server whose status is stopped is the server in which the VM is operating.

By the above function of the unnecessary state searching unit 1212, the 32 state information items, which have been created by integrating a combination of 2³² state information items, are separated into two groups, and therefore the number of state information items will increase by a maximum of 32 state information items (that is, a maximum of 64 state information items will be obtained).

However, even when the number of state information items increases by a maximum of 32 state information items, it is still possible to suppress the number of state information items to a significantly small number, compared to the number of state information items before the integration (2³² state information items).

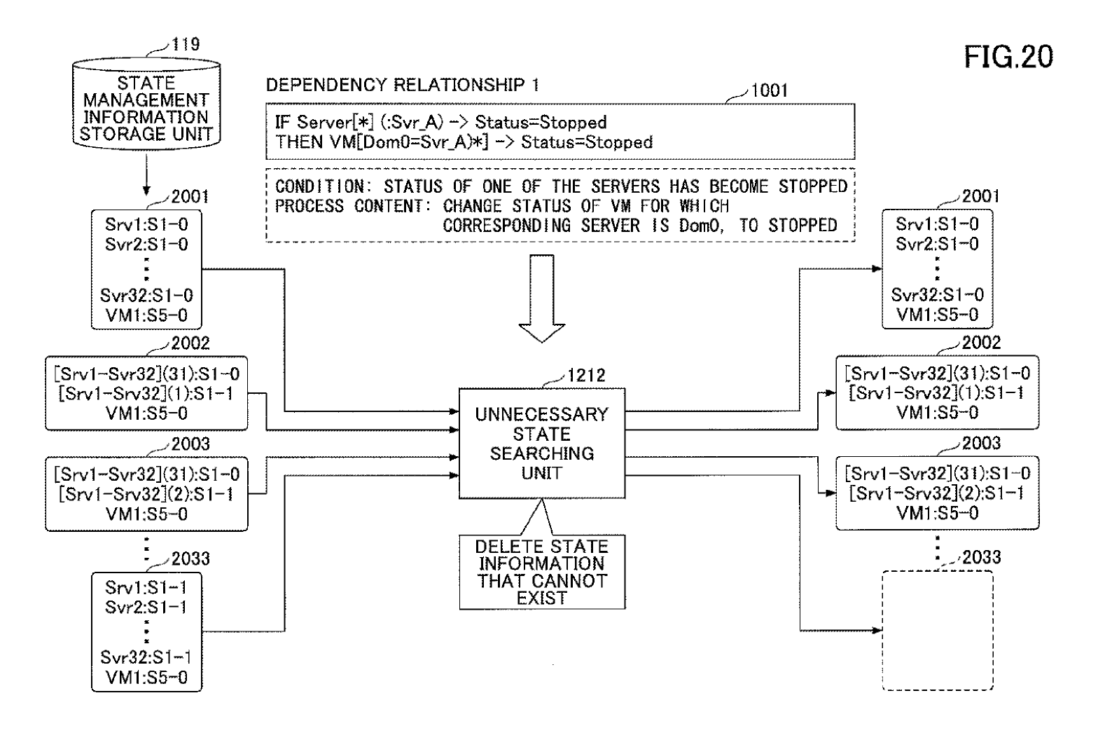

FIG. 20 is a fifth diagram for describing the functions of the unnecessary state searching unit 1212, describing a function of determining that creation of state transition information is unnecessary with respect to state information indicating a state that cannot exist, among the state information items stored in the state management information storage unit 119, and deleting the state information.

As illustrated in FIG. 20, the unnecessary state searching unit 1212 acquires the state information stored in the state management information storage unit 119. The state information stored in the state management information storage unit 119 includes state information indicating a state that cannot exist, when considering the dependency relationship between the states of the devices. For this reason, the unnecessary state searching unit 1212 deletes such state information items.

State information 2001 is state information indicating a state where the statuses of all 32 servers having the management target IDs=“Svr1” through “Svr32” are operating, and the status of the VM having a management target ID=“VM1” is operating. Furthermore, state information 2002 is state information indicating a state where the statuses of 31 servers out of the 32 servers having the management target IDs=“Svr1” through “Svr32” are operating, and the status of any one of the servers is stopped. Note that the state information 2002 also indicates a state where the status of the VM having a management target ID=“VM1” is operating.

Furthermore, state information 2003 is state information indicating a state where the statuses of 30 servers out of the 32 servers having the management target IDs=“Svr1” through “Svr32” are operating, and the statuses of any two of the servers are stopped. Note that the state information 2003 also indicates a state where the status of the VM having a management target ID=“VM1” is operating.

Furthermore, state information 2033 is state information indicating a state where the statuses of all 32 servers having the management target IDs=“Svr1” through “Svr32” are stopped, and the status of the VM having a management target ID=“VM1” is operating.

As illustrated in FIG. 20, when the state information items 2001 through 2033 are acquired, the unnecessary state searching unit 1212 refers to the dependency relationship defined in the dependency information 1000. A dependency relationship 1001 having a relationship name=“dependency relationship 1” defines that when the status of the server in which the VM is operating becomes stopped, the status of the VM also becomes stopped in association with the change of the status of the corresponding server.

Here, the state information 2033 indicates a state where all of the 32 servers are stopped, and therefore according to the dependency relationship 1, the status of the VM having a management target ID=“VM1” cannot possibly be operating.

Therefore, the unnecessary state searching unit 1212 determines that the state information 2033 is state information indicating a state that cannot exist, among the acquired state information items 2001 through 2033, and deletes the state information 2033.

As described above, by deleting state information indicating a state that cannot exist, the unnecessary state searching unit 1212 is able to decrease the number of state information items stored in the state management information storage unit 119.

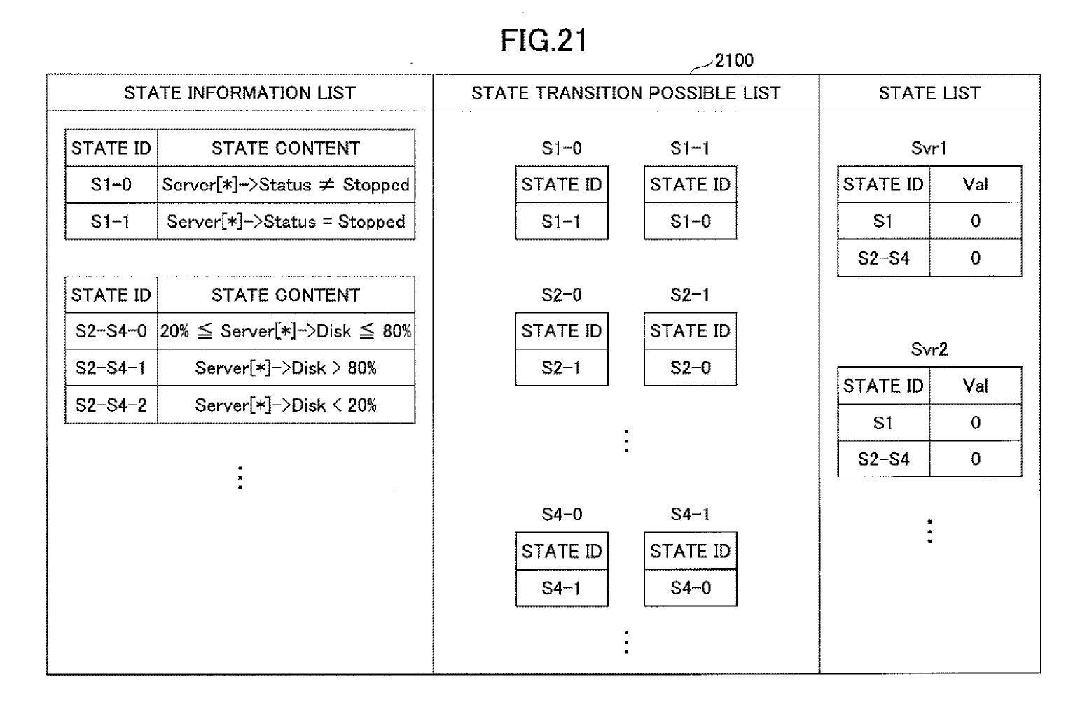

FIG. 21 illustrates an example of state management information stored by the unnecessary state searching unit 1212. With respect to the state management information 1500 stored by the state creating unit 1211, the results of integrating or deleting the state information are applied in state management information 2100 stored by the unnecessary state searching unit 1212.

For example, in the state management information 1500, the state information items having the state IDs=“S2-0”, “S2-1”, “S4-0”, and “S4-1” have been stored in the “state information list”. On the other hand, in the state management information 2100, these state information items have been deleted, and the state information items having the state IDs=“S2-S4-0”, “S2-S4-1”, and “S2-S4-2” are newly stored.

Furthermore, in the state management information 1500, the values of state IDs=“S2” and “S4” are separately stored for “Va1”, in the “state list”. On the other hand, in the state management information 2100, the value of a state ID=“S2-S4” is stored for “Va1” in an integrated manner, in the “state list”.

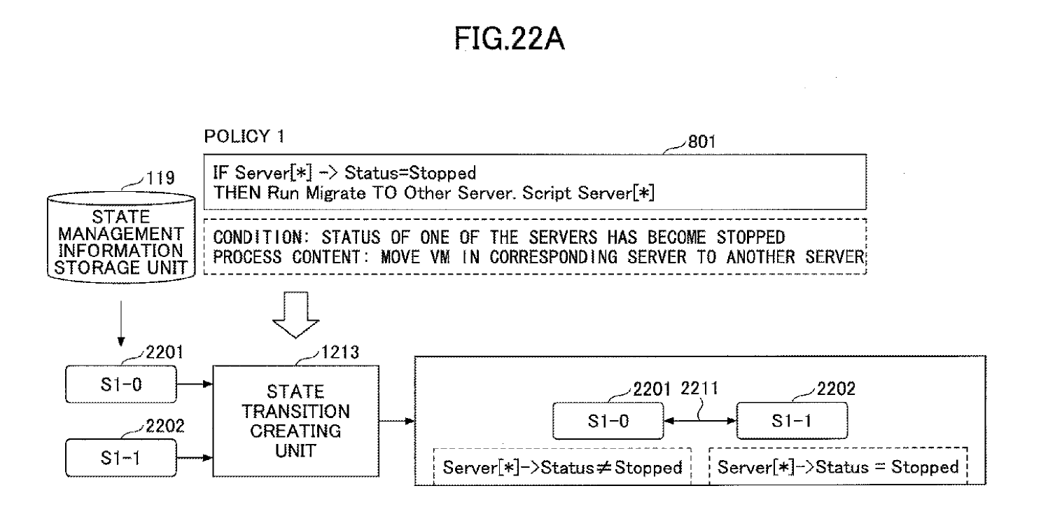

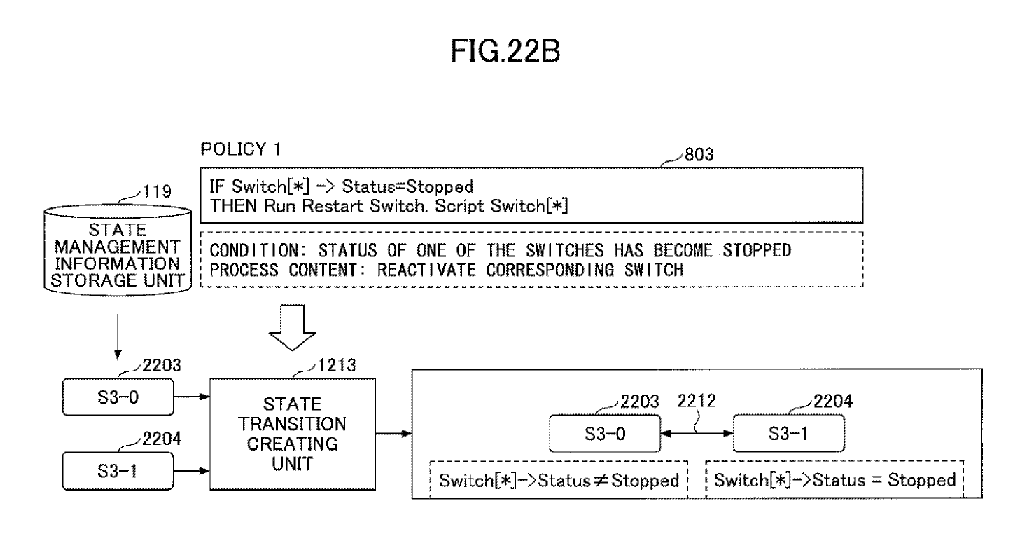

Next, a detailed description is given of functions of the state transition creating unit 1213, with reference to FIGS. 22A through 29. FIGS. 22A and 22B are a first diagram for describing the functions of the state transition creating unit 1213, describing a function of creating state transition information corresponding to the respective state information items, based on the policy rule used for creating the state information.

The state transition creating unit 1213 reads and acquires the state information items from the “state information list” of the state management information 2100 stored in the state management information storage unit 119.

The state transition creating unit 1213 creates state transition information corresponding to each of the acquired state information items. Here, the state information items acquired by the state transition creating unit 1213 include the policy rules that have been used for creating the state information items. Therefore, the state transition creating unit 1213 refers to the policy rule that has been used for creating each state information item, to create the state transition information.

The example of FIG. 22A illustrates that the state transition creating unit 1213 has acquired state information 2201 having a state ID=“S1-0” and state information 2202 having a state ID=“S1-1”. The state information 2201 having a state ID=“S1-0” and the state information 2202 having a state ID=“S1-1” are both state information created by the state creating unit 1211 based on the policy rule 801 identified by the policy name=“policy 1”.

Therefore, the state transition creating unit 1213 refers to the policy rule 801 that has been used for creating these state information items, and creates state transition information 2211 connecting these state information items.

Furthermore, the example of FIG. 22B illustrates that the state transition creating unit 1213 has acquired state information 2203 having a state ID=“S3-0” and state information 2204 having a state ID=“S3-1”. The state information 2203 having a state ID=“S3-0” and the state information 2204 having a state ID=“S3-1” are both state information created by the state creating unit 1211 based on the policy rule 803 identified by the policy name=“policy 3”.

Therefore, the state transition creating unit 1213 refers to the policy rule 803 that has been used for creating these state information items, and creates state transition information 2212 connecting these state information items.

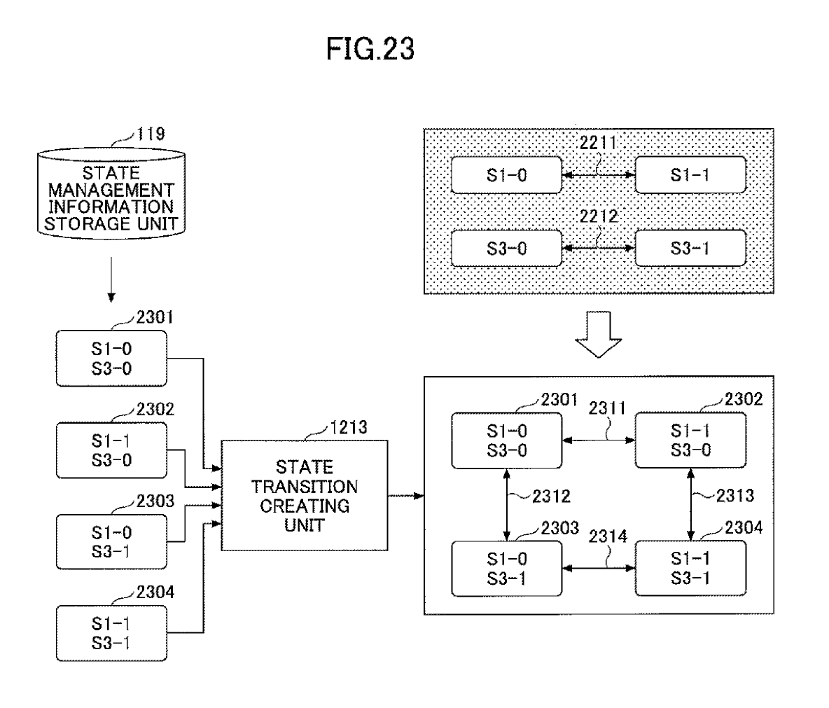

FIG. 23 is a second diagram for describing the functions of the state transition creating unit 1213, describing a function of creating state transition information corresponding to state information after being combined, based on the state transition information corresponding to the respective state information items before being combined.

The state transition creating unit 1213 reads state information items from the “state information list” of the state management information 2100 stored in the state management information storage unit 119, to acquire the state information items.

The state transition creating unit 1213 creates state transition information based on the acquired state information items. Here, when the state information items acquired by the state transition creating unit 1213 are state information items after being combined, the state transition creating unit 1213 creates state transition information corresponding to the state information after being combined, based on the state transition information corresponding to the state information before being combined.

The example of FIG. 23 illustrates that the state transition creating unit 1213 has acquired state information 2301, state information 2302, state information 2303, and state information 2304, as state information after being combined.

The state information 2301 is state information created by combining state information having a state ID=“S1-0” and state information having a state ID=“S3-0”. The state information 2302 is state information created by combining state information having a state ID=“S1-1” and state information having a state ID=“S3-0”. The state information 2303 is state information created by combining state information having a state ID=“S1-0” and state information having a state ID=“S3-1”. Furthermore, the state information 2304 is state information created by combining state information having a state ID=“S1-1” and state information having a state ID=“S3-1”.

Here, the state transition information 2211 connecting the state information having the state ID=“S1-0” and the state information having the state ID=“S1-1” is assumed to have already been created based on the policy rule 801. Furthermore, the state transition information 2212 connecting the state information having the state ID=“S3-0” and the state information having the state ID=“S3-1” is assumed to have already been created based on the policy rule 802.

The state transition creating unit 1213 creates state transition information connecting the state information items 2301 through 2304, based on the state transition information 2211 and 2212 that have already been created.

Specifically, the state transition creating unit 1213 creates state transition information 2311 connecting the state information 2301 and the state information 2302, based on the state transition information 2211. Furthermore, the state transition creating unit 1213 creates state transition information 2314 connecting the state information 2303 and the state information 2304, based on the state transition information 2211.

Furthermore, the state transition creating unit 1213 creates state transition information 2312 connecting the state information 2301 and the state information 2303, based on the state transition information 2212. Furthermore, the state transition creating unit 1213 creates state transition information 2313 connecting the state information 2302 and the state information 2304, based on the state transition information 2212.

As described above, the state transition creating unit 1213 is able to create state transition information connecting the state information items after being combined, by using the state transition information created based on the state information items before being combined.

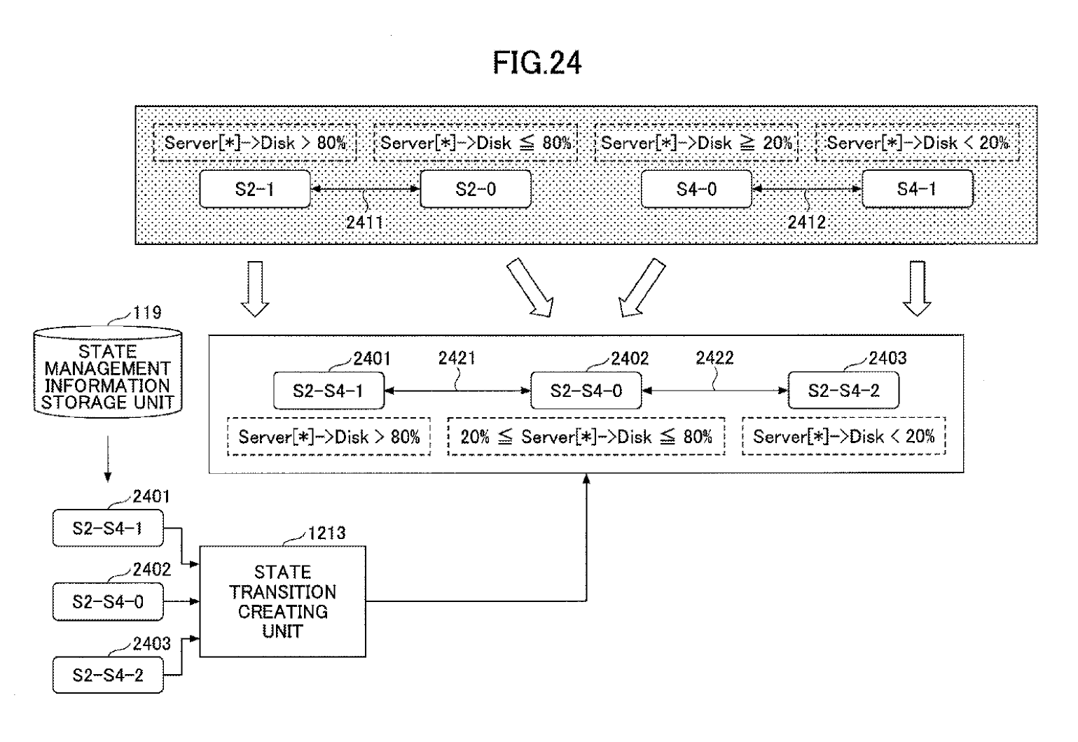

FIG. 24 is a third diagram for describing the functions of the state transition creating unit 1213, describing a function of creating state transition information with respect to state information integrated by the unnecessary state searching unit 1212 as a result of being determined as having overlapping parts in a part of the state content.

The state transition creating unit 1213 reads and acquires state information that has been integrated by the unnecessary state searching unit 1212 as a result of being determined as having overlapping parts in a part of the state content, from among the state information items stored in the “state information list” of the state management information 2100.

The state transition creating unit 1213 refers to the state transition information created based on the state information before being integrated, when creating the state transition information based on the integrated state information. Furthermore, the state transition creating unit 1213 creates state transition information corresponding to the acquired state information, based on the state transition information that has been referred to.

The example of FIG. 24 illustrates that the state transition creating unit 1213 has acquired state information 2401, state information 2402, and state information 2403, as state information that has been integrated.

The state information items 2401 through 2403 are state information items created by integrating the state information having the state ID=“S2-1”, the state information having the state ID=“S2-0”, the state information having the state ID=“S4-0”, and the state information having the state ID=“S4-1”.

Here, state transition information 2411 connecting the state information having the state ID=“S2-1” and the state information having the state ID=“S2-0” is assumed to have already been created based on the policy rule 802. Furthermore, state transition information 2412 connecting the state information having the state ID=“S4-0” and the state information having the state ID=“S4-1” is assumed to have already been created based on the policy rule 804.

The state transition creating unit 1213 creates state transition information 2421 connecting the state information items 2401 and 2402, by referring to the state transition information 2411 that has already been created. Furthermore, the state transition creating unit 1213 creates state transition information 2422 connecting the state information items 2402 and 2403, by referring to the state transition information 2412 that has already been created.

As described above, the state transition creating unit 1213 is able to create state transition information based on state information after being integrated, by referring to the state transition information based on the state information items before being integrated.

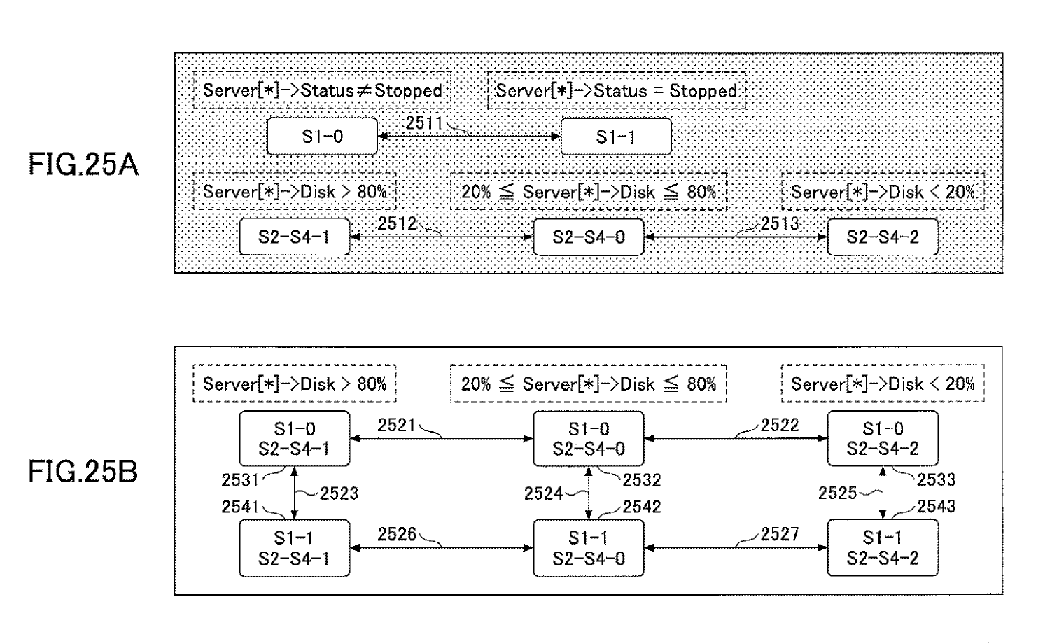

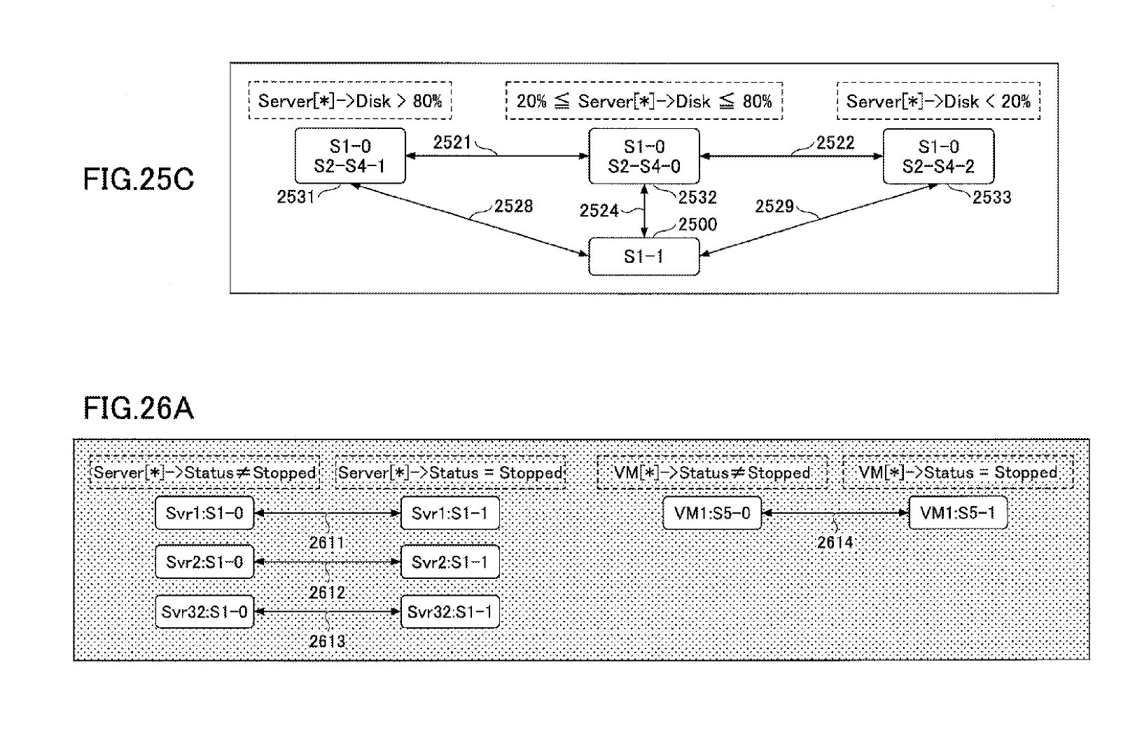

FIGS. 25A through 25C are a fourth diagram for describing the functions of the state transition creating unit 1213, describing a function of creating state transition information corresponding to the state information from which a description, which is relevant to the internal state of a device whose status is in the stopped state, has been deleted by the unnecessary state searching unit 1212.

Note that as a matter of simplifying the descriptions with respect to FIGS. 25A through 25C, a description about the state information acquired by the state transition creating unit 1213 is omitted, and only the state transition information that is referred to by the state transition creating unit 1213 and the state transition information created based on the referred state transition information are illustrated in FIGS. 25A through 25C. Furthermore, FIGS. 25A through 25C illustrate state information 2500 as an example of state information from which a description, which is relevant to the internal state of a device whose status is in the stopped state, has been deleted.

FIG. 25A illustrates state transition information to which the state transition creating unit 1213 refers. As illustrated in FIG. 25A, state transition information 2511 connecting the state information having the state ID=“S1-0” and the state information having the state ID=“S1-1” is assumed to have already been created based on the policy rule 801. Furthermore, state transition information 2512 connecting the state information having the state ID=“S2-S4-1” and the state information having the state ID=“S2-S4-0” is assumed to have already been created based on the policy rule 802. Furthermore, state transition information 2513 connecting the state information having the state ID=“S2-S4-0” and the state information having the state ID=“S2-S4-2” is assumed to have already been created based on the policy rule 804.

In order to create state transition information based on the state information 2500, first, the state transition creating unit 1213 creates state transition information corresponding to state information items 2541 through 2543 before the descriptions relevant to the internal state are deleted.

FIG. 25B illustrates the state transition information corresponding to the state information items 2541 through 2543. In FIG. 25B, state transition information 2523 connecting state information 2531 and state information 2541 is created based on the state transition information 2511. Furthermore, state transition information 2524 connecting state information 2532 and state information 2542, and state transition information 2525 connecting state information 2533 and state information 2543, are also created based on the state transition information 2511.

Furthermore, state transition information 2526 connecting state information 2541 and state information 2542 is created based on the state transition information 2512, and state transition information 2527 connecting state information 2542 and state information 2543 is created based on the state transition information 2513.

The state transition creating unit 1213 creates state transition information corresponding to the state information 2500, based on the state transition information items 2523 through 2527 corresponding to the state information items 2531 through 2533 and 2541 through 2543.

FIG. 25C illustrates that state transition information corresponding to the state information 2500 has been created based on the state transition information items 2523 through 2527. In FIG. 25C, state transition information 2528 is created based on the state transition information 2523 and the state transition information 2526. Furthermore, state transition information 2529 is created based on the state transition information 2525 and the state transition information 2527.

As described above, the state transition creating unit 1213 is able to create state transition information corresponding to state information from which a description, which is relevant to the internal state of a device whose status is in the stopped state, has been deleted, based on the state transition information corresponding to the state information before the description is deleted.

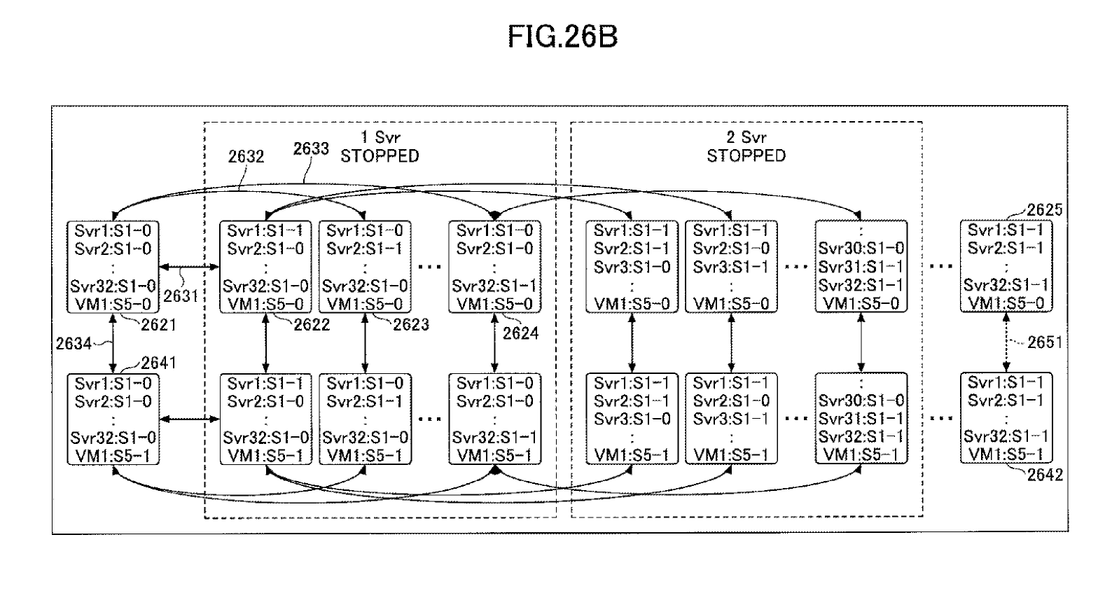

FIGS. 26A and 26B are a fifth diagram for describing the functions of the state transition creating unit 1213. FIGS. 26A and 26B are for describing a function of creating state transition information corresponding to state information created by the state creating unit 1211, by combining a plurality of state information items (state information items having different management target IDs and state information items created based on different policy rules).

Note that as a matter of simplifying the descriptions also with respect to FIGS. 26A and 26B, a description about the state information acquired by the state transition creating unit 1213 is omitted, and only the state transition information that is referred to by the state transition creating unit 1213 and the state transition information created based on the referred state transition information are illustrated in FIGS. 26A and 26B. Furthermore, FIGS. 26A and 26B illustrate state information items 2621 through 2625, 2641, and 2642, as examples of state information items created by combining a plurality of state information items. However, to facilitate the understanding of descriptions, FIGS. 26A and 26B also illustrate state information items relevant to the state information items 2621 through 2624, 2641, and 2642.

FIG. 26A illustrates state transition information that is referred to by the state transition creating unit 1213. As illustrated in FIG. 26A, with respect to a server having a management target ID=“Svr1”, state transition information 2611 connecting state information having a state ID=“S1-0” and state information having a state ID=“S1-1” is assumed to have already been created based on the policy rule 801. Furthermore, with respect to a server having a management target ID=“Svr2”, state transition information 2612 connecting state information having a state ID=“S1-0” and state information having a state ID=“S1-1” is assumed to have already been created based on the policy rule 801. Furthermore, with respect to a server having a management target ID=“Svr32”, state transition information 2613 connecting state information having a state ID=“S1-0” and state information having a state ID=“S1-1” is assumed to have already been created based on the policy rule 801. Furthermore, with respect to a VM having a management target ID=“VM1”, state transition information 2614 connecting state information having a state ID=“S5-0” and state information having a state ID=“S5-1” is assumed to have already been created based on the policy rule 805.

The state transition creating unit 1213 creates state transition information corresponding to state information items 2621 through 2625, 2641, and 2642, based on the state transition information items 2611 through 2614.

FIG. 26B illustrates that state transition information corresponding to the state information items 2621 through 2625, 2641, and 2642, has been created based on the state transition information items 2611 through 2614. In FIG. 26B, the only difference between the state information 2621 and the state information 2622 is that the state information of the management target ID=“Svr1” is different. Therefore, state transition information 2631 connecting the state information 2621 and the state information 2622 is created based on the state transition information 2611.

Furthermore, the only difference between the state information 2621 and the state information 2623 is that the state information of the management target ID=“Svr2” is different. Therefore, state transition information 2632 connecting the state information 2621 and the state information 2623 is created based on the state transition information 2612.

Furthermore, the only difference between the state information 2621 and the state information 2624 is that the state information of the management target ID=“Svr32” is different. Therefore, state transition information 2633 connecting the state information 2621 and the state information 2624 is created based on the state transition information 2613.

Furthermore, the only difference between the state information 2621 and the state information 2641 is that the state information of the management target ID=“VM1” is different. Therefore, state transition information 2634 connecting the state information 2621 and the state information 2641 is created based on the state transition information 2614.

Note that in FIG. 26B, state transition information 2651 connecting the state information 2625 and the state information 2642 is deleted based on the order of priority 1101 defined in the priority information 1100. The order of priority 1101 defines that when the condition of the policy rule 801 having a policy name=“policy 1” and the condition of the policy rule 805 having a policy name=“policy 5” are satisfied at the same time, the process content of the policy rule 801 is executed with priority. The state information 2642 indicates a state where the statuses of all of the servers having management target IDs=“Svr1” through “Svr32” are stopped, and the status of the VM having a management target ID=“VM1” is stopped. That is, the state information 2642 indicates a state where the condition of the policy rule 801 and the condition of the policy rule 802 are satisfied at the same time.

In this case, the process content of the policy rule 801 is executed with priority, and therefore a transition of a state, where only the status of the VM having a management target ID=“VM1” changes from stopped to operating, cannot possibly occur. Therefore, the state transition information 2651 is deleted by the state transition creating unit 1213.

As described above, the state transition creating unit 1213 is able to create state transition information based on state information created by combining a plurality of state information items, by referring to the state transition information corresponding to the state information before being combined. Furthermore, the state transition creating unit 1213 is able to delete state transition information indicating a transition of a state that cannot possibly occur, by referring to the priority information 1100.

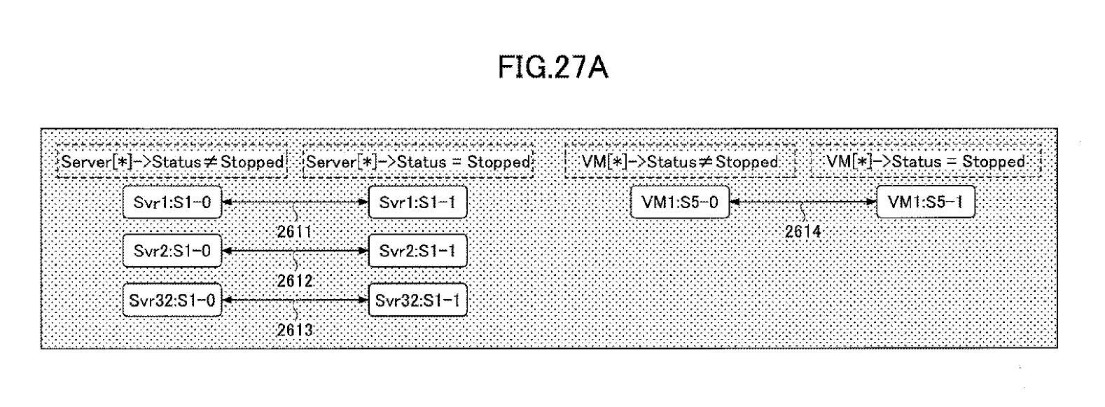

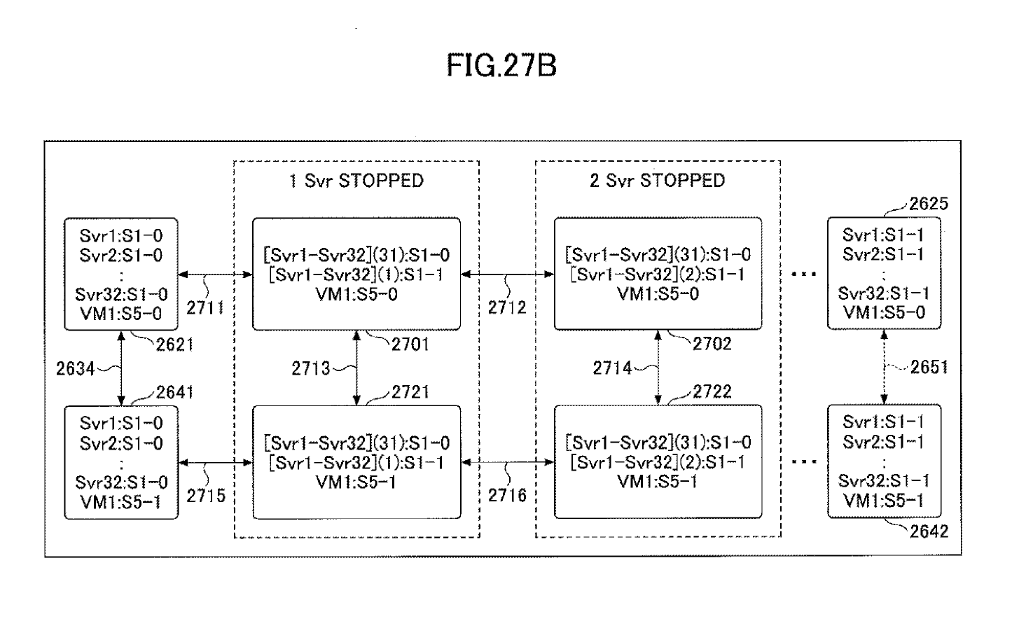

FIGS. 27A and 27B are a sixth diagram for describing the functions of the state transition creating unit 1213. FIGS. 27A and 27B are for describing a function of creating state transition information corresponding to state information created by being integrated, in a case where a combination of various states with respect to devices of the same type, among the plurality of devices that are management targets, is created as separate state information items.

Note that as a matter of simplifying the descriptions also with respect to FIGS. 27A and 27B, a description about the state information acquired by the state transition creating unit 1213 is omitted, and only the state transition information that is referred to by the state transition creating unit 1213 and the state transition information created based on the referred state transition information are illustrated in FIGS. 27A and 27B. Furthermore, FIGS. 27A and 27B illustrate state information items 2701, 2702, 2721, and 2722 as examples of state information items that have been created by integrating state information items that have been created separately. However, to facilitate the understanding of descriptions, FIGS. 27A and 27B also illustrate state information items relevant to the state information items 2621 through 2701, 2702, 2721, and 2722.

FIG. 27A illustrates state transition information referred to by the state transition creating unit 1213. Note that the state transition information illustrated in FIG. 27A is the same as the state transition information illustrated in FIG. 26A, and therefore the description is omitted.

FIG. 27B illustrates that state transition information corresponding to state information items 2701, 2702, 2721, and 2722 has been created based on the state transition information items 2611 through 2614. As illustrated in FIG. 27B, the only difference between the state information 2621 and the state information 2701 is that the state information of one of the servers having the management target IDs=“Svr1” through “Svr32” is different. Similarly, the only difference between the state information 2641 and the state information 2721 is that the state information of one of the servers having the management target IDs=“Svr1” through “Svr32” is different. Therefore, state transition information 2711 connecting the state information 2621 and the state information 2701 and state transition information 2715 connecting the state information 2641 and the state information 2721 are created, for example, based on the state transition information 2611.

Furthermore, the only difference between the state information 2701 and the state information 2702 is that the state information of one of the servers having the management target IDs=“Svr1” through “Svr32” is different. Similarly, the only difference between the state information 2721 and the state information 2722 is that the state information of one of the servers having the management target IDs=“Svr1” through “Svr32” is different. Therefore, state transition information 2712 connecting the state information 2701 and the state information 2702 and state transition information 2716 connecting the state information 2721 and the state information 2722 are created, for example, based on the state transition information items 2611 and 2612.

Furthermore, the only difference between the state information 2701 and the state information 2721 is that the state information of VM having the management target ID=“VM1” is different. Similarly, the only difference between the state information 2702 and the state information 2722 is that the state information of VM having the management target ID=“VM1” is different. Therefore, state transition information 2713 connecting the state information 2701 and the state information 2721 is created, for example, based on the state transition information items 2611 and 2614. Furthermore, state transition information 2714 connecting the state information 2702 and the state information 2722 is created, for example, based on the state transition information items 2611, 2612, and 2614.

As described above, the state transition creating unit 1213 is able to create state transition information corresponding to state information created by integrating state information items that have been separately created, by referring to the state transition information corresponding to the state information before being integrated.

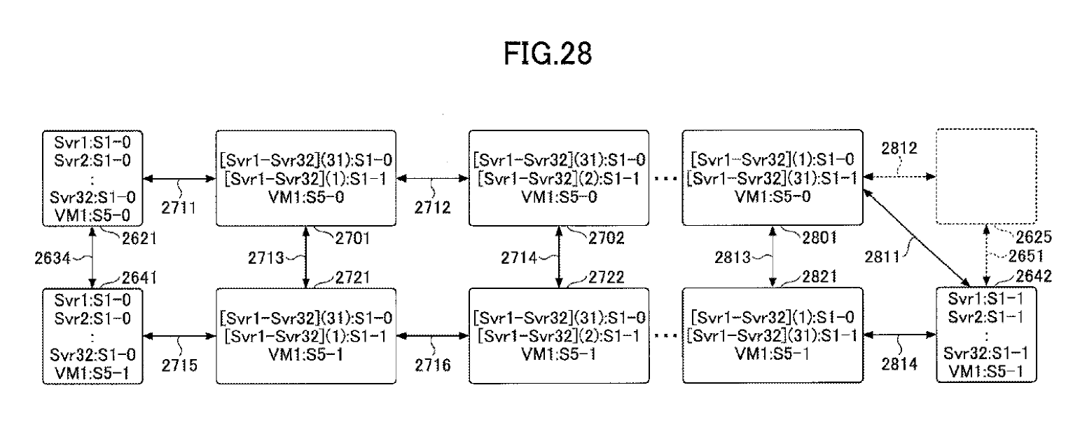

FIG. 28 is a seventh diagram for describing the functions of the state transition creating unit 1213. FIG. 28 is for describing a function of creating state transition information connecting other state information items after the unnecessary state searching unit 1212 has deleted state information, based on a policy rule that has been used for creating the state information before being deleted.

Note that as a matter of simplifying the descriptions also with respect to FIG. 28, a description about the state information acquired by the state transition creating unit 1213 is omitted. Furthermore, in the case of FIG. 28, the state transition information referred to by the state transition creating unit 1213 is the same as the state transition information illustrated in FIG. 26A, and therefore the state transition information referred to by the state transition creating unit 1213 is also omitted. Furthermore, in the case of FIG. 28, the state information 2625 is illustrated as an example of state information deleted by the unnecessary state searching unit 1212, and state information 2801 is illustrated as an example of another state information item after the state information 2625 is deleted. However, to facilitate the understanding of descriptions, FIG. 28 also illustrates state information items 2621, 2701, 2702, 2641, 2721, 2722, and 2821.

As illustrated in FIG. 28, as the state information 2625 is deleted, the state transition creating unit 1213 deletes the state transition information connecting the state information 2625. Specifically, the state transition creating unit 1213 deletes state transition information 2812. Note that the state transition information 2651 is already deleted because the state transition information 2651 has been determined to indicate a transition of a state that cannot possibly occur by referring to the priority information 1100, and therefore only the state transition information 2812 is deleted here.

Furthermore, as illustrated in FIG. 28, the state transition creating unit 1213 creates state transition information 2811 connecting the state information 2801 and the state information 2642. For example, the state transition creating unit 1213 creates the state transition information 2811 by referring to the state transition information 2613 and the state transition information 2614 illustrated in FIG. 26A.

As described above, the state transition creating unit 1213 is able to create state transition information corresponding to another state information item after state information is deleted, by referring to state transition information based on the policy rule that has been used to create the state information before being deleted.

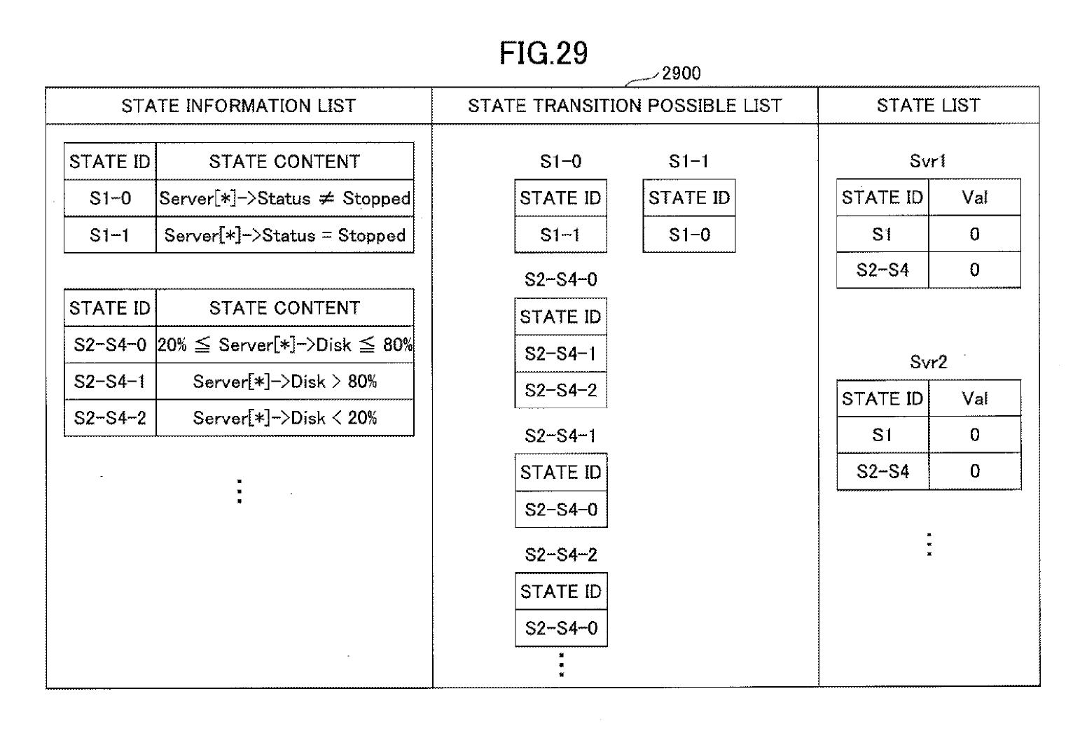

FIG. 29 illustrates an example of state management information stored by the state transition creating unit 1213. With respect to the state management information 2100 storing the state information obtained after state information has been integrated or deleted by the unnecessary state searching unit 1212, the state transition possible list is changed in state management information 2900 illustrated in FIG. 29 is changed.

For example, in the case of the state management information 2100, state transition information corresponding to state information before being integrated or deleted, is stored in the “state transition possible list”. On the other hand, in the case of the state management information 2900, state transition information corresponding to state information after being integrated or deleted, is stored in the “state transition possible list”.

For example, in the case of the state management information 2100, state transition information, which corresponds to the state information before being integrated or deleted, is stored in the “state transition possible list”. On the other hand, in the case of the state management information 2900, state transition information corresponding to the state information after being integrated or deleted, is stored.

For example, in the case of the state management information 2100, state transition information connecting the state information having a state ID=“S2-0” and the state information having a state ID=“S2-1” is stored in the “state transition possible list”. Furthermore, state transition information connecting the state information having a state ID=“S2-1” and the state information having a state ID=“S2-0” is stored.

On the other hand, in the case of the state management information 2900, state transition information connecting the state information having a state ID=“S2-S4-0” and the state information having a state ID=“S2-S4-1” is stored in the “state transition possible list”. Furthermore, state transition information connecting the state information having a state ID=“S2-S4-0” and the state information having a state ID=“S2-S4-2” is stored.

As described above, the state transition creating unit 1213 is able to create state transition information corresponding to state information after being integrated or deleted by the unnecessary state searching unit 1212, and store the created state transition information in the “state transition possible list” of the state management information 2900.

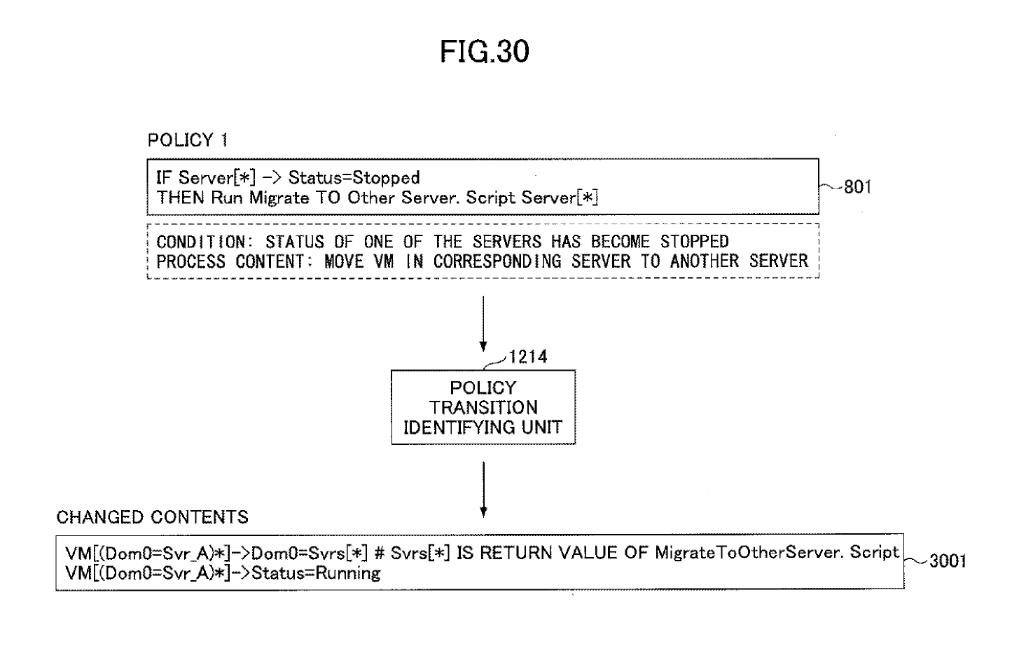

Next, detailed descriptions are given of the functions of the policy transition identifying unit 1214, with reference to FIGS. 30 through 32. FIG. 30 is a diagram for describing a function of the policy transition identifying unit 1214.

To the policy transition identifying unit 1214, the policy rules 801 through 805 included in the policy information 800 are input. The policy transition identifying unit 1214 identifies the transition of the state of each device, that occurs when the input policy rules 801 through 805 are respectively applied.

The example of FIG. 30 illustrates a case where the policy rule 801 has been input to the policy transition identifying unit 1214. The policy rule 801 defines that when the status of any one of the servers included in the data center 120 becomes stopped, the VM in the corresponding server is to be moved to another server.

As the policy rule 801 is applied, the server to which the VM moves becomes the server of Dom0, and the VM operates in the server that is the movement destination. The policy transition identifying unit 1214 identifies such a transition of a state, and manages change information 3001 indicating the above transition of the state, in association with the policy rule 801. In this way, the policy transition identifying unit 1214 is able to recognize how the state of each device transitions by applying the policy rules 801 through 805.

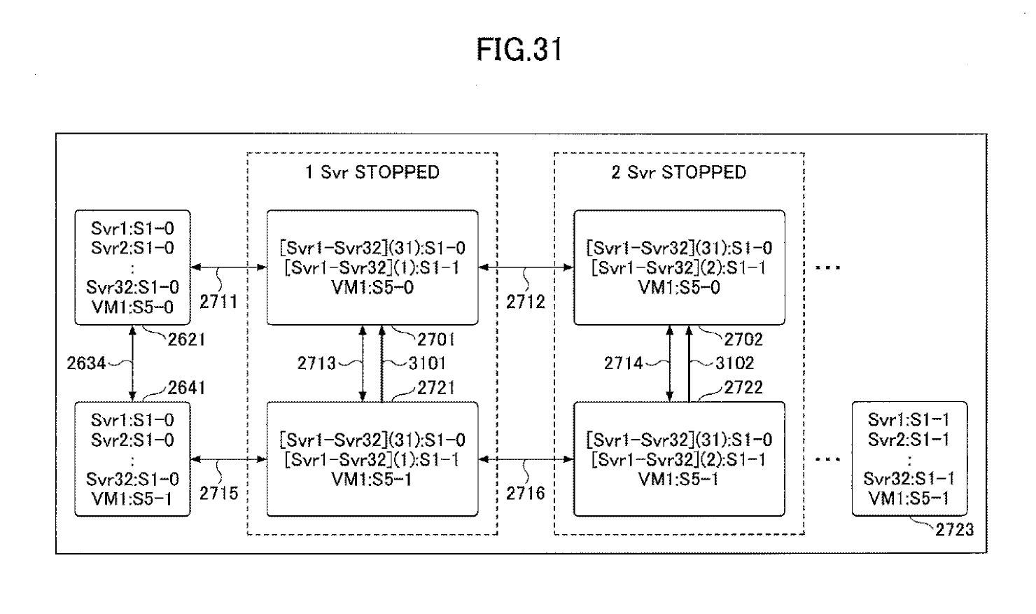

Furthermore, the policy transition identifying unit 1214 compares the identified transition of a state with a transition of a state indicated by the state transition information created by the state transition creating unit 1213. FIG. 31 illustrates an execution example of the policy transition identifying unit 1214. The example of FIG. 31 illustrates the comparison between the content (transition of a state) of the change information 3001 managed by the policy transition identifying unit 1214 and the state transition information created by the state transition creating unit 1213.

In FIG. 31, the state transition information items 2634 and 2711 through 2716 respectively correspond to state information items 2621, 2641, 2701, 2702, 2721, and 2722, and are created by the state transition creating unit 1213 (see FIG. 28).

On the other hand, in FIG. 31, the thick line arrows 3101 and 3102 indicate the comparison between the transitions of states managed as the change information 3001 and the transitions of states indicated by the state transition information created by the state transition creating unit 1213.

When the policy rule 801 is applied to the state where the VM has stopped because the server has stopped, the VM is moved to another server, and starts operating. This transition of a state is a transition of a state indicated by the state transition information 2713 and the state transition information 2714.

Therefore, in the example of FIG. 31, the thick line arrow 3101 is associated with the state transition information 2713. Furthermore, in the example of FIG. 31, the thick line arrow 3102 is associated with the state transition information 2714.

As described above, the policy transition identifying unit 1214 is able to recognize which one of the state transition information items created by the state transition creating unit 1213, corresponds to a transition of a state that has occurred by applying the policy rules 801 through 805 included in the policy information 800.

Note that when the policy transition identifying unit 1214 recognizes that a transition of a state that has occurred corresponds to the state transition information created by the state transition creating unit 1213, the policy transition identifying unit 1214 records a parameter Po in the corresponding state transition information in the “state transition possible list”. The parameter Po is a parameter that indicates that the corresponding state transition information corresponds to a transition of a state that occurs by applying a policy rule.

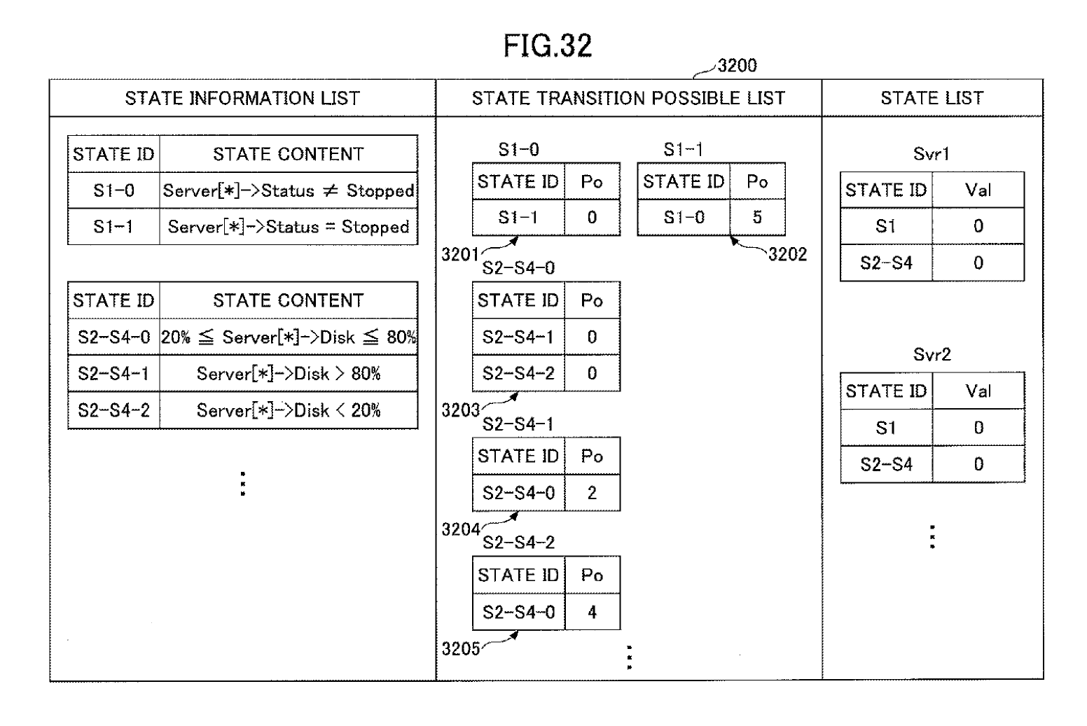

FIG. 32 illustrates an example of state management information stored by the policy transition identifying unit 1214. With respect to the state management information 2900 in which the state transition possible list has been changed by the state transition creating unit 1213, in the “state transition possible list” in state management information 3200 illustrated in FIG. 32, a parameter Po is recorded. The parameter Po is a parameter indicating that the state transition information corresponds to a transition of a state that occurs by applying a policy rule.

For example, by applying the policy rule 805 having a policy name=“policy 5”, the state transitions from a state indicated by the state information having a state ID=“S1-1” to a state indicated by the state information having a state ID=“S1-0”. Therefore, as the parameter Po of state transition information 3202, “5” expressing policy name=“policy 5” is recorded.

Furthermore, by applying the policy rule 802 having a policy name=“policy 2”, the state transitions from a state indicated by the state information having a state ID=“S2-S4-1” to a state indicated by the state information having a state ID=“S2-S4-0”. Furthermore, by applying the policy rule 804 having a policy name=“policy 4”, the state transitions from a state indicated by the state information having a state ID=“S2-S4-2” to a state indicated by the state information having a state ID=“S2-S4-0”.

Therefore, as the parameter Po of state transition information 3204 and state transition information 3205, “2” expressing policy name=“policy 2” and “4” expressing policy name=“policy 4” are respectively recorded.

Note that the transition of a state indicated by the state transition information items 3201 and 3203 do not correspond to the transition of a state that occurs by applying the policy rules 801 through 805 of the policy information 800. Therefore, as the parameter Po of the state transition information items 3201 and 3203, “0” is recorded, indicating that the state transition information does not correspond to the transition of a state that occurs by applying the policy rules 801 through 805 of the policy information 800.

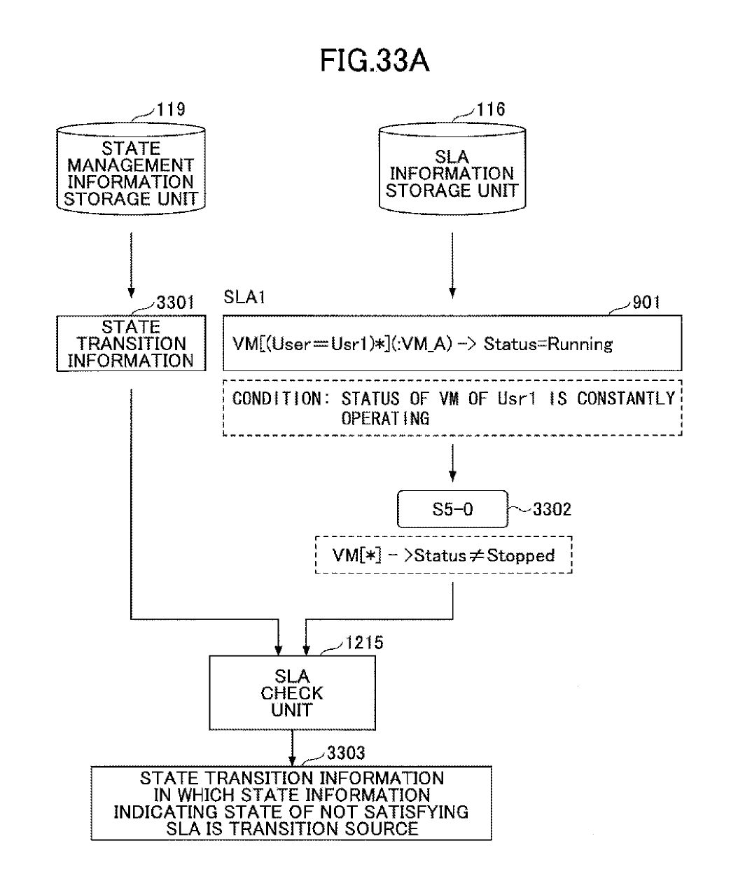

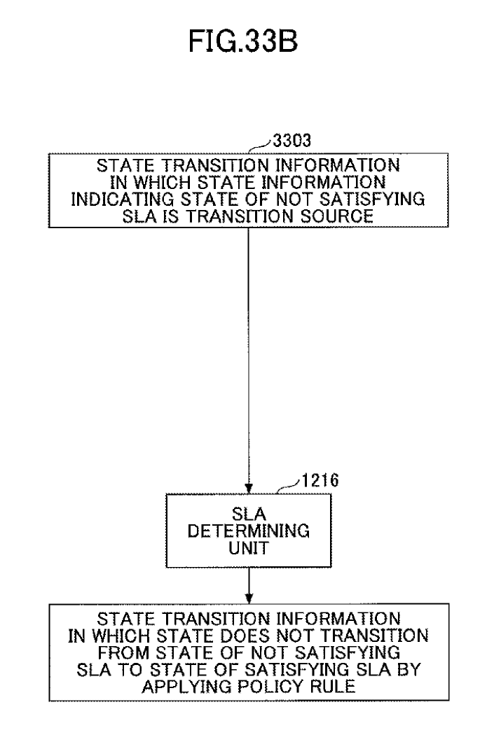

Next, a detailed description is given of functions of the SLA check unit 1215 and the SLA determining unit 1216, with reference to FIGS. 33A and 33B. FIGS. 33A and 33B are diagrams for describing the functions of the SLA check unit 1215 and the SLA determining unit 1216.

FIG. 33A illustrates the functions of the SLA check unit 1215. The SLA check unit 1215 acquires state transition information stored in the “state transition possible list” in state management information 3200 and state information indicating a state of not satisfying each SLA in the SLA information 900.

The example of FIG. 33A illustrates a case where the SLA check unit 1215 has acquired state transition information 3301 stored in the “state transition possible list” of the state management information 3200 and state information 3302 indicating a state of not satisfying the SLA 901 in the SLA information 900.

Note that the SLA 901 of the SLA information 900 defines that the status of the VM of a user identified by a user name=“Usr1” is constantly operating. Therefore, a state of not satisfying the SLA 901 means a state where the status of the VM of the user identified by the user name=“Usr1” is stopped. Therefore, in the example of FIG. 33A, the SLA check unit 1215 acquires the state information 3302 having a state ID=“S5-1”.

The SLA check unit 1215 determines whether the state information that is the transition source included in the state transition information 3301 acquired from the “state transition possible list” corresponds to the state information 3302 (state information having the state ID=“S5-1”) indicating a state of not satisfying each SLA in the SLA information 900. Furthermore, when the state information that is the transition source is determined to correspond to the state information 3302, the SLA check unit 1215 determines that the state transition information 3301 is state transition information in which the state information indicating a state of not satisfying the SLA is the transition source. The SLA check unit 1215 reports the state transition information in which the state information indicating a state of not satisfying the SLA is the transition source, as state transition information 3303, to the SLA determining unit 1216.

Furthermore, the SLA check unit 1215 records a parameter Se (for example, “0”) in the state information that has been determined to be corresponding to state information indicating a state of not satisfying each SLA in the SLA information 900, among the state information items stored in the “state information list” of the state management information 3200. Furthermore, the SLA check unit 1215 records a parameter Se (for example, “1”) in the state information other than the state information that has been determined to correspond to state information indicating a state of not satisfying each SLA in the SLA information 900, among the state information items stored in the “state information list”. Note that the parameter Se is assumed to be a parameter expressing a state of satisfying the SLA.

On the other hand, FIG. 33B illustrates the functions of the SLA determining unit 1216. The SLA determining unit 1216 acquires state transition information reported from the SLA check unit 1215. The example of FIG. 33B illustrates a case where the state transition information 3303 reported from the SLA check unit 1215 has been acquired.

The SLA determining unit 1216 determines whether the parameter Po included in the state transition information 3303 is “0”. Here, a case where the parameter Po included in the state transition information 3303 is “0” expresses that the state transition information does not correspond to a transition of a state that occurs by applying a policy rule. That is, this case expresses that a state of not satisfying the SLA will not transition to a state of satisfying the SLA, even by applying a policy rule.

When the parameter Po is determined to be “0”, the SLA determining unit 1216 determines that state transition information 3300 is state transition information in which a state of not satisfying the SLA does not transition to a state of satisfying the SLA, even by applying the policy rule.

Note that when the SLA determining unit 1216 determines that the state transition information 3300 is the state transition information as described above, the SLA determining unit 1216 determines that there is state transition information in which the state of the device does not transition from a state of not satisfying the SLA, by applying the present policy rule, and reports the determination result to the output unit 1217.

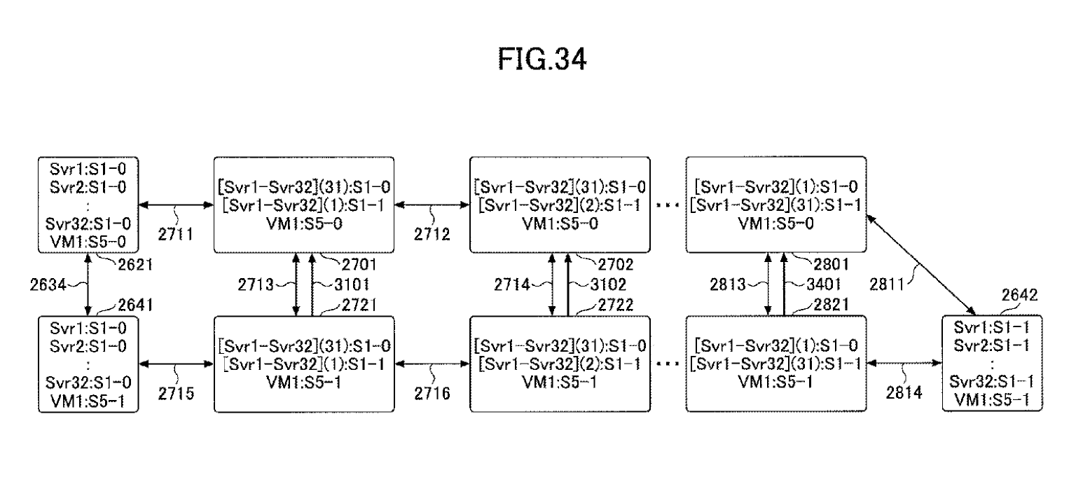

Next, a description is given of execution examples by the SLA check unit 1215 and the SLA determining unit 1216, with reference to FIG. 34. FIG. 34 is a diagram for describing execution examples by the SLA check unit 1215 and the SLA determining unit 1216.

In FIG. 34, the state information 2641, the state information 2721, the state information 2722, the state information 2821, and the state information 2642 are state information items that are determined to be state information indicating a state of not satisfying the SLA 901 by the SLA check unit 1215.

Furthermore, in FIG. 34, thick line arrows 3101, 3102, and 3401 express the transitions of states managed as the change information 3001. The state transition information items 2713, 2714, and 2813, with which the thick line arrows 3101, 3102, and 3401 are associated, are state transition information items in which a parameter Po=“5” is recorded, in the “state transition possible list” in the state management information 3200. On the other hand, the state transition information 2634 and 2811, with which the thick line arrows are not associated, are state transition information items for which a parameter Po=“0” is recorded in the “state transition possible list” in the state management information 3200.

As illustrated in FIG. 34, even by applying the policy rule 805, a state indicated by the state information 2641 does not transition to a state indicated by the state information 2621. That is, the state of the device will not transition from a state of not satisfying the SLA 901 to a state of satisfying the SLA 901. Therefore, the SLA determining unit 1216 determines that the state transition information 2634 is state transition information in which the state of the device does not transition from a state of not satisfying the SLA, even by applying the present policy rule. In this case, the SLA determining unit 1216 determines that there is state transition information in which the state of the device does not transition from a state of not satisfying the SLA even by applying the present policy rule, and reports the determination result to the output unit 1217. Note that the determination result reported here includes the state transition information 2634 (information indicating directions of transitions from the state information 2641, the state information 2621, and the state information 2641, to the state information 2621, etc.).

Similarly, even by applying the policy rule 805, a state indicated by the state information 2642 does not transition to a state indicated by the state information 2801. That is, the state of the device will not transition from a state of not satisfying the SLA 901 to a state of satisfying the SLA 901. Therefore, the SLA determining unit 1216 determines that the state transition information 2811 is state transition information in which the state of the device does not transition from a state of not satisfying the SLA, even by applying the present policy rule. In this case, the SLA determining unit 1216 determines that there is state transition information in which the state of the device does not transition from a state of not satisfying the SLA even by applying the present policy rule, and reports the determination result to the output unit 1217. Note that the determination result reported here includes the state transition information 2811 (information indicating directions of transitions from the state information 2642, the state information 2801, and the state information 2642, to the state information 2801, etc.).

As described above, the SLA check unit 1215 and the SLA determining unit 1216 are able to determine that there is state transition information in which the state of the device does not transition from a state of not satisfying the SLA, even by applying the present policy rule.

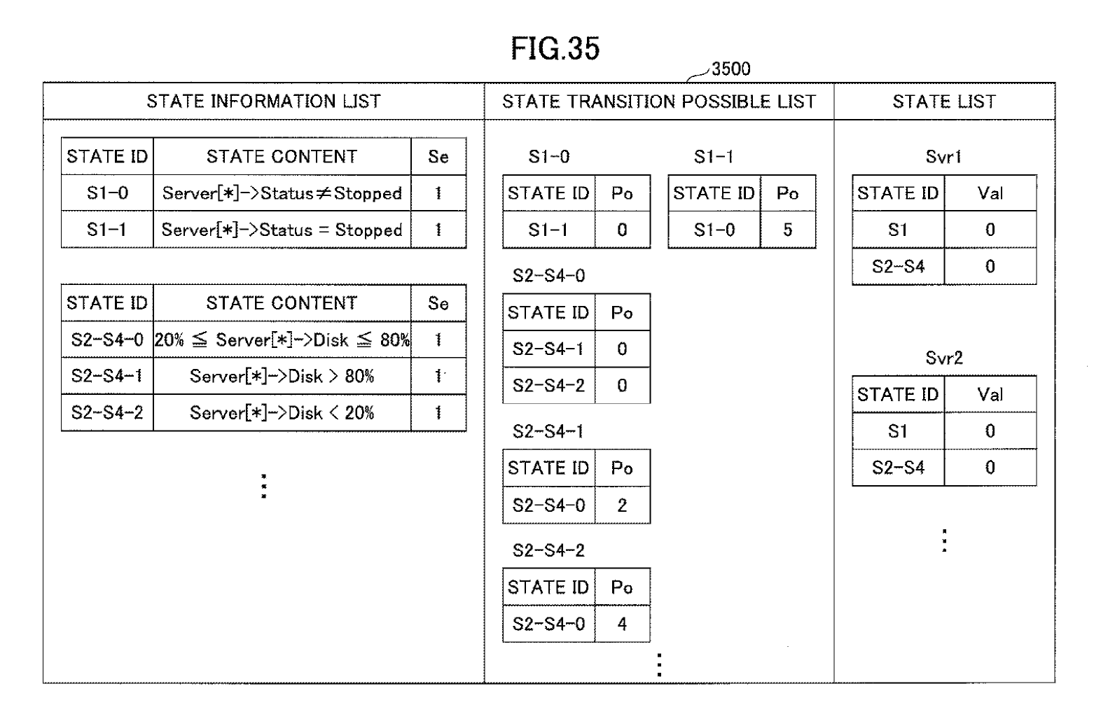

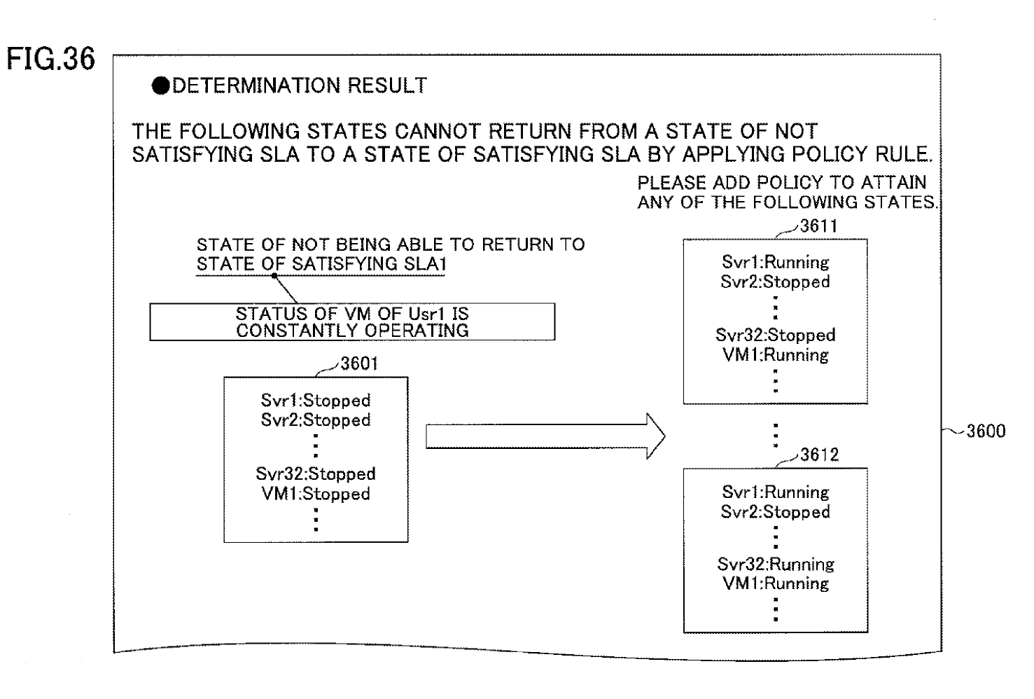

FIG. 35 illustrates an example of state management information stored by the SLA determining unit 1216. With respect to the state management information 3200 stored by the policy transition identifying unit 1214, a parameter Se is added to each state information item in the “state information list” in state management information 3500 illustrated in FIG. 35. The parameter Se is recorded in the state management information, as a parameter expressing that the state indicated by the state information satisfies the SLA.

For example, for the state information having a state ID=“S1-0”, a parameter Se “1”, which expresses that the state indicated by the state information satisfies the SLA, is recorded. Furthermore, for the state information having a state ID=“S1-1”, a parameter Se “1”, which expresses that the state indicated by the state information satisfies the SLA, is recorded.

Similarly, for the state information items having state IDs=“S2-S4-0”, “S2-S4-1”, “S2-S4-2”, a parameter Se “1”, which expresses that the state indicated by the state information satisfies the SLA, is recorded.

Next, a detailed description is given of an output example of the output unit 1217, with reference to FIG. 36. FIG. 36 illustrates an output example of the output unit 1217. The output unit 1217 reports a determination result to the administrator, by outputting determination result information 3600.

As illustrated in FIG. 36, in the determination result information 3600, a message is displayed, saying that there is a case where the state of the device will not transition from a state of not satisfying the SLA to a state of satisfying the SLA. Accordingly, the administrator is able to recognize that there is a case where the state of the device will not transition from a state of not satisfying the SLA to a state of satisfying the SLA by applying the present policy rule.

Furthermore, as illustrated in FIG. 36, in the determination result information 3600, state information 3601 is displayed. Accordingly, the administrator is able to recognize the state information 3601 as state information in a case where the state of the device does not transition from a state of not satisfying the SLA even by applying the present policy rule.

Furthermore, as illustrated in FIG. 36, in the determination result information 3600, state information 3611 and state information 3612 are displayed. Accordingly, the administrator is able to recognize the state information indicating a state of the device that is the transition destination, to which the state is to transition from the state indicated by the state information 3601, in order to satisfy the SLA. Furthermore, the administrator is able to recognize that there is a need to add a policy rule required for causing the state of the device to transition from the state indicated by the state information 3601 to the state indicated by the state information 3611 or 3612.

Furthermore, as illustrated in FIG. 36, in the determination result information 3600, details of the SLA that is not satisfied by the state information 3601, are displayed. Accordingly, the administrator is able to recognize that the SLA will be satisfied if the status of the VM of the user identified by “Usr1” is constantly operating.

As described above, as the determination result information 3600 is reported, the administrator is able to verify whether an appropriate policy rule is defined in the data center 120, before starting the operation management of the data center 120.

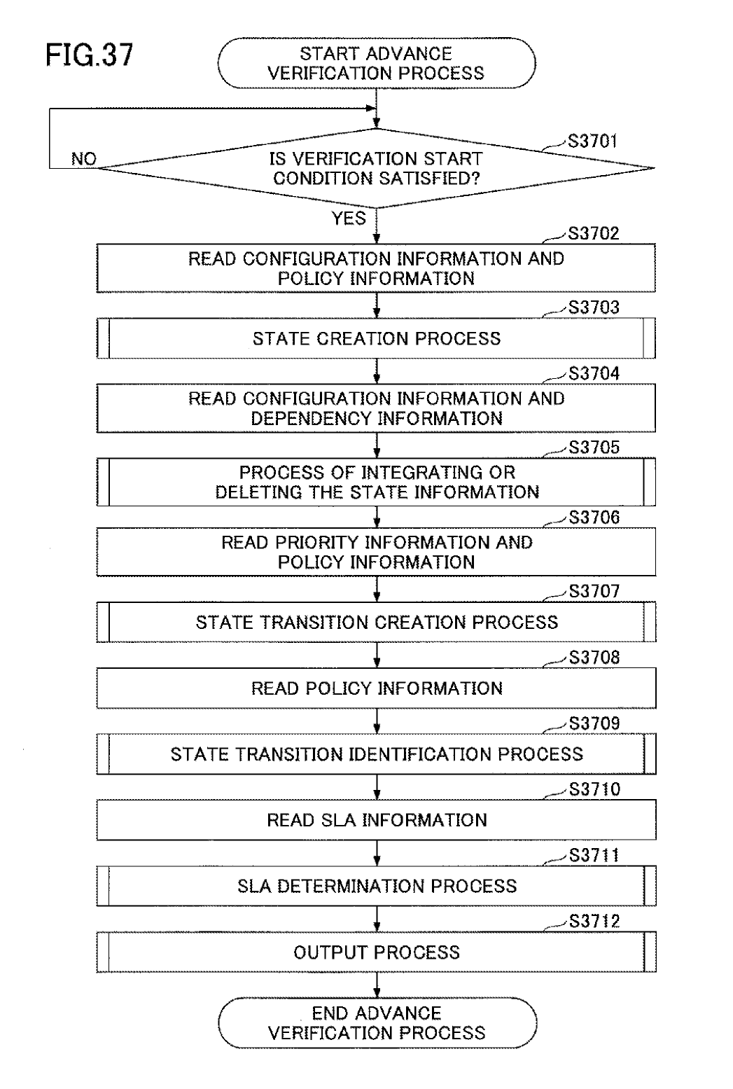

Next, a description is given of an advance verification process executed by the advance verification unit 113_2. FIG. 37 is a flowchart of an advance verification process.

In step S3701, the state creating unit 1211 determines whether the timing when the data center 120 is about to start operating has approached. As described above, the timing when the data center 120 is about to start operating includes, for example, a timing when a new data center 120 is constructed and the new data center 120 is about to actually start operating, a timing when the configuration inside the data center 120 has been changed and the data center 120 is subsequently about to start operating, etc. Furthermore, a timing when policy information stored in the policy information storage unit 115, etc., is changed and the data center 120 is subsequently about to start operating, etc., may be included.

The state creating unit 1211 determines whether any of these timings has approached, by determining whether a verification start condition is satisfied.

Note that the verification start condition includes a case where the configuration information 500 stored in the configuration information storage unit 114 (for example, the information 710 indicating server configuration items) is updated, and a case where the policy information 800 stored in the policy information storage unit 115 is updated. Furthermore, the verification start condition includes a case where the SLA information 900 stored in the SLA information storage unit 116 is updated, a case where the dependency information 1000 stored in the dependency information storage unit 117 is updated, and a case where the priority information 1100 stored in the priority information storage unit 118 is updated.

The state creating unit 1211 automatically determines the update of these information items. However, the update of these information items is not limited to being automatically determined by the state creating unit 1211. For example, the administrator may determine that the verification start condition has been satisfied. In this case, the state creating unit 1211 determines that the verification start condition has been satisfied, as the administrator inputs information that the verification start condition has been satisfied.

In step S3701, when the state creating unit 1211 determines that the verification start condition has been satisfied, the process proceeds to step S3702. In step S3702, the state creating unit 1211 reads the configuration information from the configuration information storage unit 114, and reads the policy information from the policy information storage unit 115.

In step S3703, the state creating unit 1211 executes a “state creation process” of creating the state information of each device included in the data center 120, based on the configuration information and the policy information that have been read. Note that details of the process flow of the state creation process are described below.

In step S3704, the unnecessary state searching unit 1212 reads the configuration information from the configuration information storage unit 114, and reads the dependency information from the dependency information storage unit 117.

In step S3705, the unnecessary state searching unit 1212 performs “a process of integrating or deleting the state information”, with respect to the state information items created in step S3702, based on the configuration information and the dependency information read in step S3703. Note that details of the process of integrating or deleting the state information are described below.

In step S3706, the state transition creating unit 1213 reads priority information from the priority information storage unit 118. Furthermore, the state transition creating unit 1213 reads policy information from the policy information storage unit 115.

In step S3707, the state transition creating unit 1213 performs a “state transition creation process” of creating state transition information corresponding to state information after a process of integrating or deleting the state information has been executed in step S3705. Details of the process flow of the state transition creation process by the state transition creating unit 1213 are described below.

In step S3708, the policy transition identifying unit 1214 reads policy information from the policy information storage unit 115.

In step S3709, the policy transition identifying unit 1214 executes a “state transition identification process” of identifying the transition of a state that occurs when each policy rule included in the policy information that has been read, is applied. Details of the process flow of the state transition identification process by the policy transition identifying unit 1214 are described below.

In step S3710, the SLA check unit 1215 reads the SLA information stored in the SLA information storage unit 116.

In step S3711, the SLA check unit 1215 and the SLA determining unit 1216 execute an “SLA determination process” of determining state transition information in which the state of the device does not transition from a state of not satisfying the SLA to a state of satisfying the SLA even by applying the present policy rule. Details of the process flow of the SLA determination process are described below.

In step S3712, the output unit 1217 outputs the determination result reported as the SLA determining unit 1216 executes the SLA determination process, to perform an “output process” of reporting the determination result information to the administrator. Note that details of the process flow of the output process by the output unit 1217 are described below.

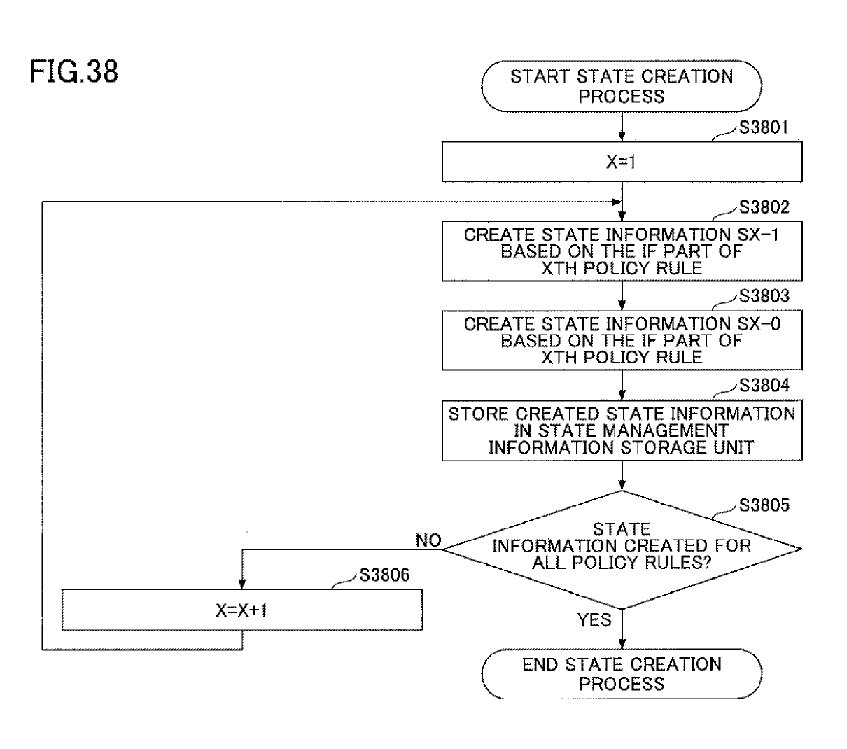

Next, a description is given of the details of a state creation process (step S3703 in FIG. 37) by the state creating unit 1211 with reference to FIG. 38. FIG. 38 is a flowchart of a state creation process.

In step S3801, the state creating unit 1211 assigns an initial value (=1) in a counter X counting the number of policy rules.

In step S3802, the state creating unit 1211 creates state information having a state ID=“SX-1” based on the “IF part” of the Xth policy rule, for each device included in the configuration information.

In step S3803, the state creating unit 1211 creates state information having a state ID=“SX-0” based on the “IF part” of the Xth policy rule, for each device included in the configuration information.

In step S3804, the state creating unit 1211 stores each state information item, which has been created with respect to each device included in the configuration information, in the state management information storage unit 119.

In step S3805, the state creating unit 1211 determines whether the state information has been created based on all of the policy rules defined in the policy information 800. In step S3805, when the state creating unit 1211 determines that there is a policy rule that has not been used for creating state information, the process proceeds to step S3806.

In step S3806, the state creating unit 1211 increments the counter X, and returns to step S3802. On the other hand, when the state creating unit 1211 determines that state information has been created based on all of the policy rules in step S3805, the state creation process is ended.

Note that when the state creating unit 1211 determines that the state information has been created based on all of the policy rules in step S3805, it is assumed that the process of combining the created state information items is performed, although not clearly illustrated in the flowchart of FIG. 38. Furthermore, the state information created by combining the state information is stored in the state management information storage unit 119.

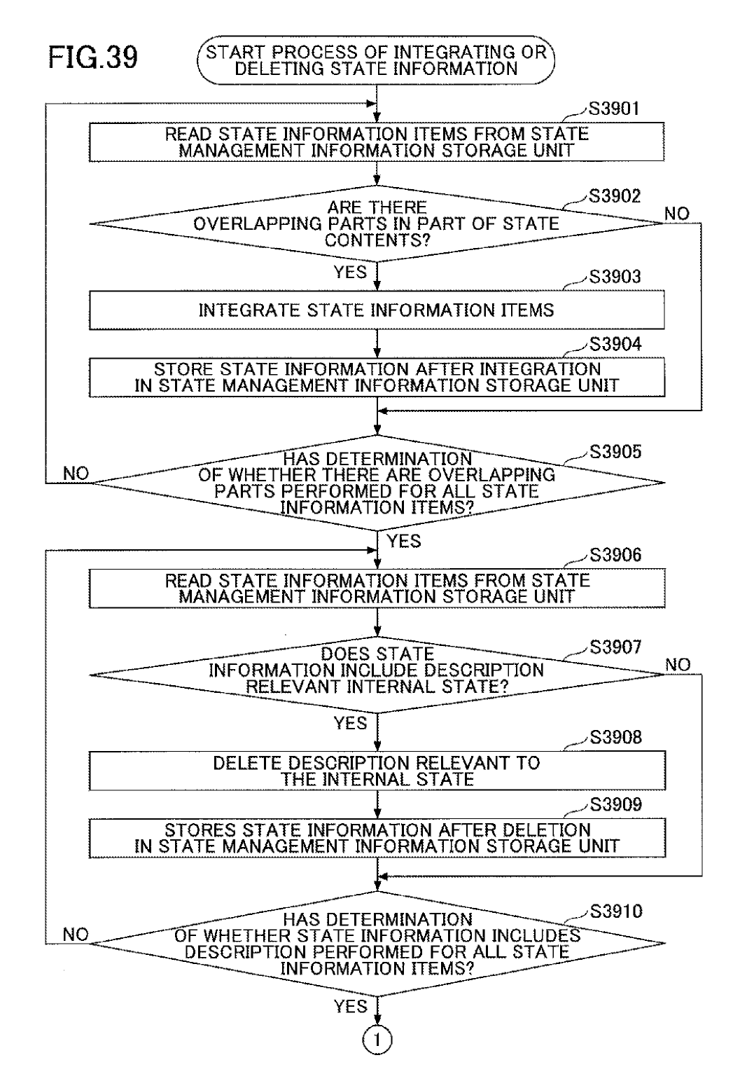

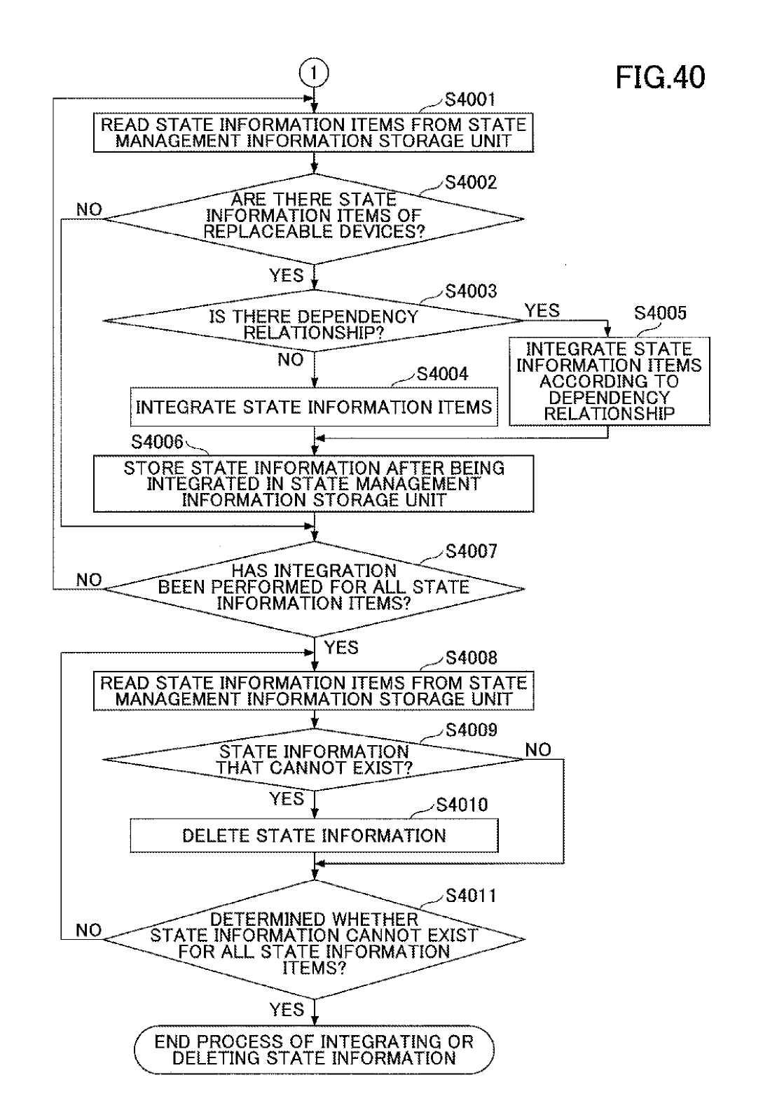

Next, a description is given of the details of a process of integrating or deleting the state information (step S3705 in FIG. 37) by the unnecessary state searching unit 1212 with reference to FIGS. 39 and 40. FIGS. 39 and 40 are a flowchart of a process of integrating or deleting the state information.

In step S3901, the unnecessary state searching unit 1212 reads the state information items stored in the “state information list” in the state management information storage unit 119.

In step S3902, the unnecessary state searching unit 1212 determines whether there are overlapping parts in a part of the state contents describing the states of the devices, in the state information items read in step S3901. When the unnecessary state searching unit 1212 determines that there are overlapping parts in step S3902, the process proceeds to step S3903.

In step S3903, the unnecessary state searching unit 1212 integrates the state information items that have been determined as having overlapping parts. In step S3904, the unnecessary state searching unit 1212 stores the state information after the integration in the state management information storage unit 119, and the process proceeds to step S3905.

On the other hand, when the unnecessary state searching unit 1212 determines that there are no overlapping parts in step S3902, the process directly proceeds to step S3905.

In step S3905, the unnecessary state searching unit 1212 determines whether the determination of whether there are overlapping parts has been performed for all of the state information items stored in the “state information list” in the state management information storage unit 119.

In step S3905, when the unnecessary state searching unit 1212 determines that there is state information for which the determination of whether there are overlapping parts has not been performed, the process returns to step S3901. On the other hand, when the unnecessary state searching unit 1212 determines that the determination of whether there are overlapping parts has been performed for all of the state information items, the process proceeds to step S3906.

In step S3906, the unnecessary state searching unit 1212 reads the state information items stored in the “state information list” in the state management information storage unit 119.

In step S3907, the unnecessary state searching unit 1212 determines whether the state information read in step S3906 is state information including a description relevant to the internal state of a device in a state where the status is stopped. When the unnecessary state searching unit 1212 determines that the state information includes a description relevant to the internal state of a device in a state where the status is stopped in step S3907, the process proceeds to step S3908.

In step S3908, the unnecessary state searching unit 1212 deletes the description relevant to the internal state of a device in a state where the status is stopped, from the state information read in step S3906.

In step S3909, the unnecessary state searching unit 1212 stores the state information, from which the description relevant to the internal state of a stopped device has been deleted, in the state management information storage unit 119, and the process proceeds to step S3910.

On the other hand, when the unnecessary state searching unit 1212 determines that the state information does not include a description relevant to the internal state of a device in a state where the status is stopped in step S3907, the process directly proceeds to step S3910.

In step S3910, the unnecessary state searching unit 1212 determines whether the determination of whether the state information includes a description relevant to the internal state has been performed for all of the state information items stored in the “state information list” in the state management information storage unit 119.

In step S3910, when the unnecessary state searching unit 1212 determines that there is state information for which the determination of whether the state information includes a description relevant to the internal state has not been performed, the process returns to step S3906. On the other hand, when the unnecessary state searching unit 1212 determines that the determination of whether the state information includes a description relevant to the internal state has been performed for all of the state information items, the process proceeds to step S4001 of FIG. 40.

In step S4001, the unnecessary state searching unit 1212 reads the state information items stored in the “state information list” in the state management information storage unit 119.

In step S4002, the unnecessary state searching unit 1212 determines whether there is a combination of various states of devices of the same type that has been created as separate state information items (state information items of replaceable devices), among the state information items read in step S4001.

In step S4002, when the unnecessary state searching unit 1212 determines that there are state information items of replaceable devices, the process proceeds to step S4003. In step S4003, the unnecessary state searching unit 1212 determines whether there is a dependency relationship between the states of devices determined in step S4002.

When the unnecessary state searching unit 1212 determines that there is no dependency relationship in step S4003, the process proceeds to step S4004. In step S4004, the unnecessary state searching unit 1212 integrates the state information items of the replaceable devices. On the other hand, when the unnecessary state searching unit 1212 determines that there is a dependency relationship in step S4003, the process proceeds to step S4005. In step S4005, the unnecessary state searching unit 1212 integrates the state information items of replaceable devices according to the dependency relationship.

In step S4006, the unnecessary state searching unit 1212 stores the state information integrated in step S4004 or step S4005 in the state management information storage unit 119, and the process proceeds to step S4007.

On the other hand, in step S4002, when the unnecessary state searching unit 1212 determines that there are no state information items of replaceable devices, the process directly proceeds to step S4007.

In step S4007, the unnecessary state searching unit 1212 determines whether the process of integrating the state information items of replaceable devices has been performed for all of the state information items stored in the “state information list” in the state management information storage unit 119.

In step S4007, when the unnecessary state searching unit 1212 determines that there is state information for which the process of integrating the state information items of replaceable devices has not been performed, the process returns to step S4001. On the other hand, when the unnecessary state searching unit 1212 determines that the process of integrating the state information items of replaceable devices has been performed for all of the state information items, the process proceeds to step S4008.

In step S4008, the unnecessary state searching unit 1212 reads the state information items stored in the “state information list” in the state management information storage unit 119.

In step S4009, the unnecessary state searching unit 1212 determines whether the state information read in step S4008 indicates a state that cannot exist, based on the dependency information. In step S4009, when the unnecessary state searching unit 1212 determines that the state information indicates a state that cannot exist, the process proceeds to step S4010.

In step S4010, the unnecessary state searching unit 1212 deletes the state information read in step S4008, and the process proceeds to step S4011. On the other hand, in step S4009, when the unnecessary state searching unit 1212 determines that the state information does not indicate a state that cannot exist, the process directly proceeds to step S4011.

In step S4011, the unnecessary state searching unit 1212 determines whether the determination of whether the state information indicates a state that cannot exist has been performed for all of the state information items stored in the “state information list” in the state management information storage unit 119. In step S4011, when the unnecessary state searching unit 1212 determines that there is state information for which the determination of whether the state information indicates a state that cannot exist has not been performed, the process returns to step S4008. On the other hand, when the unnecessary state searching unit 1212 determines that the determination of whether the state information indicates a state that cannot exist has been performed for all of the state information items, the process of integrating or deleting the state information is ended.

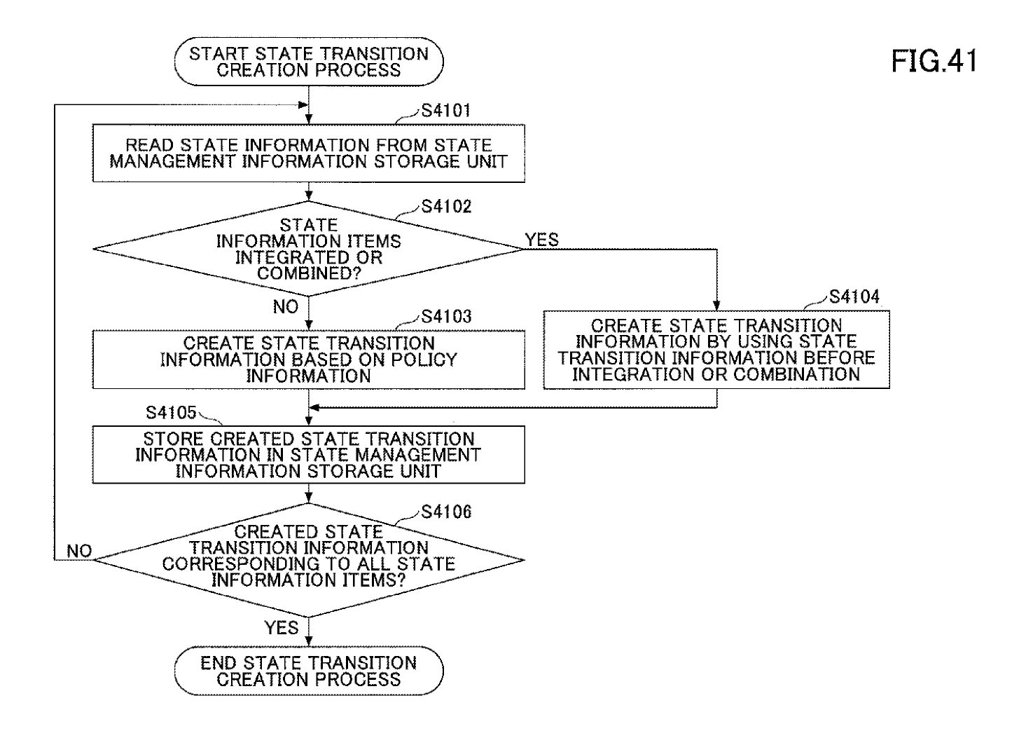

Next, a description is given of the details of a state transition creation process (step S3707 in FIG. 37) by the state transition creating unit 1213 with reference to FIG. 41. FIG. 41 is a flowchart of a state transition creation process.

In step S4101, the state transition creating unit 1213 reads the state information stored in the “state information list” in the state management information storage unit 119.

In step S4102, the state transition creating unit 1213 determines whether the integration or the combination of state information items has been performed. In step S4102, when the state transition creating unit 1213 determines that the integration or the combination of state information items has not been performed, the process proceeds to step S4103.

In step S4103, the state transition creating unit 1213 creates state transition information corresponding to the state information that has been read in step S4102, based on the policy information 800.

On the other hand, in step S4102, when the state transition creating unit 1213 determines that the integration or the combination of state information items has been performed, the process proceeds to step S4104. In step S4104, the state transition creating unit 1213 determines the state transition information corresponding to the state information before the integration or the combination of the state information that has been read in step S4101, based on the policy information 800. Furthermore, the state transition creating unit 1213 creates state transition information corresponding to the state information read in step S4101, based on the determined state transition information.

In step S4105, the state transition creating unit 1213 stores the created state transition information in the state management information storage unit 119.

In step S4106, the state transition creating unit 1213 determines whether state transition information items corresponding to all of the state information items stored in the “state information list” in the state management information storage unit 119, have been created.

In step S4106, when the state transition creating unit 1213 determines that there is state information for which state transition information has not been created, the process returns to step S4101. On the other hand, when the state transition creating unit 1213 determines that state transition information items corresponding to all of the state information items have been created, the state transition creation process is ended.

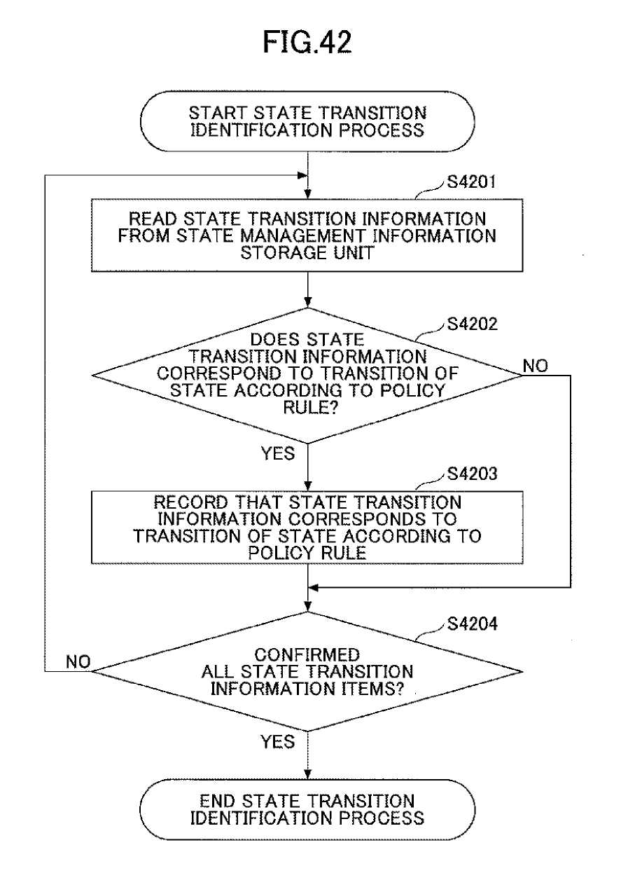

Next, a description is given of the details of a state transition identification process (step S3709 in FIG. 37) by the policy transition identifying unit 1214 with reference to FIG. 42. FIG. 42 is a flowchart of a state transition identification process.

In step S4201, the policy transition identifying unit 1214 reads the state transition information stored in the “state transition possible list” in the state management information storage unit 119.

In step S4202, the policy transition identifying unit 1214 identifies the transition of a state that occurs by applying a policy rule. Furthermore, the policy transition identifying unit 1214 determines whether the state transition information read in step S4201 corresponds to the transition of a state that occurs by applying a policy rule.

In step S4202, when the policy transition identifying unit 1214 determines that the state transition information corresponds to the transition of a state that occurs by applying a policy rule, the process proceeds to step S4203. In step S4203, the policy transition identifying unit 1214 records, in the state management information storage unit 119, a parameter Po indicating that the state transition information corresponds to the transition of a state that occurs by applying a policy rule.

Note that the policy transition identifying unit 1214 records the above parameter in information item “Po”, in the “state transition possible list” in the state management information 3200 stored in the state management information storage unit 119. Specifically, the policy transition identifying unit 1214 records a parameter Po in the information item “Po” in the “state transition possible list”, every time the state transition information is determined to correspond to the transition of a state that occurs by applying a policy rule in step S4202. The parameter Po recorded by the policy transition identifying unit 1214 is a value indicating the policy rule used in the determination of step S4202 (for example, “1” in the case of the policy rule 801, “2” in the case of the policy rule 802, etc.).

On the other hand, in step S4202, when the policy transition identifying unit 1214 determines that the state transition information does not correspond to the transition of a state that occurs by applying a policy rule, the process proceeds to step S4204. Note that when the policy transition identifying unit 1214 determines that the state transition information does not correspond to the transition of a state that occurs by applying a policy rule, the policy transition identifying unit 1214 records “0” in the information item “Po” in the “state transition possible list”.

In step S4204, the policy transition identifying unit 1214 determines whether a confirmation is made with respect to all of the state transition information items stored in the “state transition possible list” in the state management information storage unit 119. In step S4204, when the policy transition identifying unit 1214 determines that there is state transition information that is not confirmed, the process returns to step S4201. On the other hand, when the policy transition identifying unit 1214 determines that a confirmation is made with respect to all of the state transition information items, the state transition identification process is ended.

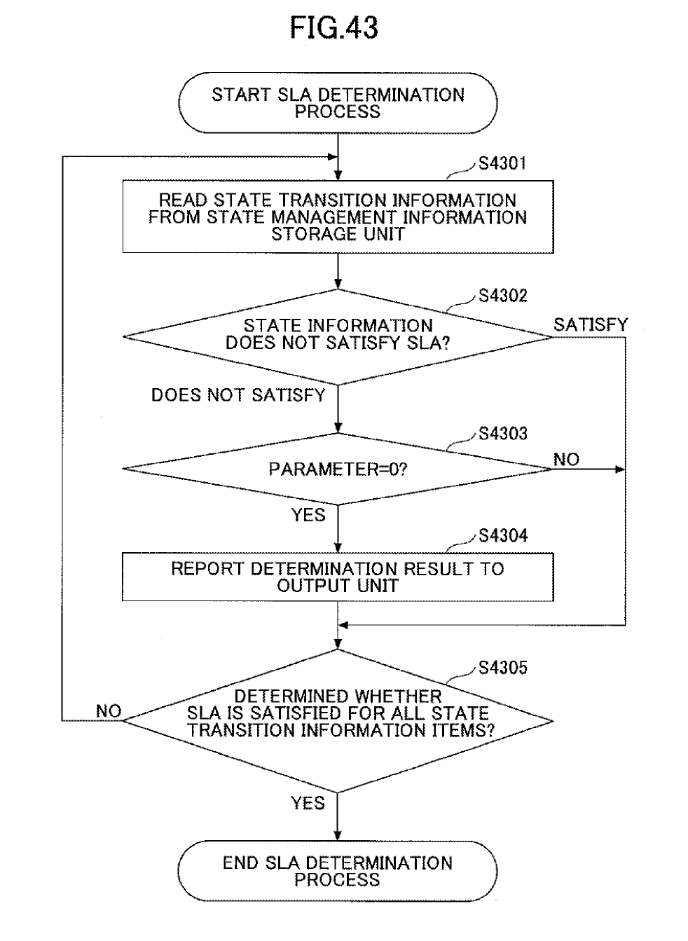

Next, a description is given of the details of an SLA determination process (step S3711 in FIG. 37) by the SLA check unit 1215 and the SLA determining unit 1216 with reference to FIG. 43. FIG. 43 is a flowchart of an SLA determination process.

In step S4301, the SLA check unit 1215 reads the state transition information from the “state transition possible list” in the state management information storage unit 119.

In step S4302, the SLA check unit 1215 identifies the state information that is the transition source included in the state transition information that has been read. Furthermore, the SLA check unit 1215 determines whether the identified state information corresponds to the state information indicating a state of not satisfying the SLA.

In step S4302, when the SLA check unit 1215 determines that the identified state information does not correspond to the state information indicating a state of not satisfying the SLA, the process proceeds to step S4305. On the other hand, when the SLA check unit 1215 determines that the identified state information corresponds to the state information indicating a state of not satisfying the SLA, the process proceeds to step S4303. Note that when the SLA check unit 1215 determines that the identified state information does not correspond to the state information indicating a state of not satisfying the SLA, the SLA check unit 1215 records a parameter Se=“1” in the “state information list” in the state management information storage unit 119. Furthermore, when the SLA check unit 1215 determines that the identified state information corresponds to the state information indicating a state of not satisfying the SLA, the SLA check unit 1215 records a parameter Se=“0” in the “state information list” in the state management information storage unit 119.

Accordingly, the SLA check unit 1215 is able to determine the state transition information in which the state information indicating a state of a device before the transition corresponds to a state of not satisfying the SLA.

In step S4303, the SLA determining unit 1216 determines whether the parameter Po included in the state transition information read in step S4301 is “0”. In step S4303, when the SLA determining unit 1216 determines that the parameter Po is not “0”, the process proceeds to step S4305. On the other hand, in step S4303, when the SLA determining unit 1216 determines that the parameter Po is “0”, the process proceeds to step S4304. Accordingly, the SLA determining unit 1216 is able to determine a state transition information item that does not correspond to the transition of a state of a device that occurs when a policy rule is applied among the state transition information items determined by the SLA check unit 1215.

In step S4304, the SLA determining unit 1216 reports the determination result according to whether the state transition information has been determined, to the output unit 1217. Subsequently, the process proceeds to step S4305. Note that the SLA determining unit 1216 reports, for example, the following information as the determination result, to the output unit 1217.
Whether there is state transition information determined in step S4303.
The state transition information determined in step S4303 (the state information before the transition, the state information after the transition, and information indicating the direction of the transition of the state).
The SLA determined as not being satisfied in step S4302.

In step S4305, the SLA determining unit 1216 determines whether a determination has been made of whether the SLA is satisfied, with respect to all of the state transition information items stored in the “state transition possible list” in the state management information storage unit 119. In step S4305, when the SLA determining unit 1216 determines that there is state transition information for which the determination of whether the SLA is satisfied has not been made, the process returns to step S4301. On the other hand, in step S4305, when the SLA determining unit 1216 determines that a determination has been made of whether the SLA is satisfied, with respect to all of the state transition information items, the SLA determination process is ended.

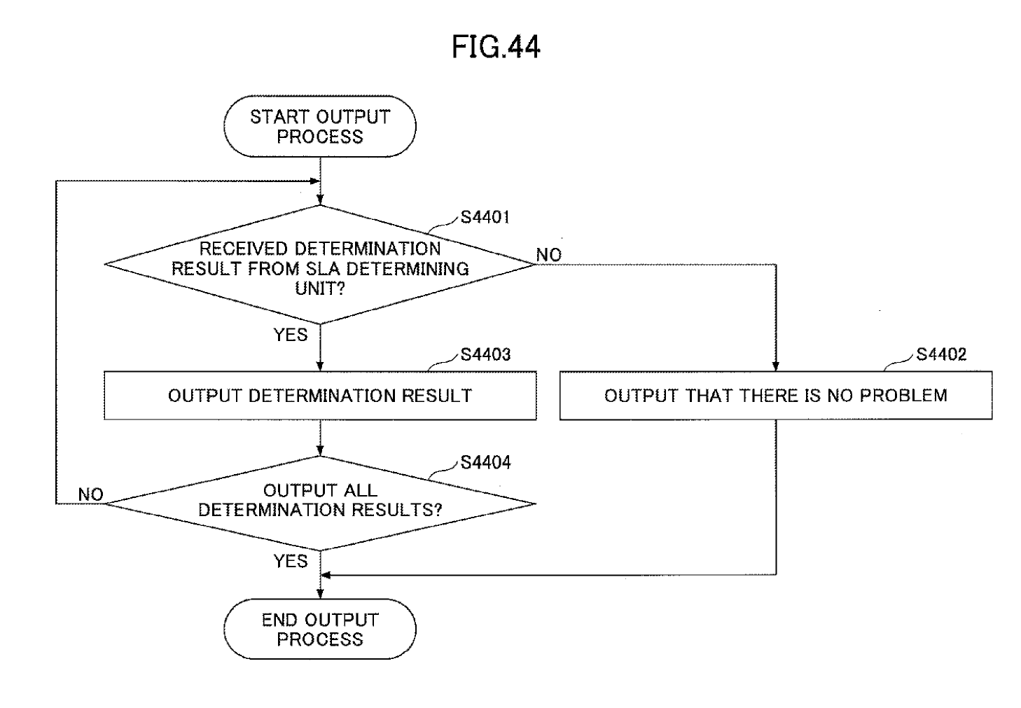

Next, a description is given of the details of an output process (step S3712 in FIG. 37) by the output unit 1217 with reference to FIG. 44. FIG. 44 is a flowchart of an output process.

In step S4401, the output unit 1217 determines whether a determination result has been received from the SLA determining unit 1216. In step S4401, when the output unit 1217 determines that a determination result has not been received, the process proceeds to step S4402.

In step S4402, the output unit 1217 reports that the present policy rule is appropriate, to the administrator. Specifically, the output unit 1217 reports to the administrator that, by applying the present policy rule, the state of the device will transition from a state of not satisfying the SLA to a state of satisfying the SLA.

On the other hand, in step S4401, when the output unit 1217 determines that a determination result has been received, the process proceeds to step S4403. In step S4403, the output unit 1217 outputs the received determination result.

In step S4404, the output unit 1217 determines whether all of the determination results received from the SLA determining unit 1216 have been output. In step S4404, when the output unit 1217 determines that there is a determination result that is not output, the process returns to step S4401. On the other hand, when the output unit 1217 determines that all of the determination results received from the SLA determining unit 1216 have been output, the output process is ended.

As clearly described above, in the operation management server 110, state information of each device included in the data center 120 is created and the created state information items are integrated or deleted based on the configuration information and the “IF” part of a policy rule, to decrease the number of state information items. Furthermore, in the operation management server 110, state transition information corresponding to state information is created based on a policy rule. Furthermore, the operation management server 110 determines state transition information, in which the state of the device of the transition source does not satisfy the SLA, and that does not correspond to the transition of a state that occurs by applying a policy rule, among the created state transition information items.

Accordingly, the operation management server 110 is able to determine whether there will be a case where the state of the device will not transition from a state of not satisfying the SLA to a state of satisfying the SLA even by applying the present policy rule.

As a result, it is possible to verify whether an appropriate policy rule is defined in the system (data center 120).

According to an aspect of the embodiments, it is possible to verify whether an appropriate policy rule is defined in a system.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an advance verification program that causes a computer to execute a process, the process comprising:
creating one or more state transition information items indicating a transition of a state of a device, based on a condition described in a policy rule and configuration information indicating the device included in a system, the policy rule describing a content of a process to be executed by the system and the condition for executing the process; and
referring to quality information describing a quality to be satisfied in the system, determining whether there is a state transition information item in which the state of the device does not transition from a state of not satisfying the quality when complying with the policy rule, among the created one or more state transition information items, and outputting information indicating a result of the determination.

2. The non-transitory computer-readable recording medium according to claim 1, wherein the information indicating the result of the determination includes the state transition information item in which the state of the device does not transition from the state of not satisfying the quality when complying with the policy rule.

3. The non-transitory computer-readable recording medium according to claim 1, wherein the information indicating the result of the determination includes at least one of state information indicating the state of the device before the transition and state information indicating the state of the device after the transition, included in the state transition information item in which the state of the device does not transition from the state of not satisfying the quality when complying with the policy rule.

4. The non-transitory computer-readable recording medium according to claim 1, the process further comprising:
creating a new state information item by integrating a plurality of state information items having overlapping parts in a description of the condition, among state information items that are created by using the condition and the configuration information and that indicate the state of the device.

5. The non-transitory computer-readable recording medium according to claim 1, the process further comprising:
creating one or more new state information items by combining a plurality of state information items, among state information items that are created by using the condition and the configuration information and that indicate the state of the device.

6. The non-transitory computer-readable recording medium according to claim 5, the process further comprising:
deleting, from the one or more new state information items, a description relating to an internal state of the device that is stopped, when the one or more new state information items include the description relating to the internal state of the device that is stopped.

7. The non-transitory computer-readable recording medium according to claim 5, the process further comprising:
deleting, from the one or more new state information items, a state information item determined to be a combination of the states that cannot exist, based on a dependency relationship between the states of the device.

8. The non-transitory computer-readable recording medium according to claim 1, the process further comprising:
creating another new state information item by integrating a plurality of state information items included in a new state information item, when the new state information item has been created by combining the plurality of state information items respectively indicating the state of a plurality of the devices of a same type, among state information items that are created by using the condition and the configuration information and that indicate the state of the device.

9. The non-transitory computer-readable recording medium according to claim 1, the process further comprising:
determining, with respect to the created one or more state transition information items, whether state information indicating the state of the device before the transition is state information indicating the state of not satisfying the quality; and
determining whether the created one or more state transition information items correspond to the transition of the state of the device when complying with the policy rule, when the state information indicating the state of the device before the transition is determined to be the state information indicating the state of not satisfying the quality, to
determine whether there is the state transition information item in which the state of the device does not transition from the state of not satisfying the quality when complying with the policy rule.

10. An advance verification method executed by a computer, the advance verification method comprising:
creating one or more state transition information items indicating a transition of a state of a device, based on a condition described in a policy rule and configuration information indicating the device included in a system, the policy rule describing a content of a process to be executed by the system and the condition for executing the process; and
referring to quality information describing a quality to be satisfied in the system, determining whether there is a state transition information item in which the state of the device does not transition from a state of not satisfying the quality when complying with the policy rule, among the created one or more state transition information items, and outputting information indicating a result of the determination.
